(19) United States
(12) Patent Application Publication
(10) Pub. No.: US 2024/0155131 A1
(43) Pub. Date: May 9, 2024

(54) Block Vector Difference (BVD) Indication with Reduced Overhead

(71) Applicant: Comcast Cable Communications, LLC, Philadelphia, PA (US)

(72) Inventors: Damian Ruiz Coll, Reston, VA (US); Vikas Warudkar, Herndon, VA (US); Jung Kyung Lee, Reston, VA (US)

(21) Appl. No.: 18/504,455

(22) Filed: Nov. 8, 2023

Related U.S. Application Data
(60) Provisional application No. 63/434,736, filed on Dec. 22, 2022.
(60) Provisional application No. 63/423,723, filed on Nov. 8, 2022.

(51) Int. Cl. H04N 19/139; H04N 19/105; H04N 19/167; H04N 19/176; H04N 19/46; H04N 19/517

(52) U.S. Cl. CPC H04N 19/139; H04N 19/105; H04N 19/167; H04N 19/176; H04N 19/46; H04N 19/517

(57) ABSTRACT

Encoding and/or decoding a block of a video frame may be based on a previously decoded reference block in the same frame or in a different frame. The reference block may be indicated by a block vector (BV). The BV may be encoded as difference (e.g., block vector difference (BVD)) between a block vector predictor (BVP) and the BV. The BVP may comprise a null component, for example, based on the BV comprising a null component. Signaling overhead may be reduced by indicating whether the BV comprises a null component and/or a direction of the null component.

### CROSS-REFERENCE TO RELATED APPLICATIONS

This application claims the benefit of U.S. Provisional Application No. 63/423,723 filed on Nov. 8, 2022, and U.S. Provisional Application No. 63/434,736 filed on Dec. 22, 2022. Each of the above-referenced applications is hereby incorporated by reference in its entirety.

### BACKGROUND

A computing device processes video for storage, transmission, reception, and/or display. Processing a video comprises encoding and/or decoding, for example, to reduce a data size associated with the video.

### SUMMARY

The following summary presents a simplified summary of certain features. The summary is not an extensive overview and is not intended to identify key or critical elements.

A video may comprise a sequence of frames (pictures) displayed consecutively. Predictive encoding and decoding may involve the use of information associated with reference blocks, within a frame, to encode and/or decode other blocks in the same frame. A reference block may be indicated in the form of a block vector (BV) that represents the location of the reference block with respect to a current block being encoded or decoded. The BV may be indicated as a function of a block vector predictor (BVP) (e.g., a block vector difference (BVD) for reducing signaling overhead required for directly indicating the BV. For a BV that comprises a null component and a non-null component, signaling overhead for indicating a BVD may be reduced by providing an indication that the BV comprises a null component and/or a direction of the null component. Information associated with a null component of the BV may enable indication of a BVD solely as a difference between non-null components of the BV and the BVP, thereby improving video encoding efficiency and reducing signaling overhead.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example video coding/decoding system.

FIG. 2 shows an example encoder.

FIG. 3 shows an example decoder.

FIG. 4 shows an example quadtree partitioning of a coding tree block (CTB).

FIG. 5 shows an example quadtree corresponding to the example quadtree partitioning of the CTB in FIG. 4.

FIG. 6 shows example binary tree and ternary tree partitions.

FIG. 7 shows an example of combined quadtree and multi-type tree partitioning of a CTB.

FIG. 8 shows a tree corresponding to the combined quadtree and multi-type tree partitioning of the CTB shown in FIG. 7.

FIG. 9 shows an example set of reference samples determined for intra prediction of a current block.

FIGS. 10A and 10B show example intra prediction modes.

FIG. 11 shows a current block and corresponding reference samples.

FIG. 12 shows an example application of an intra prediction mode for prediction of a current block.

FIG. 13A shows an example of inter prediction.

FIG. 13B shows an example motion vector.

FIG. 14 shows an example of bi-prediction.

FIG. 15A shows example spatial candidate neighboring blocks for a current block.

FIG. 15B shows example temporal, co-located blocks for a current block.

FIG. 16 shows an example of intra block copy (IBC) for encoding.

FIG. 17A shows an example of a BV comprising a null vertical component.

FIG. 17B shows an example of a BV comprising a null horizontal component.

FIGS. 18A and 18B show example IBC reference regions.

FIG. 19A shows an example of a BV comprising a null vertical component.

FIG. 19B shows an example of a BV comprising a null horizontal component.

FIG. 20A shows an example of a BV comprising a null vertical component.

FIG. 20B shows an example of a BV comprising a null horizontal component.

FIG. 21 shows an example use of Reconstruction-Reordered Intra Block Copy (RRIBC) or IBC mirror mode for screen content e.

FIGS. 22A and 22B show examples of syntax parsing of conditionally indicated syntax elements in an IBC mirror mode or RRIBC mode.

FIG. 23 shows an example method for determining a BV.

FIG. 24 shows an example method for determining a BV.

FIG. 25 shows an example computer system in which examples of the present disclosure may be implemented.

FIG. 26 shows example elements of a computing device that may be used to implement any of the various devices described herein

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of video encoding and decoding systems, which may be used in the technical field of video data storage and/or transmission/reception. More particularly, the technology disclosed herein may relate to video compression as used in encoding and/or decoding devices and/or systems.

A video sequence, comprising multiple pictures/frames, may be represented in digital form for storage and/or transmission. Representing a video sequence in digital form may require a large quantity of bits. Large data sizes that may be associated with video sequences may require significant resources for storage and/or transmission. Video encoding may be used to compress a size of a video sequence for more efficient storage and/or transmission. Video decoding may be used to decompress a compressed video sequence for display and/or other forms of consumption.

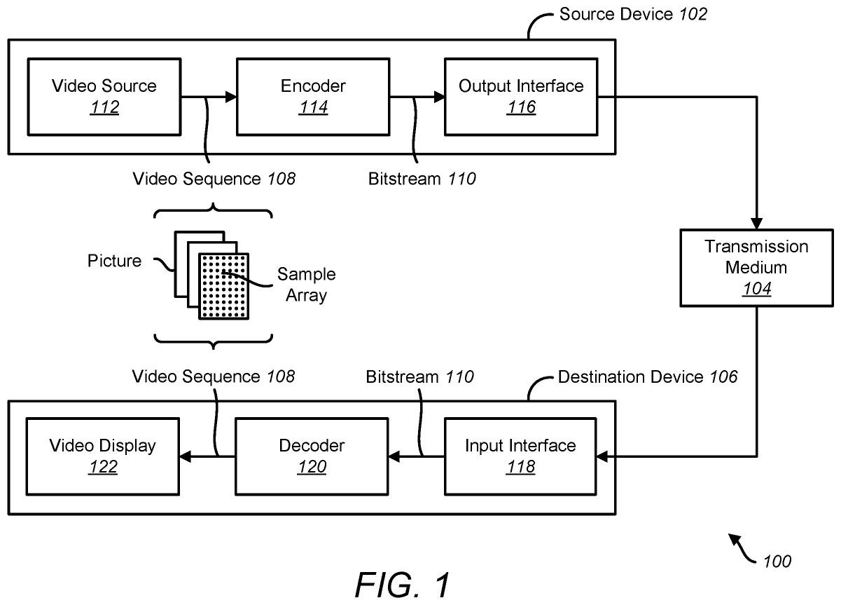

FIG. 1 shows an example video coding/decoding system. Video coding/decoding system 100 may comprise a source device 102, a transmission medium 104, and a destination device 106. The source device 102 may encode a video sequence 108 into a bitstream 110 for more efficient storage and/or transmission. The source device 102 may store and/or send/transmit the bitstream 110 to the destination device 106 via the transmission medium 104. The destination device 106 may decode the bitstream 110 to display the video sequence 108. The destination device 106 may receive the bitstream 110 from the source device 102 via the transmission medium 104. The source device 102 and/or the destination device 106 may be any of a plurality of different devices (e.g., a desktop computer, laptop computer, tablet computer, smart phone, wearable device, television, camera, video gaming console, set-top box, video streaming device, etc.).

The source device 102 may comprise (e.g., for encoding the video sequence 108 into the bitstream 110) one or more of a video source 112, an encoder 114, and/or an output interface 116. The video source 112 may provide and/or generate the video sequence 108 based on a capture of a natural scene and/or a synthetically generated scene. A synthetically generated scene may be a scene comprising computer generated graphics and/or screen content. The video source 112 may comprise a video capture device (e.g., a video camera), a video archive comprising previously captured natural scenes and/or synthetically generated scenes, a video feed interface to receive captured natural scenes and/or synthetically generated scenes from a video content provider, and/or a processor to generate synthetic scenes.

A video sequence, such as video sequence 108, may comprise a series of pictures (also referred to as frames). A video sequence may achieve an impression of motion based on successive presentation of pictures of the video sequence using a constant time interval or variable time intervals between the pictures. A picture may comprise one or more sample arrays of intensity values. The intensity values may be taken (e.g., measured, determined, provided) at a series of regularly spaced locations within a picture. A color picture may comprise (e.g., typically comprises) a luminance sample array and two chrominance sample arrays. The luminance sample array may comprise intensity values representing the brightness (e.g., luma component, Y) of a picture. The chrominance sample arrays may comprise intensity values that respectively represent the blue and red components of a picture (e.g., chroma components, Cb and Cr) separate from the brightness. Other color picture sample arrays may be possible based on different color schemes (e.g., a red, green, blue (RGB) color scheme). A pixel, in a color picture, may refer to/comprise/be associated with all intensity values (e.g., luma component, chroma components), for a given location, in the sample arrays used to represent color pictures. A monochrome picture may comprise a single, luminance sample array. A pixel, in a monochrome picture, may refer to/comprise/be associated with the intensity value (e.g., luma component) at a given location in the single, luminance sample array used to represent monochrome pictures.

The encoder 114 may encode the video sequence 108 into the bitstream 110. The encoder 114 may apply/use (e.g., to encode the video sequence 108) one or more prediction techniques to reduce redundant information in the video sequence 108. Redundant information may comprise information that may be predicted at a decoder and need not be transmitted to the decoder for accurate decoding of the video sequence 108. For example, the encoder 114 may apply spatial prediction (e.g., intra-frame or intra prediction), temporal prediction (e.g., inter-frame prediction or inter prediction), inter-layer prediction, and/or other prediction techniques to reduce redundant information in the video sequence 108. The encoder 114 may partition pictures comprising the video sequence 108 into rectangular regions referred to as blocks, for example, prior to applying one or more prediction techniques. The encoder 114 may then encode a block using the one or more of the prediction techniques.

The encoder 114 may search for a block similar to the block being encoded in another picture (e.g., a reference picture) of the video sequence 108, for example, for temporal prediction. The block determined during the search (e.g., a prediction block) may then be used to predict the block being encoded. The encoder 114 may form a prediction block based on data from reconstructed neighboring samples of the block to be encoded within the same picture of the video sequence 108, for example, for spatial prediction. A reconstructed sample may be a sample that was encoded and then decoded. The encoder 114 may determine a prediction error (e.g., a residual) based on the difference between a block being encoded and a prediction block. The prediction error may represent non-redundant information that may be sent/transmitted to a decoder for accurate decoding of the video sequence 108.

The encoder 114 may apply a transform to the prediction error (e.g. using a discrete cosine transform (DCT), or any other transform) to generate transform coefficients. The encoder 114 may form the bitstream 110 based on the transform coefficients and other information used to determine prediction blocks using/based on prediction types, motion vectors, and prediction modes. The encoder 114 may perform one or more of quantization and entropy coding of the transform coefficients and/or the other information used to determine the prediction blocks, for example, prior to forming the bitstream 110. The quantization and/or the entropy coding may further reduce the quantity of bits needed to store and/or transmit the video sequence 108.

The output interface 116 may be configured to write and/or store the bitstream 110 onto the transmission medium 104 for transmission to the destination device 106. The output interface 116 may be configured to send/transmit, upload, and/or stream the bitstream 110 to the destination device 106 via the transmission medium 104. The output interface 116 may comprise a wired and/or a wireless transmitter configured to send/transmit, upload, and/or stream the bitstream 110 in accordance with one or more proprietary, open-source, and/or standardized communication protocols (e.g., Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol).

The transmission medium 104 may comprise wireless, wired, and/or computer readable medium. For example, the transmission medium 104 may comprise one or more wires, cables, air interfaces, optical discs, flash memory, and/or magnetic memory. The transmission medium 104 may comprise one or more networks (e.g., the internet) or file servers configured to store and/or send/transmit encoded video data.

The destination device 106 may decode the bitstream 110 into the video sequence 108 for display. The destination device 106 may comprise one or more of an input interface 118, a decoder 120, and/or a video display 122. The input interface 118 may be configured to read the bitstream 110 stored on the transmission medium 104 by the source device 102. The input interface 118 may be configured to receive, download, and/or stream the bitstream 110 from the source device 102 via the transmission medium 104. The input interface 118 may comprise a wired and/or a wireless receiver configured to receive, download, and/or stream the bitstream 110 in accordance with one or more proprietary, open-source, standardized communication protocols, and/or any other communication protocol (e.g., such as referenced herein).

The decoder 120 may decode the video sequence 108 from the encoded bitstream 110. The decoder 120 may generate prediction blocks for pictures of the video sequence 108 in a similar manner as the encoder 114 and determine the prediction errors for the blocks, for example, to decode the video sequence 108. The decoder 120 may generate the prediction blocks using/based on prediction types, prediction modes, and/or motion vectors received in the bitstream 110. The decoder 120 may determine the prediction errors using the transform coefficients received in the bitstream 110. The decoder 120 may determine the prediction errors by weighting transform basis functions using the transform coefficients. The decoder 120 may combine the prediction blocks and the prediction errors to decode the video sequence 108. The video sequence 108 at the destination device 106 may be, or may not necessarily be, the same video sequence sent, such as the video sequence 108 as sent by the source device 102. The decoder 120 may decode a video sequence that approximates the video sequence 108, for example, because of lossy compression of the video sequence 108 by the encoder 114 and/or errors introduced into the encoded bitstream 110 during transmission to the destination device 106.

The video display 122 may display the video sequence 108 to a user. The video display 122 may comprise a cathode rate tube (CRT) display, a liquid crystal display (LCD), a plasma display, a light emitting diode (LED) display, and/or any other display device suitable for displaying the video sequence 108.

The video encoding/decoding system 100 is merely an example and video encoding/decoding systems different from the video encoding/decoding system 100 and/or modified versions of the video encoding/decoding system 100 may perform the methods and processes as described herein. For example, the video encoding/decoding system 100 may comprise other components and/or arrangements. The video source 112 may be external to the source device 102. The video display device 122 may be external to the destination device 106 or omitted altogether (e.g., if the video sequence 108 is intended for consumption by a machine and/or storage device). The source device 102 may further comprise a video decoder and the destination device 104 may further comprise a video encoder. For example, the source device 102 may be configured to further receive an encoded bit stream from the destination device 106 to support two-way video transmission between the devices.

The encoder 114 and/or the decoder 120 may operate according to one or more proprietary or industry video coding standards. For example, the encoder 114 and/or the decoder 120 may operate in accordance with one or more proprietary, open-source, and/or standardized protocols (e.g., International Telecommunications Union Telecommunication Standardization Sector (ITU-T) H.263, ITU-T H.264 and Moving Picture Expert Group (MPEG)-4 Visual (also known as Advanced Video Coding (AVC)), ITU-T H.265 and MPEG-H Part 2 (also known as High Efficiency Video Coding (HEVC)), ITU-T H.265 and MPEG-I Part 3 (also known as Versatile Video Coding (VVC)), the WebM VP8 and VP9 codecs, and/or AOMedia Video 1 (AV1), and/or any other video coding protocol).

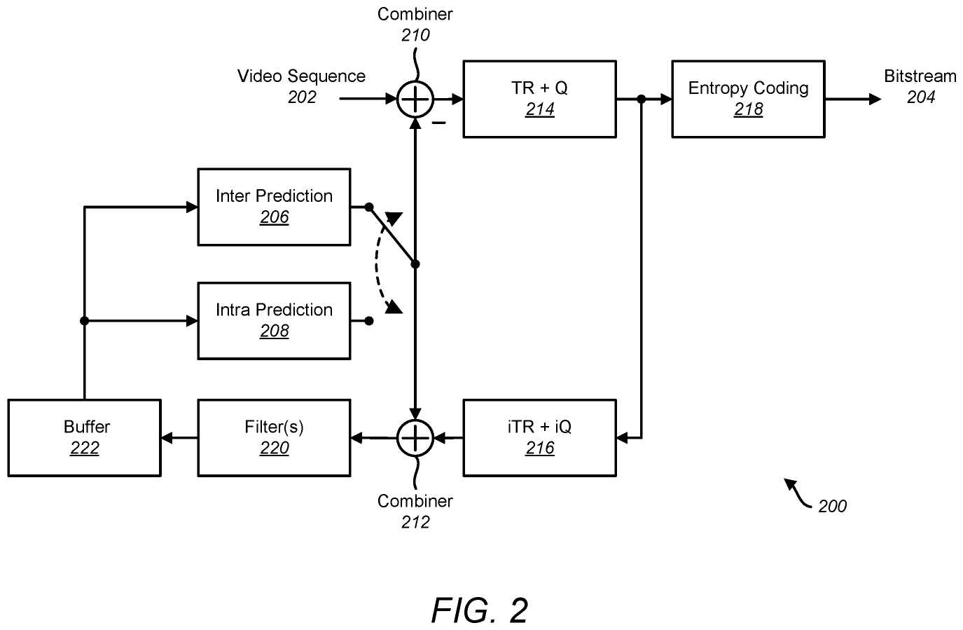

FIG. 2 shows an example encoder. The encoder 200 as shown in FIG. 2 may implement one or more processes described herein. The encoder 200 may encode a video sequence 202 into a bitstream 204 for more efficient storage and/or transmission. The encoder 200 may be implemented in the video coding/decoding system 100 as shown in FIG. 1 (e.g., as the encoder 114) or in any computing, communication, or electronic device (e.g., desktop computer, laptop computer, tablet computer, smart phone, wearable device, television, camera, video gaming console, set-top box, video streaming device, etc.). The encoder 200 may comprise one or more of an inter prediction unit 206, an intra prediction unit 208, combiners 210 and 212, a transform and quantization unit (TR+Q) 214, an inverse transform and quantization unit (iTR+iQ) 216, an entropy coding unit 218, one or more filters 220, and/or a buffer 222.

The encoder 200 may partition pictures (e.g., frames) of (e.g., comprising) the video sequence 202 into blocks and encode the video sequence 202 on a block-by-block basis. The encoder 200 may perform/apply a prediction technique on a block being encoded using either the inter prediction unit 206 or the intra prediction unit 208. The inter prediction unit 206 may perform inter prediction by searching for a block similar to the block being encoded in another, reconstructed picture (e.g., a reference picture) of the video sequence 202. The reconstructed picture may be a picture that was encoded and then decoded. The block determined during the search (e.g., a prediction block) may then be used to predict the block being encoded to remove redundant information. The inter prediction unit 206 may exploit temporal redundancy or similarities in scene content from picture to picture in the video sequence 202 to determine the prediction block. For example, scene content between pictures of the video sequence 202 may be similar except for differences due to motion and/or affine transformation of the screen content over time.

The intra prediction unit 208 may perform intra prediction by forming a prediction block based on data from reconstructed neighboring samples of the block to be encoded within the same picture of the video sequence 202. The reconstructed sample may be a sample that was encoded and then decoded. The intra prediction unit 208 may exploit spatial redundancy or similarities in scene content within a picture of the video sequence 202 to determine the prediction block. For example, the texture of a region of scene content in a picture may be similar to the texture in the immediate surrounding area of the region of the scene content in the same picture.

The combiner 210 may determine a prediction error (e.g., a residual) based on the difference between the block being encoded and the prediction block. The prediction error may represent non-redundant information that may be sent/transmitted to a decoder for accurate decoding of the video sequence 202.

The transform and quantization unit (TR+Q) 214 may transform and quantize the prediction error. The transform and quantization unit 214 may transform the prediction error into transform coefficients by applying, for example, a DCT to reduce correlated information in the prediction error. The transform and quantization unit 214 may quantize the coefficients by mapping data of the transform coefficients to a predefined set of representative values. The transform and quantization unit 214 may quantize the coefficients to reduce irrelevant information in the bitstream 204. The Irrelevant information may be information that may be removed from the coefficients without producing visible and/or perceptible distortion in the video sequence 202 after decoding (e.g., at a receiving device).

The entropy coding unit 218 may apply one or more entropy coding methods to the quantized transform coefficients to further reduce the bit rate. For example, the entropy coding unit 218 may apply context adaptive variable length coding (CAVLC), context adaptive binary arithmetic coding (CABAC), and/or syntax-based context-based binary arithmetic coding (SBAC). The entropy coded coefficients may be packed to form the bitstream 204.

The inverse transform and quantization unit (iTR+iQ) 216 may inverse quantize and inverse transform the quantized transform coefficients to determine a reconstructed prediction error. The combiner 212 may combine the reconstructed prediction error with the prediction block to form a reconstructed block. The filter(s) 220 may filter the reconstructed block, for example, using a deblocking filter and/or a sample-adaptive offset (SAO) filter. The buffer 222 may store the reconstructed block for prediction of one or more other blocks in the same and/or different picture of the video sequence 202.

The encoder 200 may further comprise an encoder control unit. The encoder control unit may be configured to control one or more units of the encoder 200 as shown in FIG. 2. The encoder control unit may control the one or more units of the encoder 200 such that the bitstream 204 may be generated in conformance with the requirements of one or more proprietary coding protocols, industry video coding standards, and/or any other video cording protocol. For example, the encoder control unit may control the one or more units of the encoder 200 such that bitstream 204 may be generated in conformance with one or more of ITU-T H.263, AVC, HEVC, VVC, VP8, VP9, AV1, and/or any other video coding standard/format.

The encoder control unit may attempt to minimize (or reduce) the bitrate of bitstream 204 and/or maximize (or increase) the reconstructed video quality (e.g., within the constraints of a proprietary coding protocol, industry video coding standard, and/or any other video cording protocol). For example, the encoder control unit may attempt to minimize or reduce the bitrate of bitstream 204 such that the reconstructed video quality may not fall below a certain level/threshold, and/or may attempt to maximize or increase the reconstructed video quality such that the bit rate of bitstream 204 may not exceed a certain level/threshold. The encoder control unit may determine/control one or more of: partitioning of the pictures of the video sequence 202 into blocks, whether a block is inter predicted by the inter prediction unit 206 or intra predicted by the intra prediction unit 208, a motion vector for inter prediction of a block, an intra prediction mode among a plurality of intra prediction modes for intra prediction of a block, filtering performed by the filter(s) 220, and/or one or more transform types and/or quantization parameters applied by the transform and quantization unit 214. The encoder control unit may determine/control one or more of the above based on a rate-distortion measure for a block or picture being encoded. The encoder control unit may determine/control one or more of the above to reduce the rate-distortion measure for a block or picture being encoded.

The prediction type used to encode a block (intra or inter prediction), prediction information of the block (intra prediction mode if intra predicted, motion vector, etc.), and/or transform and/or quantization parameters, may be sent to the entropy coding unit 218 to be further compressed (e.g., to reduce the bit rate). The prediction type, prediction information, and/or transform and/or quantization parameters may be packed with the prediction error to form the bitstream 204.

The encoder 200 is merely an example and encoders different from the encoder 200 and/or modified versions of the encoder 200 may perform the methods and processes as described herein. For example, the encoder 200 may comprise other components and/or arrangements. One or more of the components shown in FIG. 2 may be optionally included in the encoder 200 (e.g., the entropy coding unit 218 and/or the filters(s) 220).

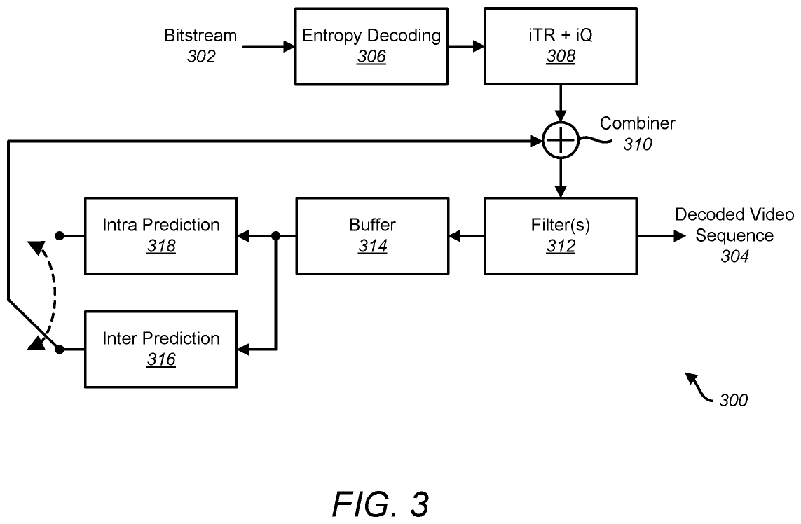

FIG. 3 shows an example decoder. A decoder 300 as shown in FIG. 3 may implement one or more processes described herein. The decoder 300 may decode a bitstream 302 into a decoded video sequence 304 for display and/or some other form of consumption. The decoder 300 may be implemented in the video encoding/decoding system 100 in FIG. 1 and/or in a computing, communication, or electronic device (e.g., desktop computer, laptop computer, tablet computer, smart phone, wearable device, television, camera, video gaming console, set-top box, and/or video streaming device). The decoder 300 may comprise an entropy decoding unit 306, an inverse transform and quantization (iTR+iQ) unit 308, a combiner 310, one or more filters 312, a buffer 314, an inter prediction unit 316, and/or an intra prediction unit 318.

The decoder 300 may comprise a decoder control unit configured to control one or more units of decoder 300. The decoder control unit may control the one or more units of decoder 300 such that the bitstream 302 is decoded in conformance with the requirements of one or more proprietary coding protocols, industry video coding standards, and/or any other communication protocol. For example, the decoder control unit may control the one or more units of decoder 300 such that the bitstream 302 is decoded in conformance with one or more of ITU-T H.263, AVC, HEVC, VVC, VP8, VP9, AV1, and/or any other video coding standard/format.

The decoder control unit may determine/control one or more of: whether a block is inter predicted by the inter prediction unit 316 or intra predicted by the intra prediction unit 318, a motion vector for inter prediction of a block, an intra prediction mode among a plurality of intra prediction modes for intra prediction of a block, filtering performed by the filter(s) 312, and/or one or more inverse transform types and/or inverse quantization parameters to be applied by the inverse transform and quantization unit 308. One or more of the control parameters used by the decoder control unit may be packed in bitstream 302.

The Entropy decoding unit 306 may entropy decode the bitstream 302. The inverse transform and quantization unit 308 may inverse quantize and/or inverse transform the quantized transform coefficients to determine a decoded prediction error. The combiner 310 may combine the decoded prediction error with a prediction block to form a decoded block. The prediction block may be generated by the intra prediction unit 318 or the inter prediction unit 316 (e.g., as described above with respect to encoder 200 in FIG. 2). The filter(s) 312 may filter the decoded block, for example, using a deblocking filter and/or a sample-adaptive offset (SAO) filter. The buffer 314 may store the decoded block for prediction of one or more other blocks in the same and/or different picture of the video sequence in the bitstream 302. The decoded video sequence 304 may be output from the filter(s) 312 as shown in FIG. 3.

The decoder 300 is merely an example and decoders different from the decoder 300 and/or modified versions of the decoder 300 may perform the methods and processes as described herein. For example, the decoder 300 may have other components and/or arrangements. One or more of the components shown in FIG. 3 may be optionally included in the decoder 300 (e.g., the entropy decoding unit 306 and/or the filters(s) 312).

Although not shown in FIGS. 2 and 3, each of the encoder 200 and the decoder 300 may further comprise an intra block copy unit in addition to inter prediction and intra prediction units. The intra block copy unit may perform/operate similar to an inter prediction unit but may predict blocks within the same picture. For example, the intra block copy unit may exploit repeated patterns that appear in screen content. The screen content may include computer generated text, graphics, animation, etc.

Video encoding and/or decoding may be performed on a block-by-block basis. The process of partitioning a picture into blocks may be adaptive based on the content of the picture. For example, larger block partitions may be used in areas of a picture with higher levels of homogeneity to improve coding efficiency.

A picture (e.g., in HEVC, or any other coding standard/format) may be partitioned into non-overlapping square blocks, which may be referred to as coding tree blocks (CTBs). The CTBs may comprise samples of a sample array. A CTB may have a size of 2n×2n samples, where n may be specified by a parameter of the encoding system. For example, n may be 4, 5, 6, or any other value. A CTB may have any other size. A CTB may be further partitioned by a recursive quadtree partitioning into coding blocks (CBs) of half vertical and half horizontal size. The CTB may form the root of the quadtree. A CB that is not split further as part of the recursive quadtree partitioning may be referred to as a leaf CB of the quadtree, and otherwise may be referred to as a non-leaf CB of the quadtree. A CB may have a minimum size specified by a parameter of the encoding system. For example, a CB may have a minimum size of 4×4, 8×8, 16×16, 32×32, 64×64 samples, or any other minimum size. A CB may be further partitioned into one or more prediction blocks (PBs) for performing inter and/or intra prediction. A PB may be a rectangular block of samples on which the same prediction type/mode may be applied. For transformations, a CB may be partitioned into one or more transform blocks (TBs). A TB may be a rectangular block of samples that may determine/indicate an applied transform size.

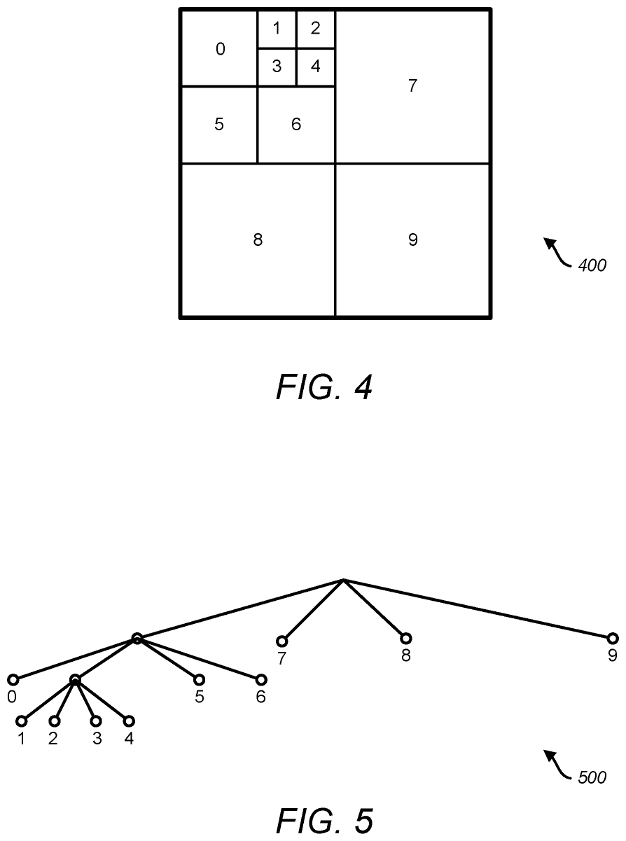

FIG. 4 shows an example quadtree partitioning of a CTB. FIG. 5 shows a quadtree corresponding to the example quadtree partitioning of the CTB 400 in FIG. 4. As shown in FIGS. 4 and 5, the CTB 400 may first be partitioned into four CBs of half vertical and half horizontal size. Three of the resulting CBs of the first level partitioning of CTB 400 may be leaf CBs. The three leaf CBs of the first level partitioning of CTB 400 are respectively labeled 7, 8, and 9 in FIGS. 4 and 5. The non-leaf CB of the first level partitioning of CTB 400 may be partitioned into four sub-CBs of half vertical and half horizontal size. Three of the resulting sub-CBs of the second level partitioning of CTB 400 may be leaf CBs. The three leaf CBs of the second level partitioning of CTB 400 are respectively labeled 0, 5, and 6 in FIGS. 4 and 5. The non-leaf CB of the second level partitioning of CTB 400 may be partitioned into four leaf CBs of half vertical and half horizontal size. The four leaf CBs may be respectively labeled 1, 2, 3, and 4 in FIGS. 4 and 5.

The CTB 400 of FIG. 4 may be partitioned into 10 leaf CBs respectively labeled 0-9, and/or any other quantity of leaf CBs. The 10 leaf CBs may correspond to 10 CB leaf nodes (e.g., 10 CB leaf nodes of the quadtree 500 as shown in FIG. 5). In other examples, a CTB may be partitioned into a different number of leaf CBs. The resulting quadtree partitioning of the CTB 400 may be scanned using a z-scan (e.g., left-to-right, top-to-bottom) to form the sequence order for encoding/decoding the CB leaf nodes. A numeric label (e.g., indicator, index) of each CB leaf node in FIGS. 4 and 5 may correspond to the sequence order for encoding/decoding. For example, CB leaf node 0 may be encoded/decoded first and CB leaf node 9 may be encoded/decoded last. Although not shown in FIGS. 4 and 5, each CB leaf node may comprise one or more PBs and/or TBs.

A picture, in VVC (or in any other coding standard/format), may be partitioned in a similar manner (such as in HEVC). A picture may be first partitioned into non-overlapping square CTBs. The CTBs may then be partitioned, using a recursive quadtree partitioning, into CBs of half vertical and half horizontal size. A quadtree leaf node (e.g., in VVC) may be further partitioned by a binary tree or ternary tree partitioning (or any other partitioning) into CBs of unequal sizes.

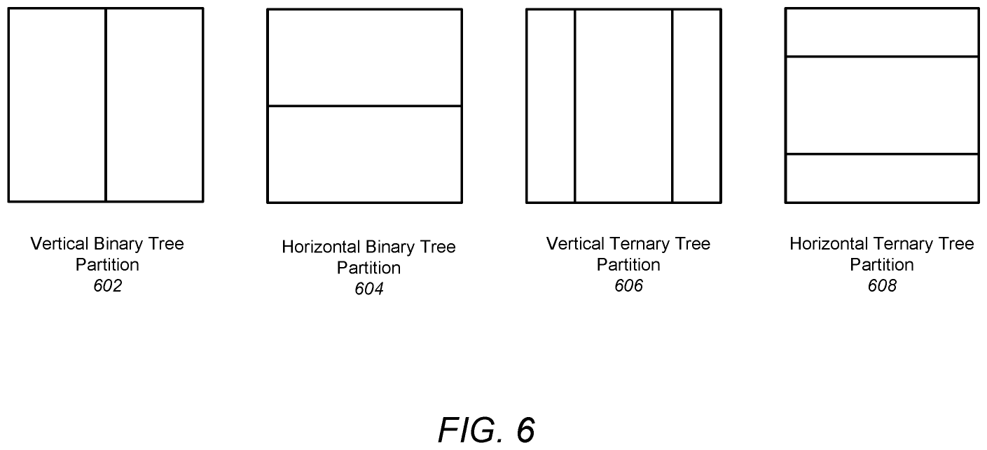

FIG. 6 shows example binary tree and ternary tree partitions. A binary tree partition may divide a parent block in half in either a vertical direction 602 or a horizontal direction 604. The resulting partitions may be half in size as compared to the parent block. The resulting partitions may correspond to sizes that are less than and/or greater than half of the parent block size. A ternary tree partition may divide a parent block into three parts in either a vertical direction 606 or a horizontal direction 608. FIG. 6 shows an example in which the middle partition may be twice as large as the other two end partitions in the ternary tree partitions. In other examples, partitions may be of other sizes relative to each other and to the parent block. Binary and ternary tree partitions are examples of multi-type tree partitioning. Multi-type tree partitions may comprise partitioning a parent block into other quantities of smaller blocks. The block partitioning strategy (e.g., in VVC) may be referred to as a combination of quadtree and multi-type tree partitioning (quadtree+multi-type tree partitioning) because of the addition of binary and/or ternary tree partitioning to quadtree partitioning.

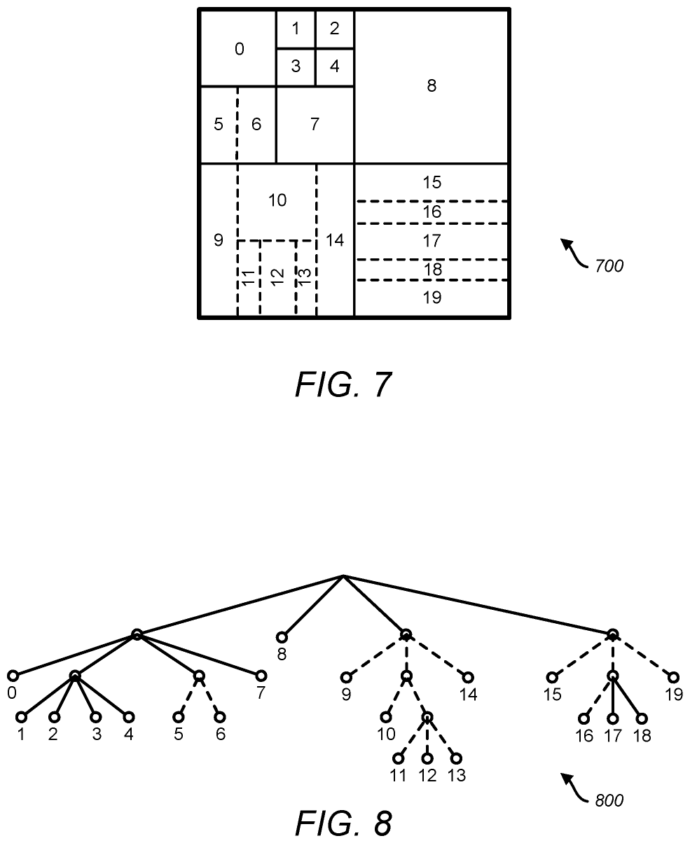

FIG. 7 shows an example of combined quadtree and multi-type tree partitioning of a CTB. FIG. 8 shows a tree corresponding to the combined quadtree and multi-type tree partitioning of the CTB 700 shown in FIG. 7. In both FIGS. 7 and 8, quadtree splits are shown in solid lines and multi-type tree splits are shown in dashed lines. The CTB 700 is shown with the same quadtree partitioning as the CTB 400 described in FIG. 4, and a description of the quadtree partitioning of the CTB 700 is omitted. The quadtree partitioning of the CTB 700 is merely an example and a CTB may be quadtree partitioned in a manner different from the CTB 700. Additional multi-type tree partitions of the CTB 700 may be made relative to three leaf CBs shown in FIG. 4. The three leaf CBs in FIG. 4 that are shown in FIG. 7 as being further partitioned may be leaf CBs 5, 8, and 9. The three leaf CBs may be further partitioned using one or more binary and/or ternary tree partitions.

The leaf CB 5 of FIG. 4 may be partitioned into two CBs based on a vertical binary tree partitioning. The two resulting CBs may be leaf CBs respectively labeled 5 and 6 in FIGS. 7 and 8. The leaf CB 8 of FIG. 4 may be partitioned into three CBs based on a vertical ternary tree partition. Two of the three resulting CBs may be leaf CBs respectively labeled 9 and 14 in FIGS. 7 and 8. The remaining, non-leaf CB may be partitioned first into two CBs based on a horizontal binary tree partition. One of the two CBs may be a leaf CB labeled 10. The other of the two CBs may be further partitioned into three CBs based on a vertical ternary tree partition. The resulting three CBs may be leaf CBs respectively labeled 11, 12, and 13 in FIGS. 7 and 8. The leaf CB 9 of FIG. 4 may be partitioned into three CBs based on a horizontal ternary tree partition. Two of the three CBs may be leaf CBs respectively labeled 15 and 19 in FIGS. 7 and 8. The remaining, non-leaf CB may be partitioned into three CBs based on another horizontal ternary tree partition. The resulting three CBs may all be leaf CBs respectively labeled 16, 17, and 18 in FIGS. 7 and 8.

Altogether, the CTB 700 may be partitioned into 20 leaf CBs respectively labeled 0-19. The 20 leaf CBs may correspond to 20 leaf nodes (e.g., 20 leaf nodes of the tree 800 shown in FIG. 8). The resulting combination of quadtree and multi-type tree partitioning of the CTB 700 may be scanned using a z-scan (left-to-right, top-to-bottom) to form the sequence order for encoding/decoding the CB leaf nodes. A numeric label of each CB leaf node in FIGS. 7 and 8 may correspond to the sequence order for encoding/decoding, with CB leaf node 0 encoded/decoded first and CB leaf node 19 encoded/decoded last. Although not shown in FIGS. 7 and 8, it should be noted that each CB leaf node may comprise one or more PBs and/or TBs.

A coding standard/format (e.g., HEVC, VVC, or any other coding standard/format) may define various units (e.g., in addition to specifying various blocks (e.g., CTBs, CBs, PBs, TBs)). Blocks may comprise a rectangular area of samples in a sample array. Units may comprise the collocated blocks of samples from the different sample arrays (e.g., luma and chroma sample arrays) that form a picture as well as syntax elements and prediction data of the blocks. A coding tree unit (CTU) may comprise the collocated CTBs of the different sample arrays and may form a complete entity in an encoded bit stream. A coding unit (CU) may comprise the collocated CBs of the different sample arrays and syntax structures used to code the samples of the CBs. A prediction unit (PU) may comprise the collocated PBs of the different sample arrays and syntax elements used to predict the PBs. A transform unit (TU) may comprise TBs of the different samples arrays and syntax elements used to transform the TBs.

A block may refer to any of a CTB, CB, PB, TB, CTU, CU, PU, and/or TU (e.g., in the context of HEVC, VVC, or any other coding format/standard). A block may be used to refer to similar data structures in the context of any video coding format/standard/protocol. For example, a block may refer to a macroblock in the AVC standard, a macroblock or a sub-block in the VP8 coding format, a superblock or a sub-block in the VP9 coding format, and/or a superblock or a sub-block in the AV1 coding format.

Samples of a block to be encoded (e.g., a current block) may be predicted from samples of the column immediately adjacent to the left-most column of the current block and samples of the row immediately adjacent to the top-most row of the current block, such as in intra prediction. The samples from the immediately adjacent column and row may be jointly referred to as reference samples. Each sample of the current block may be predicted (e.g., in an intra prediction mode) by projecting the position of the sample in the current block in a given direction to a point along the reference samples. The sample may be predicted by interpolating between the two closest reference samples of the projection point if the projection does not fall directly on a reference sample. A prediction error (e.g., a residual) may be determined for the current block based on differences between the predicted sample values and the original sample values of the current block.

Predicting samples and determining a prediction error based on a difference between the predicted samples and original samples may be performed (e.g., at an encoder) for a plurality of different intra prediction modes (e.g., including non-directional intra prediction modes). The encoder may select one of the plurality of intra prediction modes and its corresponding prediction error to encode the current block. The encoder may send an indication of the selected prediction mode and its corresponding prediction error to a decoder for decoding of the current block. The decoder may decode the current block by predicting the samples of the current block, using the intra prediction mode indicated by the encoder, and/or combining the predicted samples with the prediction error.

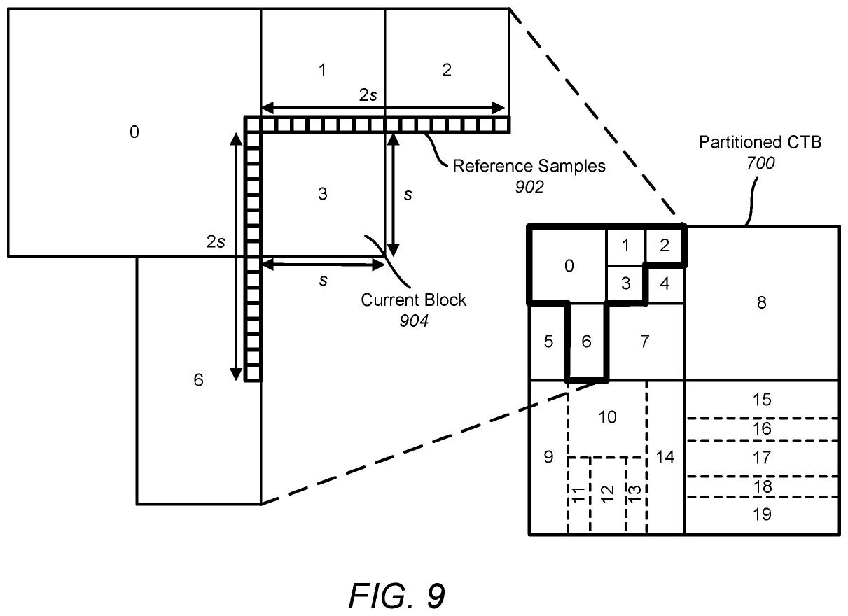

FIG. 9 shows an example set of reference samples determined for intra prediction of a current block. The current block 904 may correspond to a block being encoded and/or decoded. The current block 904 may correspond to block 3 of the partitioned CTB 700 as shown in FIG. 7. As described herein, the numeric labels 0-19 of the blocks of partitioned CTB 700 may correspond to the sequence order for encoding/decoding the blocks and may be used as such in the example of FIG. 9.

The current block 904 may be w×h samples in size. The reference samples 902 may comprise: 2w samples (or any other quantity of samples) of the row immediately adjacent to the top-most row of the current block 904, 2h samples (or any other quantity of samples) of the column immediately adjacent to the left-most column of the current block 904, and the top left neighboring corner sample to the current block 904. The current block 904 may be square, such that w=h=s. In other examples, a current block need not be square, such that w h. Available samples from neighboring blocks of the current block 904 may be used for constructing the set of reference samples 902. Samples may not be available for constructing the set of reference samples 902, for example, if the samples lie outside the picture of the current block, the samples are part of a different slice of the current block (e.g., if the concept of slices is used), and/or the samples belong to blocks that have been inter coded and constrained intra prediction is indicated. Intra prediction may not be dependent on inter predicted blocks, for example, if constrained intra prediction is indicated.

Samples that may not be available for constructing the set of reference samples 902 may comprise samples in blocks that have not already been encoded and reconstructed at an encoder and/or decoded at a decoder based on the sequence order for encoding/decoding. Restriction of such samples from inclusion in the set of reference samples 902 may allow identical prediction results to be determined at both the encoder and decoder. Samples from neighboring blocks 0, 1, and 2 may be available to construct the reference samples 902 given that these blocks are encoded and reconstructed at an encoder and decoded at a decoder prior to coding of the current block 904. The samples from neighboring blocks 0, 1, and 2 may be available to construct reference samples 902, for example, if there are no other issues (e.g., as mentioned above) preventing the availability of the samples from the neighboring blocks 0, 1, and 2. The portion of reference samples 902 from neighboring block 6 may not be available due to the sequence order for encoding/decoding (e.g., because the block 6 may not have already been encoded and reconstructed at the encoder and/or decoded at the decoder based on the sequence order for encoding/decoding).

Unavailable samples from the reference samples 902 may be filled with one or more of the available reference samples 902. For example, an unavailable reference sample may be filled with a nearest available reference sample. The nearest available reference sample may be determined by moving in a clock-wise direction through the reference samples 902 from the position of the unavailable reference. The reference samples 902 may be filled with the mid-value of the dynamic range of the picture being coded, for example, if no reference samples are available.

The reference samples 902 may be filtered based on the size of current block 904 being coded and an applied intra prediction mode. FIG. 9 shows an exemplary determination of reference samples for intra prediction of a block. Reference samples may be determined in a different manner than described above. For example, multiple reference lines may be used in other instances (e.g., in VVC).

Samples of the current block 904 may be intra predicted based on the reference samples 902, for example, based on (e.g., after) determination and (optionally) filtration of the reference samples. At least some (e.g., most) encoders/decoders may support a plurality of intra prediction modes in accordance with one or more video coding standards. For example, HEVC supports 35 intra prediction modes, including a planar mode, a direct current (DC) mode, and 33 angular modes. VVC supports 67 intra prediction modes, including a planar mode, a DC mode, and 65 angular modes. Planar and DC modes may be used to predict smooth and gradually changing regions of a picture. Angular modes may be used to predict directional structures in regions of a picture. Any quantity of intra prediction modes may be supported.

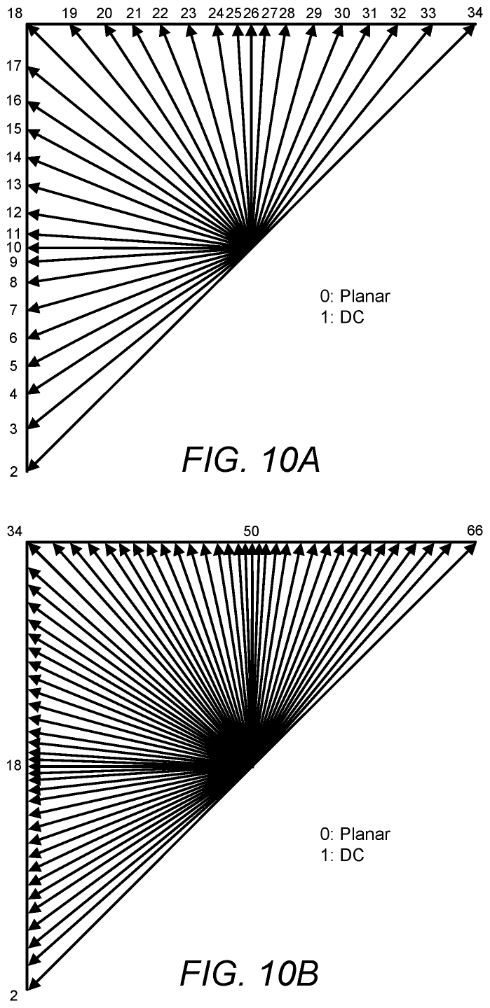

FIGS. 10A and 10B show example intra prediction modes. FIG. 10A shows 35 intra prediction modes, such as supported by HEVC. The 35 intra prediction modes may be indicated/identified by indices 0 to 34. Prediction mode 0 may correspond to planar mode. Prediction mode 1 may correspond to DC mode. Prediction modes 2-34 may correspond to angular modes. Prediction modes 2-18 may be referred to as horizontal prediction modes because the principal source of prediction is in the horizontal direction. Prediction modes 19-34 may be referred to as vertical prediction modes because the principal source of prediction is in the vertical direction.

FIG. 10B shows 67 intra prediction modes, such as supported by VVC. The 67 intra prediction modes may be indicated/identified by indices 0 to 66. Prediction mode 0 may correspond to planar mode. Prediction mode 1 corresponds to DC mode. Prediction modes 2-66 may correspond to angular modes. Prediction modes 2-34 may be referred to as horizontal prediction modes because the principal source of prediction is in the horizontal direction. Prediction modes 35-66 may be referred to as vertical prediction modes because the principal source of prediction is in the vertical direction. Some of the intra prediction modes illustrated in FIG. 10B may be adaptively replaced by wide-angle directions because blocks in VVC need not be squares.

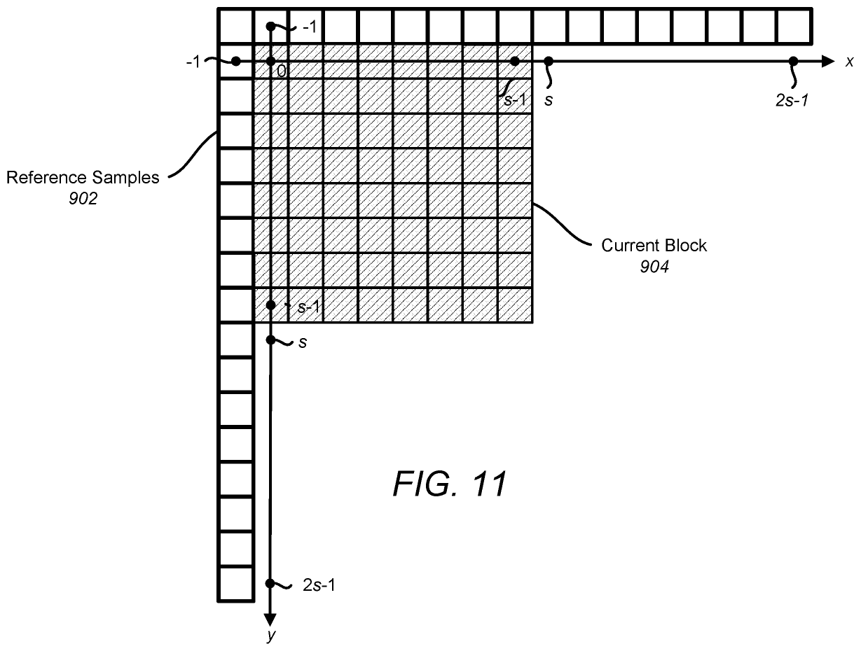

FIG. 11 shows a current block and corresponding reference samples. In FIG. 11, the current block 904 and the reference samples 902 from FIG. 9 are shown in a two-dimensional x, y plane, where a sample may be referenced as p[x][y]. In order to simplify the prediction process, the reference samples 902 may be placed in two, one-dimensional arrays. The reference samples 902, above the current block 904, may be placed in the one-dimensional array ref₁[x]:

ref₁[x]=p[−1+x][−1],(x≥0). (1)

The reference samples 902 to the left of the current block 904 may be placed in the one-dimensional array ref₂[y]:

ref₂[y]=p[−1][−1+y],(y≥0). (2)

The prediction process may comprise determination of a predicted sample p[x][y] (e.g., a predicted value) at a location [x][y] in the current block 904. For planar mode, a sample at the location [x][y] in the current block 904 may be predicted by determining/calculating the mean of two interpolated values. The first of the two interpolated values may be based on a horizontal linear interpolation at the location [x][y] in the current block 904. The second of the two interpolated values may be based on a vertical linear interpolation at the location [x][y] in the current block 904. The predicted sample p[x][y] in the current block 904 may be determined/calculated as:

$$\\ \begin{matrix}p [ x ] [ y ] = \frac{1}{2 \cdot s} ( h [ x ] [ y ] + v [ x ] [ y ] + s ) , & ( 3 )\end{matrix}$$

where

h[x][y]=(s−x−1)·ref₂[y]+(x+1)·ref₁[s] (4)

may be the horizontal linear interpolation at the location [x][y] in the current block 904 and

v[x][y]=(s−y−1)·ref₁[x]+(y+1)·ref₂[s] (5)

may be the vertical linear interpolation at the location [x][y] in the current block 904. s may be equal to a length of a side (e.g., a number of samples on a side) of the current block 904.

A sample at a location [x][y] in the current block 904 may be predicted by the mean of the reference samples 902, such as for a DC mode. The predicted sample p[x][y] in the current block 904 may be determined/calculated as:

$$\\ \begin{matrix}p [ x ] [ y ] = \frac{1}{2 \cdot s} ( {\sum }_{x = 0}^{s - 1} {ref}_{1} [ x ] + {\sum }_{y = 0}^{s - 1} {ref}_{2} [ y ] ) . & ( 6 )\end{matrix}$$

A sample at a location [x][y] in the current block 904 may be predicted by projecting the location [x][y] in a direction specified by a given angular mode to a point on the horizontal or vertical line of samples comprising the reference samples 902, such as for an angular mode. The sample at the location [x][y] may be predicted by interpolating between the two closest reference samples of the projection point if the projection does not fall directly on a reference sample. The direction specified by the angular mode may be given by an angle φ defined relative to the y-axis for vertical prediction modes (e.g., modes 19-34 in HEVC and modes 35-66 in VVC). The direction specified by the angular mode may be given by an angle φ defined relative to the x-axis for horizontal prediction modes (e.g., modes 2-18 in HEVC and modes 2-34 in VVC).

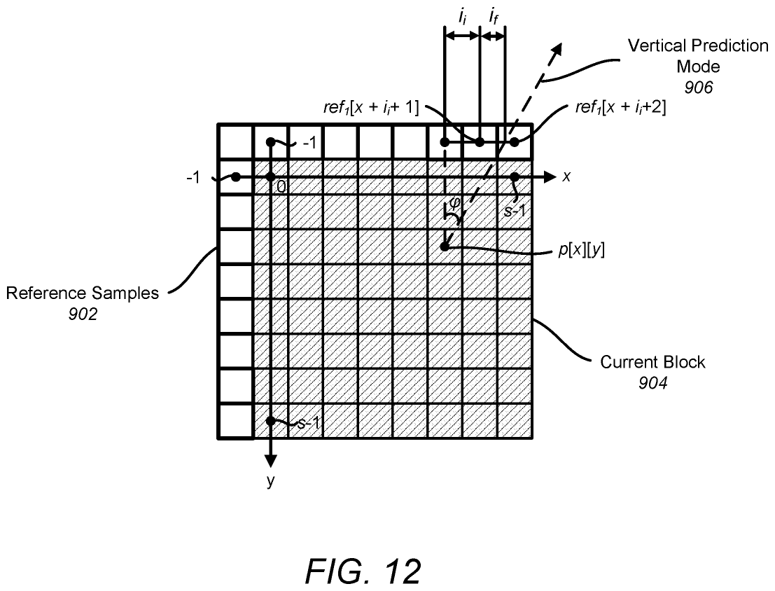

FIG. 12 shows an example application of an intra prediction mode for prediction of a current block. FIG. 12 specifically shows prediction of a sample at a location [x][y] in the current block 904 for a vertical prediction mode 906. The vertical prediction mode 906 may be given by an angle φ with respect to the vertical axis. The location [x][y] in the current block 904, in vertical prediction modes, may be projected to a point (e.g., a projection point) on the horizontal line of reference samples ref₁[x]. The reference samples 902 are only partially shown in FIG. 12 for ease of illustration. As shown in FIG. 12, the projection point on the horizontal line of reference samples ref₁[x] may not be exactly on a reference sample. A predicted sample p[x][y] in the current block 904 may be determined/calculated by linearly interpolating between the two reference samples, for example, if the projection point falls at a fractional sample position between two reference samples. The predicted sample p[x][y] may be determined/calculated as:

p[x][y]=(1−i_{f})·ref₁[x+iᵢ+1]+i_{f}·ref₁[x+iᵢ+2]. (7)

iᵢ may be the integer part of the horizontal displacement of the projection point relative to the location [x][y]. iᵢ may be determined/calculated as a function of the tangent of the angle φ of the vertical prediction mode 906 as:

iᵢ=└(y+1)·tan φ┘. (8)

i_{f} may be the fractional part of the horizontal displacement of the projection point relative to the location [x][y] and may be determined/calculated as:

i_{f}=((y+1)·tan φ)−└(y+1)·tan φ┘, (9)

where └⋅┘ is the integer floor function.

A location [x][y] of a sample in the current block 904 may be projected onto the vertical line of reference samples ref₂[y], such as for horizontal prediction modes. A predicted sample p[x][y] for horizontal prediction modes may be determined/calculated as:

p[x][y]=(1−i_{f})·ref₂[y+iᵢ+1]+i_{f}·ref₂[y+iᵢ+2]. (10)

iᵢ may be the integer part of the vertical displacement of the projection point relative to the location [x][y]. iᵢ may be determined/calculated as a function of the tangent of the angle φ of the horizontal prediction mode as:

iᵢ=└(x+1)·tan φ┘. (11)

i_{f} may be the fractional part of the vertical displacement of the projection point relative to the location [x][y]. i_{f} may be determined/calculated as:

i_{f}=((x+1)·tan φ)−└(x+1)·tan φ┘, (12)

where └⋅┘ is the integer floor function.

The interpolation functions given by Equations (7) and (10) may be implemented by an encoder and/or a decoder (e.g., the encoder 200 in FIG. 2 and/or the decoder 300 in FIG. 3). The interpolation functions may be implemented by finite impulse response (FIR) filters. For example, the interpolation functions may be implemented as a set of two-tap FIR filters. The coefficients of the two-tap FIR filters may be respectively given by (1−i_{f}) and i_{f}. The predicted sample p[x][y], in angular intra prediction, may be calculated with some predefined level of sample accuracy (e.g., 1/32 sample accuracy, or accuracy defined by any other metric). For 1/32 sample accuracy, the set of two-tap FIR interpolation filters may comprise up to 32 different two-tap FIR interpolation filters one for each of the 32 possible values of the fractional part of the projected displacement if. In other examples, different levels of sample accuracy may be used.

The FIR filters may be used for predicting chroma samples and/or luma samples. For example, the two-tap interpolation FIR filter may be used for predicting chroma samples and a same and/or a different interpolation technique/filter may be used for luma samples. For example, a four-tap FIR filter may be used to determine a predicted value of a luma sample. Coefficients of the four tap FIR filter may be determined based on i_{f} (e.g., similar to the two-tap FIR filter). For 1/32 sample accuracy, a set of 32 different four-tap FIR filters may comprise up to 32 different four-tap FIR filters—one for each of the 32 possible values of the fractional part of the projected displacement i_{f}. In other examples, different levels of sample accuracy may be used. The set of four-tap FIR filters may be stored in a look-up table (LUT) and referenced based on i_{f}. A predicted sample p[x][y], for vertical prediction modes, may be determined based on the four-tap FIR filter as:

$$\\ \begin{matrix}p [ x ] [ y ] = {\sum }_{i = 0}^{3} fT [ i ] \cdot {ref}_{1} [ x + iIdx + i ] , & ( 13 )\end{matrix}$$

where fT[i], i=0 . . . 0.3, may be the filter coefficients, and Idx is integer displacement. A predicted sample p[x][y], for horizontal prediction modes, may be determined based on the four-tap FIR filter as:

$$\\ \begin{matrix}p [ x ] [ y ] = {\sum }_{i = 0}^{3} fT [ i ] \cdot {ref}_{2} [ y + iIdx + i ] . & ( 14 )\end{matrix}$$

Supplementary reference samples may be determined/constructed if the location [x][y] of a sample in the current block 904 to be predicted is projected to a negative x coordinate. The location [x][y] of a sample may be projected to a negative x coordinate, for example, if negative vertical prediction angles φ are used. The supplementary reference samples may be determined/constructed by projecting the reference samples in ref₂[y] in the vertical line of reference samples 902 to the horizontal line of reference samples 902 using the negative vertical prediction angle φ. Supplementary reference samples may be similarly determined/constructed, for example, if the location [x][y] of a sample in the current block 904 to be predicted is projected to a negative y coordinate. The location [x][y] of a sample may be projected to a negative y coordinate, for example, if negative horizontal prediction angles φ are used. The supplementary reference samples may be determined/constructed by projecting the reference samples in ref₁[x] on the horizontal line of reference samples 902 to the vertical line of reference samples 902 using the negative horizontal prediction angle φ.

An encoder may determine/predict samples of a current block being encoded (e.g., the current block 904) for a plurality of intra prediction modes (e.g., using one or more of the functions described herein). For example, an encoder may determine/predict samples of a current block for each of 35 intra prediction modes in HEVC and/or 67 intra prediction modes in VVC. The encoder may determine, for each intra prediction mode applied, a corresponding prediction error for the current block based on a difference (e.g., sum of squared differences (SSD), sum of absolute differences (SAD), or sum of absolute transformed differences (SATD)) between the prediction samples determined for the intra prediction mode and the original samples of the current block. The encoder may determine/select one of the intra prediction modes to encode the current block based on the determined prediction errors. For example, the encoder may determine/select one of the intra prediction modes that results in the smallest prediction error for the current block. The encoder may determine/select the intra prediction mode to encode the current block based on a rate-distortion measure (e.g., Lagrangian rate-distortion cost) determined using the prediction errors. The encoder may send an indication of the determined/selected intra prediction mode and its corresponding prediction error (e.g., residual) to a decoder for decoding of the current block.

A decoder may determine/predict samples of a current block being decoded (e.g., the current block 904) for an intra prediction mode. For example, a decoder may receive an indication of an intra prediction mode (e.g., an angular intra prediction mode) from an encoder for a current block. The decoder may construct a set of reference samples and perform intra prediction based on the intra prediction mode indicated by the encoder for the current block in a similar manner (e.g., as described above for the encoder). The decoder may add predicted values of the samples (e.g., determined based on the intra prediction mode) of the current block to a residual of the current block to reconstruct the current block. A decoder need not receive an indication of an angular intra prediction mode from an encoder for a current block. A decoder may determine an intra prediction mode, for example, based on other criteria. While various examples herein correspond to intra prediction modes in HEVC and VVC, the methods, devices, and systems as described herein may be applied to/used for other intra prediction modes (e.g., as used in other video coding standards/formats, such as VP8, VP9, AV1, etc.).

Intra prediction may exploit correlations between spatially neighboring samples in the same picture of a video sequence to perform video compression. Inter prediction is another coding tool that may be used to perform video compression. Inter prediction may exploit correlations in the time domain between blocks of samples in different pictures of a video sequence. For example, an object may be seen across multiple pictures of a video sequence. The object may move (e.g., by some translation and/or affine motion) or remain stationary across the multiple pictures. A current block of samples in a current picture being encoded may have/be associated with a corresponding block of samples in a previously decoded picture. The corresponding block of samples may accurately predict the current block of samples. The corresponding block of samples may be displaced from the current block of samples, for example, due to movement of the object, represented in both blocks, across the respective pictures of the blocks. The previously decoded picture may be a reference picture. The corresponding block of samples in the reference picture may be a reference block for motion compensated prediction. An encoder may use a block matching technique to estimate the displacement (or motion) of the object and/or to determine the reference block in the reference picture.

An encoder may determine a difference between a current block and a prediction for a current block. An encoder may determine a difference, for example, based on/after determining/generating a prediction for a current block (e.g., using inter prediction). The difference may be a prediction error and/or as a residual. The encoder may store and/or send (e.g., signal), in/via a bitstream, the prediction error and/or other related prediction information. The prediction error and/or other related prediction information may be used for decoding and/or other forms of consumption. A decoder may decode the current block by predicting the samples of the current block (e.g., by using the related prediction information) and combining the predicted samples with the prediction error.

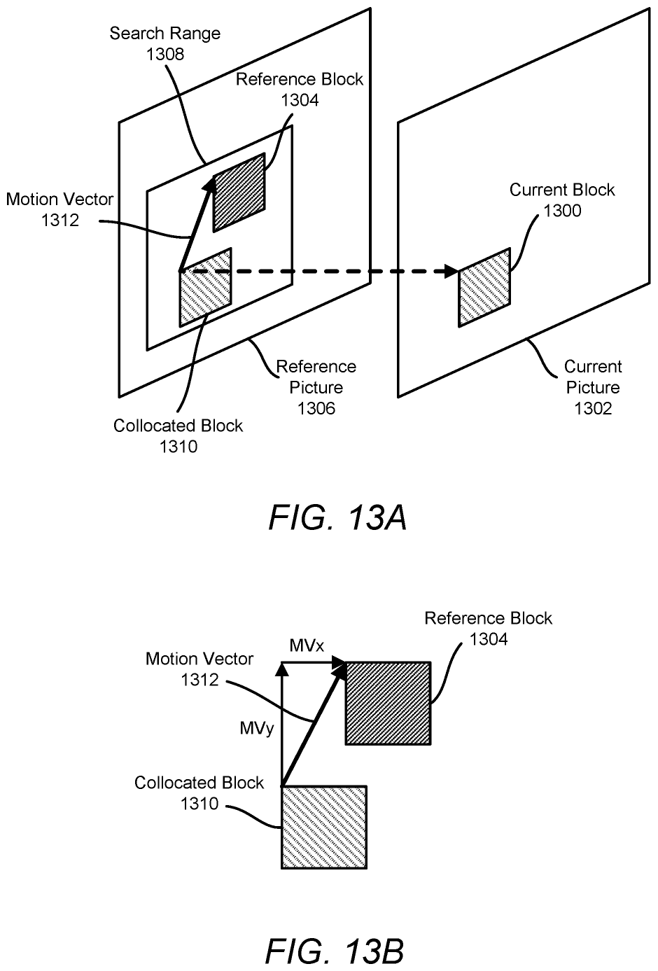

FIG. 13A shows an example of inter prediction. The inter prediction may be performed for a current block 1300 in a current picture 1302 being encoded. An encoder (e.g., the encoder 200 as shown in FIG. 2) may perform inter prediction to determine and/or generate a reference block 1304 in a reference picture 1306. The reference block 1304 may be used to predict the current block 1300. Reference pictures (e.g., the reference picture 1306) may be prior decoded pictures available at the encoder and/or a decoder. Availability of a prior decoded picture may depend/be based on whether the prior decoded picture is available in a decoded picture buffer, at the time, the current block 1300 is being encoded and/or decoded. The encoder may search the one or more reference pictures 1306 for a block that is similar (or substantially similar) to the current block 1300. The encoder may determine the best matching block from the blocks tested during the searching process. The best matching block may be a reference block 1304. The encoder may determine that the reference block 1304 is the best matching reference block based on one or more cost criteria. The one or more cost criteria may comprise a rate-distortion criterion (e.g., Lagrangian rate-distortion cost). The one or more cost criteria may be based on a difference (e.g., SSD, SAD, and/or SATD) between prediction samples of the reference block 1304 and original samples of the current block 1300.

The encoder may search for the reference block 1304 within a reference region (e.g., a search range 1308). The reference region (e.g., a search range 1308) may be positioned around a collocated position (or block) 1310, of the current block 1300, in the reference picture 1306. The collocated block 1310 may have a same position in the reference picture 1306 as the current block 1300 in the current picture 1302. The reference region (e.g., a search range 1308) may at least partially extend outside of the reference picture 1306. Constant boundary extension may be used, for example, if the reference region (e.g., a search range 1308) extends outside of the reference picture 1306. The constant boundary extension may be used such that values of the samples in a row or a column of reference picture 1306, immediately adjacent to a portion of the reference region (e.g., a search range 1308) extending outside of the reference picture 1306, may be used for sample locations outside of the reference picture 1306. A subset of potential positions, or all potential positions, within the reference region (e.g., a search range 1308) may be searched for the reference block 1304. The encoder may utilize one or more search implementations to determine and/or generate the reference block 1304. For example, the encoder may determine a set of candidate search positions based on motion information of neighboring blocks (e.g., a motion vector 1312) to the current block 1300.

One or more reference pictures may be searched by the encoder during inter prediction to determine and/or generate the best matching reference block. The reference pictures searched by the encoder may be included in (e.g., added to) one or more reference picture lists. For example, in HEVC and VVC (and/or in one or more other communication protocols), two reference picture lists may be used (e.g., a reference picture list 0 and a reference picture list 1). A reference picture list may include one or more pictures. The reference picture 1306 of the reference block 1304 may be indicated by a reference index pointing into a reference picture list comprising the reference picture 1306.

FIG. 13B shows an example motion vector. A displacement between the reference block 1304 and the current block 1300 may be interpreted as an estimate of the motion between the reference block 1304 and the current block 1300 across their respective pictures. The displacement may be represented by a motion vector 1312. For example, the motion vector 1312 may be indicated by a horizontal component (MVx) and a vertical component (MVy) relative to the position of the current block 1300. A motion vector (e.g., the motion vector 1312) may have fractional or integer resolution. A motion vector with fractional resolution may point between two samples in a reference picture to provide a better estimation of the motion of the current block 1300. For example, a motion vector may have ½, ¼, ⅛, 1/16, 1/32, or any other fractional sample resolution. Interpolation between the two samples at integer positions may be used to generate a reference block and its corresponding samples at fractional positions, for example, if a motion vector points to a non-integer sample value in the reference picture. The interpolation may be performed by a filter with two or more taps.

The encoder may determine a difference (e.g., a corresponding sample-by-sample difference) between the reference block 1304 and the current block 1300. The encoder may determine the difference between the reference block 1304 and the current block 1300, for example, based on/after the reference block 1304 is determined and/or generated, using inter prediction, for the current block 1300. The difference may be a prediction error and/or a residual. The encoder may store and/or send (e.g., signal), in/via a bitstream, the prediction error and/or related motion information. The prediction error and/or the related motion information may be used for decoding (e.g., decoding the current block 1300) and/or other forms of consumption. The motion information may comprise the motion vector 1312 and/or a reference indicator/index. The reference indicator may indicate the reference picture 1306 in a reference picture list. The motion information may comprise an indication of the motion vector 1312 and/or an indication of the reference index. The reference index may indicate reference picture 1306 in the reference picture list. A decoder may decode the current block 1300 by determining and/or generating the reference block 1304. The decoder may determine and/or generate the reference block 1304, for example, based on the prediction error and/or the related motion information. The reference block 1304 may correspond to/form (e.g., be considered as) a prediction of the current block 1300. The decoder may decode the current block 1300 based on combining the prediction with the prediction error.

Inter prediction, as shown in FIG. 13A, may be performed using one reference picture 1306 as a source of a prediction for the current block 1300. Inter prediction based on a prediction of a current block using a single picture may be referred to as uni-prediction.

Inter prediction of a current block, using bi-prediction, may be based on two pictures. Bi-prediction may be useful, for example, if a video sequence comprises fast motion, camera panning, zooming, and/or scene changes. Bi-prediction may be useful to capture fade outs of one scene or fade outs from one scene to another, where two pictures may effectively be displayed simultaneously with different levels of intensity.

One or both of uni-prediction and bi-prediction may be available/used for performing inter prediction (e.g., at an encoder and/or at a decoder). Performing a specific type of inter prediction (e.g., uni-prediction and/or bi-prediction) may depend on a slice type of current block. For example, for P slices, only uni-prediction may be available/used for performing inter prediction. For B slices, either uni-prediction or bi-prediction may be available/used for performing inter prediction. An encoder may determine and/or generate a reference block, for predicting a current block, from a reference picture list 0, for example, if the encoder is using uni-prediction. An encoder may determine and/or generate a first reference block, for predicting a current block, from a reference picture list 0 and determine and/or generate a second reference block, for predicting the current block, from a reference picture list 1, for example, if the encoder is using bi-prediction.

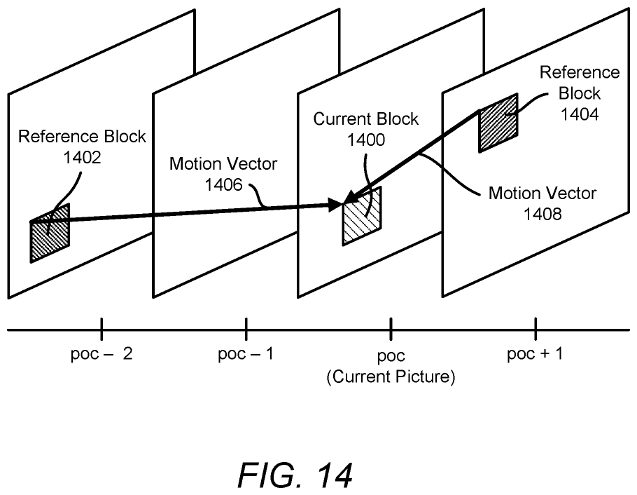

FIG. 14 shows an example of bi-prediction. Two reference blocks 1402 and 1404 may be used to predict a current block 1400. The reference block 1402 may be in a reference picture of one of reference picture list 0 or reference picture list 1. The reference block 1404 may be in a reference picture of another one of reference picture list 0 or reference picture list 1. As shown in FIG. 14, the reference block 1402 may be in a first picture that precedes (e.g., in time) a current picture of the current block 1400, and the reference block 1404 may be in a second picture that succeeds (e.g., in time) the current picture of the current block 1400. The first picture may precede the current picture in terms of a picture order count (POC). The second picture may succeed the current picture in terms of the POC. The reference pictures may both precede or both succeed the current picture in terms of POC. A POC may be/indicate an order in which pictures are output (e.g., from a decoded picture buffer). A POC may be/indicate an order in which pictures are generally intended to be displayed. Pictures that are output may not necessarily be displayed but may undergo different processing and/or consumption (e.g., transcoding). The two reference blocks determined and/or generated using/for bi-prediction may correspond to (e.g., be comprised in) a same reference picture. The reference picture may be included in both the reference picture list 0 and the reference picture list 1, for example, if the two reference blocks correspond to the same reference picture.

A configurable weight and/or offset value may be applied to one or more inter prediction reference blocks. An encoder may enable the use of weighted prediction using a flag in a picture parameter set (PPS). The encoder may send/signal the weight and/or offset parameters in a slice segment header for the current block 1400. Different weight and/or offset parameters may be sent/signaled for luma and/or chroma components.

The encoder may determine and/or generate the reference blocks 1402 and 1404 for the current block 1400 using inter prediction. The encoder may determine a difference between the current block 1400 and each of the reference blocks 1402 and 1404. The differences may be prediction errors or residuals. The encoder may store and/or send/signal, in/via a bitstream, the prediction errors and/or their respective related motion information. The prediction errors and their respective related motion information may be used for decoding and/or other forms of consumption. The motion information for the reference block 1402 may comprise a motion vector 1406 and/or a reference indicator/index. The reference indicator may indicate a reference picture, of the reference block 1402, in a reference picture list. The motion information for the reference block 1402 may comprise an indication of the motion vector 1406 and/or an indication of the reference index. The reference index may indicate the reference picture, of the reference block 1402, in the reference picture list.

The motion information for the reference block 1404 may comprise a motion vector 1408 and/or a reference index/indicator. The reference indicator may indicate a reference picture, of the reference block 1408, in a reference picture list. The motion information for the reference block 1404 may comprise an indication of motion vector 1408 and/or an indication of the reference index. The reference index may indicate the reference picture, of the reference block 1404, in the reference picture list.

A decoder may decode the current block 1400 by determining and/or generating the reference blocks 1402 and 1404. The decoder may determine and/or generate the reference blocks 1402 and 1404, for example, based on the prediction errors and/or the respective related motion information for the reference blocks 1402 and 1404. The reference blocks 1402 and 1404 may correspond to/form (e.g., be considered as) the predictions of the current block 1400. The decoder may decode the current block 1400 based on combining the predictions with the prediction errors.

Motion information may be predictively coded, for example, before being stored and/or sent/signaled in/via a bit stream (e.g., in HEVC, VVC, and/or other video coding standards/formats/protocols). The motion information for a current block may be predictively coded based on motion information of one or more blocks neighboring the current block. The motion information of the neighboring block(s) may often correlate with the motion information of the current block because the motion of an object represented in the current block is often the same as (or similar to) the motion of objects in the neighboring block(s). Motion information prediction techniques may comprise advanced motion vector prediction (AMVP) and/or inter prediction block merging.

An encoder (e.g., the encoder 200 as shown in FIG. 2), may code a motion vector. The encoder may code the motion vector (e.g., using AMVP) as a difference between a motion vector of a current block being coded and a motion vector predictor (MVP). An encoder may determine/select the MVP from a list of candidate MVPs. The candidate MVPs may be/correspond to previously decoded motion vectors of neighboring blocks in the current picture of the current block, and/or blocks at or near the collocated position of the current block in other reference pictures. The encoder and/or a decoder may generate and/or determine the list of candidate MVPs.

The encoder may determine/select an MVP from the list of candidate MVPs. The encoder may send/signal, in/via a bitstream, an indication of the selected MVP and/or a motion vector difference (MVD). The encoder may indicate the selected MVP in the bitstream using an index/indicator. The index may indicate the selected MVP in the list of candidate MVPs. The MVD may be determined/calculated based on a difference between the motion vector of the current block and the selected MVP. For example, for a motion vector that indicates a position (e.g., represented by a horizontal component (MVx) and a vertical component (MVy)) relative to a position of the current block being coded, the MVD may be represented by two components MVDₓ and MVD_{y}. MVDₓ and MVD_{y} may be determined/calculated as:

MVDₓ=MVₓ−MVPₓ, (15)

MVD_{y}=MV_{y}−MVP_{y}. (16)

MVDx and MVDy may respectively represent horizontal and vertical components of the MVD. MVPx and MVPy may respectively represent horizontal and vertical components of the MVP. A decoder (e.g., the decoder 300 as shown in FIG. 3) may decode the motion vector by adding the MVD to the MVP indicated in/via the bitstream. The decoder may decode the current block by determining and/or generating the reference block. The decoder may determine and/or generate the reference block, for example, based on the decoded motion vector. The reference block may correspond to/form (e.g., be considered as) the prediction of the current block. The decoder may decode the current block by combining the prediction with the prediction error.

The list of candidate MVPs (e.g., in HEVC, VVC, and/or one or more other communication protocols), for AMVP, may comprise two or more candidates (e.g., candidates A and B). Candidates A and B may comprise: up to two (or any other quantity of) spatial candidate MVPs determined/derived from five (or any other quantity of) spatial neighboring blocks of a current block being coded; one (or any other quantity of) temporal candidate MVP determined/derived from two (or any other quantity of) temporal, co-located blocks (e.g., if both of the two spatial candidate MVPs are not available or are identical); and/or zero motion vector candidate MVPs (e.g., if one or both of the spatial candidate MVPs or temporal candidate MVPs are not available). Other quantities of spatial candidate MVPs, spatial neighboring blocks, temporal candidate MVPs, and/or temporal, co-located blocks may be used for the list of candidate MVPs.

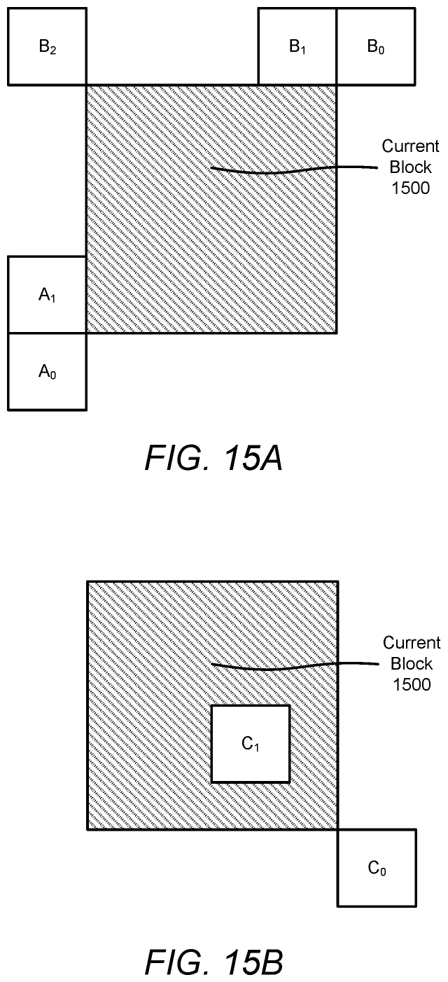

FIG. 15A shows spatial candidate neighboring blocks for a current block. For example, five (or any other quantity of) spatial candidate neighboring blocks may be located relative to a current block 1500 being encoded. The five spatial candidate neighboring blocks may be A0, A1, B0, B1, and B2. FIG. 15B shows temporal, co-located blocks for the current block. For example, two (or any other quantity of) temporal, co-located blocks may be located relative to the current block 1500. The two temporal, co-located blocks may be C0 and C1. The two temporal, co-located blocks may be in one or more reference pictures that may be different from the current picture of the current block 1500.

An encoder (e.g., the encoder 200 as shown in FIG. 2) may code a motion vector using inter prediction block merging (e.g., a merge mode). The encoder (e.g., using merge mode) may reuse the same motion information of a neighboring block (e.g., one of neighboring blocks A0, A1, B0, B1, and B2) for inter prediction of a current block. The encoder (e.g., using merge mode) may reuse the same motion information of a temporal, co-located block (e.g., one of temporal, co-located blocks C0 and C1) for inter prediction of a current block. An MVD need not be sent (e.g., indicated, signaled) for the current block because the same motion information as that of a neighboring block or a temporal, co-located block may be used for the current block (e.g., at the encoder and/or a decoder). A signaling overhead for sending/signaling the motion information of the current block may be reduced because the MVD need not be indicated for the current block. The encoder and/or the decoder may generate a candidate list of motion information from neighboring blocks or temporal, co-located blocks of the current block (e.g., in a manner similar to AMVP). The encoder may determine to use (e.g., inherit) motion information, of one neighboring block or one temporal, co-located block in the candidate list, for predicting motion information of the current block being coded. The encoder may signal/send, in/via a bit stream, an indication of the determined motion information from the candidate list. For example, the encoder may signal/send an indicator/index. The index may indicate the determined motion information in the list of candidate motion information. The encoder may signal/send the index to indicate the determined motion information.

A list of candidate motion information for merge mode (e.g., in HEVC, VVC, or any other coding formats/standards/protocols) may comprise: up to four (or any other quantity of) spatial merge candidates derived/determined from five (or any other quantity of) spatial neighboring blocks (e.g., as shown in FIG. 15A); one (or any other quantity of) temporal merge candidate derived from two (or any other quantity of) temporal, co-located blocks (e.g., as shown in FIG. 15B); and/or additional merge candidates comprising bi-predictive candidates and zero motion vector candidates. The spatial neighboring blocks and the temporal, co-located blocks used for merge mode may be the same as the spatial neighboring blocks and the temporal, co-located blocks used for AMVP.

Inter prediction may be performed in other ways and variants than those described herein. For example, motion information prediction techniques other than AMVP and merge mode may be used. While various examples herein correspond to inter prediction modes, such as used in HEVC and VVC, the methods, devices, and systems as described herein may be applied to/used for other inter prediction modes (e.g., as used for other video coding standards/formats such as VP8, VP9, AV1, etc.). History based motion vector prediction (HMVP), combined intra/inter prediction mode (CIIP), and/or merge mode with motion vector difference (MMVD) (e.g., as described in VVC) may be performed/used and are within the scope of the present disclosure.

Block matching may be used (e.g., in inter prediction) to determine a reference block in a different picture than that of a current block being encoded. Block matching may be used to determine a reference block in a same picture as that of a current block being encoded. The reference block, in a same picture as that of the current block, as determined using block matching may often not accurately predict the current block (e.g., for camera captured videos). Prediction accuracy for screen content videos may not be similarly impacted, for example, if a reference block in the same picture as that of the current block is used for encoding. Screen content videos may comprise, for example, computer generated text, graphics, animation, etc. Screen content videos may comprise (e.g., may often comprise) repeated patterns (e.g., repeated patterns of text and/or graphics) within the same picture. Using a reference block (e.g., as determined using block matching), in a same picture as that of a current block being encoded, may provide efficient compression for screen content videos.

A prediction technique may be used (e.g., in HEVC, VVC, and/or any other coding standards/formats/protocols) to exploit correlation between blocks of samples within a same picture (e.g., of screen content videos). The prediction technique may be intra block copy (IBC) or current picture referencing (CPR). An encoder may apply/use a block matching technique (e.g., similar to inter prediction) to determine a displacement vector (e.g., a block vector (BV)). The BV may indicate a relative position of a reference block (e.g., in accordance with intra block compensated prediction), that best matches the current block, from a position of the current block. For example, the relative position of the reference block may be a relative position of a top-left corner (or any other point/sample) of the reference block. The BV may indicate a relative displacement from the current block to the reference block that best matches the current block. The encoder may determine the best matching reference block from blocks tested during a searching process (e.g., in a manner similar to that used for inter prediction). The encoder may determine that a reference block is the best matching reference block based on one or more cost criteria. The one or more cost criteria may comprise a rate-distortion criterion (e.g., Lagrangian rate-distortion cost). The one or more cost criteria may be based on, for example, one or more differences (e.g., an SSD, an SAD, an SATD, and/or a difference determined based on a hash function) between the prediction samples of the reference block and the original samples of the current block. A reference block may correspond to/comprise prior decoded blocks of samples of the current picture. The reference block may comprise decoded blocks of samples of the current picture prior to being processed by in-loop filtering operations (e.g., deblocking and/or SAO filtering).

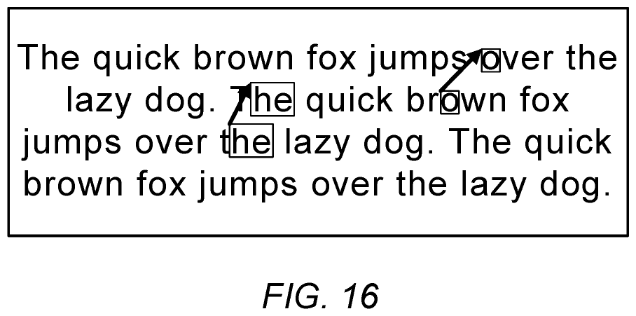

FIG. 16 shows an example of IBC for encoding. The example IBC shown in FIG. 16 may correspond to screen content. The rectangular portions/sections with arrows beginning at their boundaries may be the current blocks being encoded. The rectangular portions/sections that the arrows point to may be the reference blocks for predicting the current blocks.

A reference block may be determined and/or generated, for a current block, for IBC. The encoder may determine a difference (e.g., a corresponding sample-by-sample difference) between the reference block and the current block. The difference may be a prediction error or residual. The encoder may store and/or send/signal, in/via a bitstream the prediction error and/or related prediction information. The prediction error and/or the related prediction information may be used for decoding and/or other forms of consumption. The prediction information may comprise a BV. The prediction information may comprise an indication of the BV. A decoder (e.g., the decoder 300 as shown in FIG. 3), may decode the current block by determining and/or generating the reference block. The decoder may determine and/or generate the current block, for example, based on the prediction information (e.g., the BV). The reference block may correspond to/form (e.g., be considered as) the prediction of the current block. The decoder may decode the current block by combining the prediction with the prediction error.

A BV may be predictively coded (e.g., in HEVC, VVC, and/or any other coding standards/formats/protocols) before being stored and/or sent/signaled in/via a bit stream. The BV for a current block may be predictively coded based on a BV of one or more blocks neighboring the current block. For example, an encoder may predictively code a BV using the merge mode (e.g., in a manner similar to as described herein for inter prediction), AMVP (e.g., as described herein for inter prediction), or a technique similar to AMVP. The technique similar to AMVP may be BV prediction and difference coding (or AMVP for IBC).

An encoder (e.g., the encoder 200 as shown in FIG. 2) performing BV prediction and coding may code a BV as a difference between the BV of a current block being coded and a block vector predictor (BVP). An encoder may select/determine the BVP from a list of candidate BVPs. The candidate BVPs may comprise/correspond to previously decoded BVs of neighboring blocks in the current picture of the current block. The encoder and/or a decoder may generate or determine the list of candidate BVPs.

The encoder may send/signal, in/via a bitstream, an indication of the selected BVP and a block vector difference (BVD). The encoder may indicate the selected BVP in the bitstream using an index/indicator. The index may indicate the selected BVP in the list of candidate BVPs. The BVD may be determined/calculated based on a difference between a BV of the current block and the selected BVP. For example, for a BV that indicates a position (e.g., represented by a horizontal component (BVx) and a vertical component (BVy)) relative to a position of the current block being coded, the BVD may represented by two components BVDₓ and BVD_{y}. BVDₓ and BVD_{y} may be determined/calculated as:

BVDₓ=BVₓ−BVPₓ, (17)

BVD_{y}=BV_{y}−BVP_{y}. (18)

BVDx and BVDy may respectively represent horizontal and vertical components of the BVD. BVPx and BVPy may respectively represent horizontal and vertical components of the BVP. A decoder (e.g., the decoder 300 as shown in FIG. 3), may decode the BV by adding the BVD to the BVP indicated in/via the bitstream. The decoder may decode the current block by determining and/or generating the reference block. The decoder may determine and/or generate the reference block, for example, based on the decoded BV. The reference block may correspond to/form (e.g., be considered as) the prediction of the current block. The decoder may decode the current block by combining the prediction with the prediction error.

A same BV as that of a neighboring block may be used for the current block and a BVD need not be separately signaled/sent for the current block, such as in the merge mode. A BVP (in the candidate BVPs), which may correspond to a decoded BV of the neighboring block, may itself be used as a BV for the current block. Not sending the BVD may reduce the signaling overhead.

A list of candidate BVPs (e.g., in HEVC, VVC, and/or any other coding standard/format/protocol) may comprise two (or more) candidates. The candidates may comprise candidates A and B. Candidates A and B may comprise: up to two (or any other quantity of) spatial candidate BVPs determined/derived from five (or any other quantity of) spatial neighboring blocks of a current block being encoded; and/or one or more of last two (or any other quantity of) coded BVs (e.g., if spatial neighboring candidates are not available). Spatial neighboring candidates may not be available, for example, if neighboring blocks are encoded using intra prediction or inter prediction. Locations of the spatial candidate neighboring blocks, relative to a current block, being encoded using IBC may be illustrated in a manner similar to spatial candidate neighboring blocks used for coding motion vectors in inter prediction (e.g., as shown in FIG. 15A). For example, five spatial candidate neighboring blocks for IBC may be respectively denoted A0, A1, B0, B1, and B2.

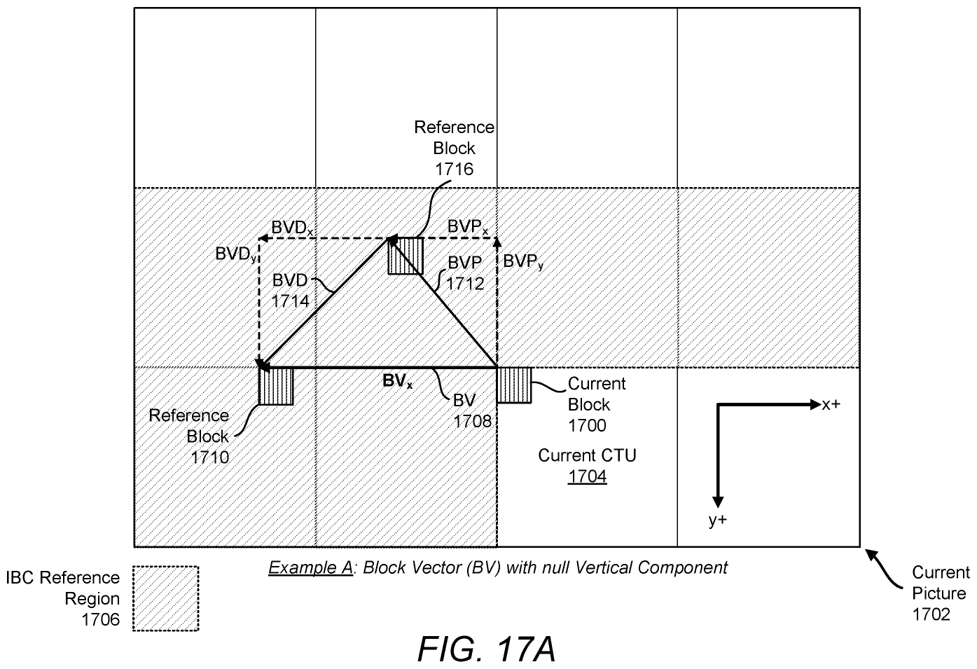

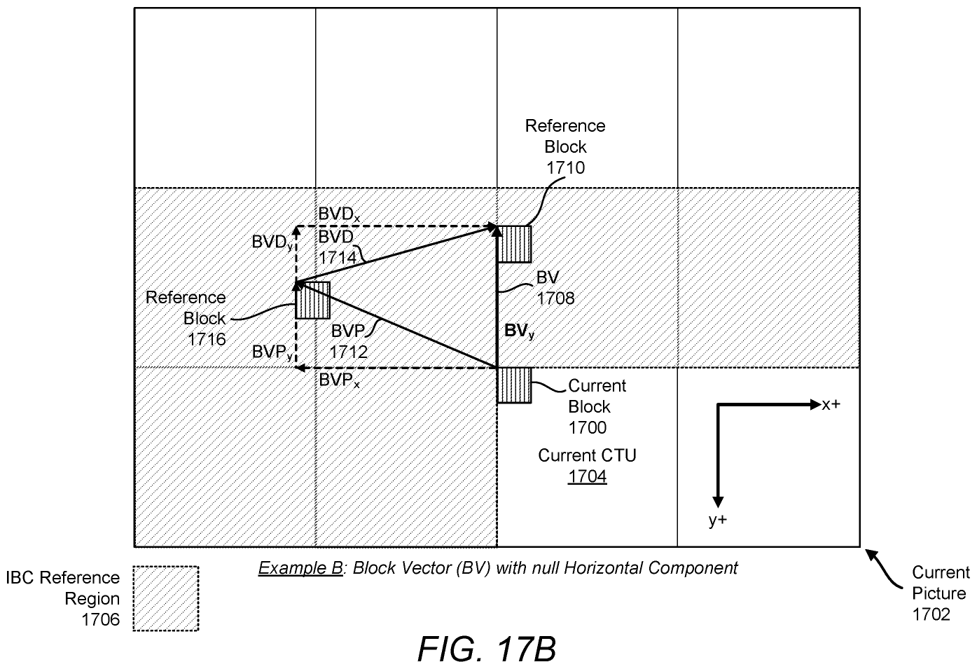

FIG. 17A shows an example of a BV comprising a null vertical component. The BV may be associated with/correspond to a BVP and a BVD.

FIG. 17A further shows an example of IBC predictive coding. An encoder (e.g., the encoder 200 in FIG. 2, or any other encoder) may use an IBC prediction mode to code a current block 1700 in a current picture (or portion of a current picture) 1702. The current block 1700 may be a prediction block (PB) or CB within a CTU 1704. A (PB may also be referred to as a reference block (RB). IBC may comprise searching for a reference block in a same, current picture as the current block, unlike inter prediction that comprises searching for a reference block in a prior decoded picture that is different than the picture of the current block being encoded. As a result, only a part of the current picture may be available for searching for a reference block in IBC. For example, only the part of the current picture that has been decoded prior to the encoding of the current block may be available for searching for a reference block in IBC. Searching for a reference block in the part of the current picture that has been decoded prior to the encoding of the current block may ensure the encoding and decoding systems can produce identical results but may also limit an IBC reference region.

Blocks may be scanned (e.g., from left-to-right, top-to-bottom) using a z-scan to form a sequence order for encoding/decoding (e.g., in HEVC, VVC, and/or any other video compression standards). The CTUs (represented by the large, square tiles in FIG. 17A) to the left and in the row immediately above current CTU 1704 may be encoded/decoded, based on the z-scan, prior to the current CTU 1704 and current block 1700 (e.g., prior to encoding the current CTU 1704 and current block 1700). The samples of the CTUs (e.g., as shown with hatching in FIG. 17A) may form an exemplary IBC reference region 1706 for determining a reference block to predict/encode/decode the current block 1700. A different sequence order for encoding/decoding may be used (e.g., in other video encoders, decoders, and/or video compression standards). The IBC reference region 1706 (e.g., location of the IBC reference region) may be affected based on the sequence order.

One or more additional reference region constraints (e.g., in addition to the encoding/decoding sequence order) may be placed on the IBC reference region 1706. For example, the IBC reference region 1706 may be constrained to CTUs based on a parallel processing approach (e.g., use of tiles or wavefront parallel processing (WPP)). Tiles may be used, as part of a picture partitioning process, for flexibly subdividing a picture into rectangular regions of CTUs such that coding dependencies between CTUs of different tiles are not allowed. WPP may be similarly used, as part of a picture partitioning process, for partitioning a picture into CTU rows such that dependencies between CTUs of different partitions are not allowed. Use of tiles or WPP may enable parallel processing of the picture partitions. For example, the top row of CTUs shown in FIG. 17A may not be part of IBC reference region 1706 due to one of the parallel processing approaches.

The encoder may use/apply a block matching technique to determine a BV 1708. The BV may indicate a relative displacement from the current block 1700 to a reference block 1710 within the IBC reference region 1706. The reference block 1710 may be a block that matches or best matches the current block 1700 (e.g., in accordance with intra block compensated prediction). The IBC reference region 1706 may be a constraint that may be applied to the BV 1708. The BV 1708 may be constrained by the IBC reference region 1706 to indicate a displacement from the current block 1700 (e.g., position of the current block 1700) to the reference block 1710 (e.g., position of the reference block 1710) that is within the IBC reference region 1706. The positions of the current block 1700 and the reference block 1710 may be determined, for example, based on the positions of their respective top-left samples.

The encoder may determine the best matching reference block from among blocks (e.g., within the IBC reference region 1706) that are tested. The encoder may determine the best matching reference block from among blocks (e.g., within the IBC reference region 1706) that are tested, for example, if a searching process occurs. The encoder may determine that the reference block 1710 may be the best matching reference block, for example, based on one or more cost criteria. The one or more cost criteria may comprise a rate-distortion criterion (e.g., Lagrangian rate-distortion cost). The one or more cost criteria may be based on, for example, one or more differences (e.g., one or more of an SSD, an SAD, an SATD, and/or a difference determined based on a hash function) between prediction samples of the reference block and original samples of the current block 1700. The reference block 1710 may comprise decoded (and/or reconstructed) samples of the current picture 1702 prior to being processed by in-loop filtering operations (e.g., deblocking and/or SAO filtering).

The encoder may determine and/or use a difference (e.g., a corresponding sample-by-sample difference) between the current block 1700 and the reference block 1710. The difference may be referred to as a prediction error or residual. The encoder may store and/or send/signal, in/via a bitstream, the prediction error and related prediction information for decoding.

The prediction information may include the BV 1708. The prediction information may include an indication of the BV 1708. The BV 1708 may be predictively coded. The BV 1708 may be predictively coded, for example, before being stored and/or signaled via a bit stream (e.g., in HEVC, VVC, and/or other video compression schemes). The BV 1708 for the current block 1700 may be predictively coded (e.g., using a similar technique as AMVP for inter prediction). The BV 1708 may be predictively coded technique using BV prediction and difference coding. The encoder may code the BV 1708 as a difference between the BV 1708 and a BVP 1712, for example, if using BV prediction and difference coding technique. The encoder may select the BVP 1712 from a list of candidate BVPs. The candidate BVPs may be determined based on/from previously decoded BVs of blocks neighboring the current block 1700 and/or from other sources. Both the encoder and decoder may generate and/or determine the list of candidate BVPs. The list of candidate BVPs may comprise as an AMVP List.

The encoder may determine a BVD 1714, for example, based on the encoder selecting the BVP 1712 from the list of candidate BVPs. The BVD 1714 may be calculated, for example, based on the difference between the BV 1708 and the BVP 1712. For example, the BVD 1714 may be represented by two directional components calculated according to equations (17) and (18), which are reproduced below:

BVDₓ=BVₓ−BVPₓ (17)

BVD_{y}=BV_{y}−BVP_{y} (18)

BVDₓ and BVD_{y} may respectively represent the horizontal and vertical components of the BVD 1714. BVₓ and BV_{y} may respectively represent the horizontal and vertical components of the BV 1708. BVPₓ and BVP_{y} may respectively represent the horizontal and vertical components of the BVP 1712. The horizontal x-axis and vertical y-axis, as well as indications of the direction of a positive sign of the x-axis and y-axis, are indicated in the lower right-hand corner of current picture 1702 for reference purposes.

FIG. 17A further shows an example wherein the BV 1708 comprises a non-null horizontal component BVₓ and a null vertical component BV_{y} (e.g., BV_{y}=0). The BVP 1712 may indicate a displacement from the current block 1700 to a secondary reference block 1716. The BVP 1712 may be a candidate for prediction included in the list of candidate BVPs (e.g., an AMVP list). As shown in FIG. 17A, the BVP 1712 may comprise a non-null vertical component BVPs and a non-null horizontal component BVPₓ. The BVD 1714 may indicate a displacement from the reference block 1716 to the reference block 1710. The BVD 1714 may comprise a non-null horizontal component BVD, and a non-null vertical component BVD_{y}.

The reference block 1716 may be selected/located using a block matching technique (e.g., similar to a block matching technique used for selecting the reference block 1710). An encoder and/or a decoder may determine that the reference block 1710 is preferred for prediction of the current block 1700 compared to the reference block 1716. An encoder and/or a decoder may determine that the reference block 1710 is preferred for prediction of the current block 1700 compared to the reference block 1716, for example, based on one or more cost criterion as discussed herein. The location of the reference block 1710 may be determined, for example, based on a displacement from the location of current block 1700 (e.g., by BVP 1712) to the location of reference block 1716, and a displacement from the location of reference block 1716 by (e.g., by BVD 1714) to the location of reference block 1710 (e.g., instead of the location of the reference block 1710 being determined based on BV 1708).

The combined displacements of BVP 1712 and BVD 1714 may indicate the location of reference block 1710. The combined displacements of BVP 1712 and BVD 1714 may indicate the location of reference block 1710, for example, such that reference block 1710 may be used for predicting or decoding current block 1700. The decoder may combine BVP 1712 (e.g., having non-null vertical component BVPs and non-null horizontal component BVPₓ), with BVD 1714 (having non-null vertical component BVD_{y} and non-null horizontal component BVDₓ), for example, to determine a location of the reference block 1710 in the IBC reference region 1706, to The decoder may combine BVP 1712 (e.g., having non-null vertical component BVPs and non-null horizontal component BVPₓ), with BVD 1714 (having non-null vertical component BVD_{y} and non-null horizontal component BVDₓ), even though the BV 1708 may comprise a null vertical component BV_{y} and a non-null horizontal component BVₓ.

The encoder may signal, via a bitstream, the prediction error, an indication of the selected BVP 1712 (e.g., via an index indicating the BVP 1712 in the list of candidate BVPs, such as an AMVP List), and the separate components of BVD 1714 (e.g., as determined based on equations (17) and (18)). A decoder (e.g., the decoder 300, or any other video decoder), may decode the BV 1708, for example, by adding corresponding components of the BVD 1714 to corresponding components of the BVP 1712. The decoder may determine and/or generate the reference block 1710 (e.g., which forms/corresponds to a prediction of current block 1700) using the decoded BV 1708. The decoder may decode the current block 1700, for example, by combining the prediction with the prediction error received via the bitstream.

FIG. 17B shows an example of a BV comprising a null horizontal component. The BV may be associated with (e.g., correspond to) a BVP and a BVD.

FIG. 17B further shows an example wherein BV 1708 comprises a non-null vertical component BV_{y} and a null horizontal component BVₓ (e.g., BVₓ=0). The BVP 1712 may indicate a displacement from a current block 1700 to a secondary reference block 1716. The BVP 1712 may be a candidate for prediction (e.g., of a reference block 1710) as included in a list of candidate BVPs (e.g., an AMVP list). The BVP 1712 may comprise a non-null horizontal component BVPₓ and a non-null vertical component BVPs. BVD 1714 may indicate a displacement from the reference block 1716 to the reference block 1710. The BVD 1714 may comprise a non-null vertical component BVD_{y} and a non-null horizontal component BVDₓ.

The reference block 1716 may be located (e.g., determined) using a block matching technique (e.g., similar to a block matching technique used for selecting the reference block 1710). An encoder and/or a decoder may determine that the reference block 1710 is preferred for prediction of the current block 1700 compared to the reference block 1716, for example, based on one or more cost criterion (e.g., as discussed herein). The location of the reference block 1710 may be determined, for example, based on a displacement from the location of current block 1700 (e.g., by BVP 1712) to the location of reference block 1716, and a displacement from the location of reference block 1716 (e.g., by BVD 1714) to the location of reference block 1710 (e.g., instead of the location of the reference block 1710 being determined based on BV 1708).

The combined displacements of BVP 1712 and BVD 1714 may indicate the location of reference block 1710. The reference block 1710 may be used for predicting or decoding the current block 1700. To determine a location of the reference block 1710 in the IBC reference region 1706, the decoder may combine BVP 1712 (e.g., having non-null horizontal component BVPₓ and non-null vertical component BVP_{y}), with BVD 1714 (e.g., having non-null horizontal component BVD, and non-null vertical component BVD_{y}), even though the BV 1708 may comprise a null horizontal component BVₓ and a non-null vertical component BV_{y}.

The encoder may signal, via a bitstream, the prediction error, an indication of the selected BVP 1712 (e.g., via an index indicating the BVP 1712 in the list of candidate BVPs, such as an AMVP List), and the separate components of BVD 1714 (e.g., as determined based on equations (17) and (18)). A decoder (e.g., the decoder 300, or any other video decoder), may decode the BV 1708, for example, by adding corresponding components of the BVD 1714 to corresponding components of the BVP 1712. The decoder may determine and/or generate the reference block 1710 (e.g., which forms/corresponds to a prediction of current block 1700) using the decoded BV 1708. The decoder may decode the current block 1700, for example, by combining the prediction with the prediction error received via the bitstream.

The IBC reference region 1706 (e.g., as shown in FIGS. 17A and 17B) is by way of example and an IBC reference region may be different from the IBC reference region 1706. The examples discussed herein may be applied to IBC reference regions that are different from the IBC reference region 1706.

The IBC reference region 1706, as shown in FIGS. 17A and 17B, may be replaced by an IBC reference region determined based on a different set of IBC reference region constraints. The IBC reference region 1706 may be constrained to include a number/quantity of decoded or reconstructed samples that may be stored in a limited memory size (e.g., IBC reference sample memory), for example, in addition to being constrained to a reconstructed part of the current picture 1702 and/or to one or more WPP partitions and/or tile partitions (e.g., as described with respect to FIGS. 17A and 17B). The size of the IBC reference sample memory may be limited based on being implemented on-chip with the encoder or decoder. The IBC reference region may be increased in size by using a larger size IBC reference sample memory off-chip from the encoder or decoder. Using an off-chip memory may require higher memory bandwidth requirements and increased delay in writing and/or reading samples (e.g., in the IBC reference region 1706) to and/or from the IBC reference sample memory.

The IBC reference region (e.g., the IBC reference region 1706) may be constrained to: a reconstructed part of the current CTU; and/or one or more reconstructed CTUs to the left of the current CTU. The one or more reconstructed CTUs to the left of the current CTU may not include a portion, of a left most one of the one or more reconstructed CTUs, that is collocated with either the reconstructed part of the current CTU or a virtual pipeline data unit (VPDU) in which the current block being coded is located. Blocks of samples in different CTUs may be collocated based on having a same size and/or CTU offset. A CTU offset of a block may be the offset of the block's top-left corner relative to the top-left corner of the CTU in which the block is located.

The IBC reference region may not include the portion, of the left most one of the more reconstructed CTUs, that is collocated with the reconstructed part of the current CTU. For example, the IBC reference region may not include the portion, of the left most one of the more reconstructed CTUs, that is collocated with the reconstructed part of the current CTU because the IBC reference sample memory may be implemented in a manner similar to a circular buffer. For example, the IBC reference sample memory may store reconstructed reference samples corresponding to one or more CTUs. Reconstructed reference samples of the current CTU may replace the reconstructed reference samples of a CTU, stored in the IBC reference sample memory, that are located (e.g., within a picture or frame) farthest to the left of the current CTU, for example, if the IBC reference sample memory is filled. The samples of the CTU stored in the IBC reference sample memory that are located, within a picture or frame, farthest to the left of the current CTU may correspond to the oldest data in the IBC reference sample memory. Updating the samples in the IBC reference sample memory as described herein may allow at least some of the reconstructed reference samples from the left most CTU to remain stored in the IBC reference sample memory when processing the current CTU. The remaining reference samples of the left most CTU stored in the IBC reference sample memory may be used for predicting the current block in the current CTU.

A CTU may or may not be processed all at once. For example, in typical hardware implementations of an encoder and/or of a decoder, a CTU may not be processed all at once. The CTU may be divided into VPDUs for processing by a pipeline stage. A VPDU may comprise a 4×4 region of samples, a 16×16 region of samples, a 32×32 region of samples, a 64×64 region of samples, a 128×128 region of samples, or any other sample region size. A size of a VPDU may be determined based on a lower one of: a maximum VPDU size (e.g., a 64×64 region of samples) and a size (e.g., a width or height) of a current CTU. The portion, of the left most one of the one or more reconstructed CTUs, that is collocated with the VPDU in which the block being coded is located may be further excluded from the IBC reference region. Excluding this portion of the left most one of the one or more reconstructed CTUs from the IBC reference region, may enable the portion of the IBC reference sample memory (e.g., used to store the reconstructed reference samples from this portion) to store only samples within the region of the current CTU corresponding to the VPDU. Storing only samples within the region of the current CTU corresponding to the VPDU may reduce and/or avoid certain complexities in encoder and/or decoder design.

The quantity/number of reconstructed CTUs, to the left of the current CTU included in the IBC reference region, may be determined based on the quantity/number of reconstructed reference samples that the IBC reference sample memory may store and/or the size of the CTUs in the current picture. The quantity/number of reconstructed CTUs, to the left of the current CTU included in the IBC reference region, may be determined based on the quantity/number of reconstructed reference samples that the IBC reference sample memory may store divided by the size of a CTU in the current picture. For example, for an IBC reference sample memory that may store 128×128 reconstructed reference samples for the IBC reference region and a CTU size is 128×128 samples, the quantity/number of reconstructed CTUs to the left of the current CTU included in the IBC reference region may be equal to (128×128)/(128×128) or 1 CTU. As another example, for a memory that may store 128×128 reconstructed reference samples for the IBC reference region and a CTU size is 64×64 samples, the quantity/number of reconstructed CTUs to the left of the current CTU included in the IBC reference region may be equal to (128×128)/(64×64) or 4 CTUs.

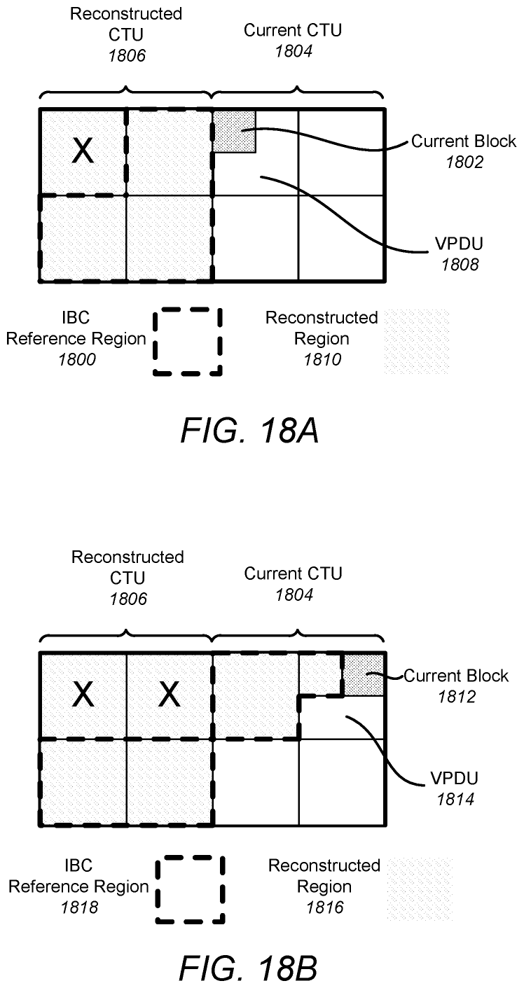

FIG. 18A shows an example IBC reference region. The IBC reference region 1800 may be determined based on an IBC reference sample memory size and a CTU size. The IBC reference sample memory size may be equal to a CTU size. The IBC reference sample memory size may be equal to 128×128 samples (or any other quantity of samples). The CTU size may be equal to 128×128 samples (or any other quantity of samples). A quantity/number of reconstructed CTUs, to the left of a current CTU 1804, as included in the IBC reference region 1800 may be equal to (128×128)/(128×128) or 1 CTU. The IBC reference region 1800 may be a portion of a reconstructed region 1810. Samples in the IBC reference region 1800 may be a subset of samples in the reconstructed region 1810. Samples of a current block 1802 being coded may be a subset of the samples in the VPDU 1808.

FIG. 18A shows a current block 1802 within a current CTU 1804. The current block 1802 may be the first block coded in the current CTU 1804 and may be coded using an IBC mode. As described with respect to FIGS. 17A and 17B, a block may be coded using IBC mode by determining a best matching reference block within an IBC reference region 1800. The IBC reference region 1800 may be constrained to: a reconstructed part of current CTU 1804; and the single, reconstructed CTU 1806 to the left of current CTU 1804 not including a portion, of the reconstructed CTU 1806, that is collocated with either the reconstructed part of current CTU 1804 or a VPDU 1808 in which the current block 1802 is located. CTUs may be divided into multiple VPDUs. For example, CTUs in FIG. 18A may be divided into 4 VPDUs of size 64×64 samples. The IBC reference region 1800 for current block 1802 may include the reconstructed region 1810 (shown with hatching) except the 64×64 region of the reconstructed CTU 1806 that is collocated with the VPDU 1808. The collocated region is marked with an X in FIG. 18A. The IBC reference region 1800 may include a different quantity/number of CTUs to the left of current CTU 1802. A quantity of CTUs, in the IBC reference region 1800, that are to the left of current CTU 1802 may be different for different CTU sizes. For example, for CTU sizes of 64×64, the IBC reference region 1800 may include 4 CTUs to the left of current CTU 1802 based on the quantity/number of reconstructed reference samples that the IBC reference sample memory may store divided by the size of the CTUs in the current picture.

FIG. 18B shows an example IBC reference region. FIG. 18B shows an IBC reference region 1818 for a later coded block in the current CTU 1804. The later coded block may be the current block 1812. The current block 1812 may be coded using an IBC mode (e.g., as described with respect to FIGS. 17A and 17B). The current block 1812 may be coded by determining a best matching reference block within an IBC reference region 1818. The IBC reference region 1818 for the current block 1812 may be constrained to: a reconstructed part of the current CTU 1804; and the reconstructed CTU 1806 not including a portion, of the reconstructed CTU 1806, that is collocated with either the reconstructed part of the current CTU 1804 or a VPDU 1814 in which the current block 1812 is located. The current CTU 1804 may be divided into 4 VPDUs of size 64×64 samples (e.g., as described with respect to FIG. 18A). The IBC reference region 1818 for the current block 1812 may comprise the reconstructed region 1816 (shown with hatching) except the part of CTU 1806 that is collocated with either the reconstructed part of the current CTU 1804 and/or the VPDU 1814. The collocated regions are each marked with an X in FIG. 18B.

Decoding/prediction information (e.g., IBC prediction information, such as BVP and BVD) may be indicated/signaled in a bitstream by an encoder. A decoder may extract the prediction information from the bitstream to decode a BV for reconstructing a current block. For example, the encoder may signal, via a bitstream, a prediction error, an indication of a selected BVP (e.g., via an index pointing into a list of candidate BVPs/AMVP list, or an index indicating the selected BVP in the list of candidate BVPs/AMVP list), the separate horizontal and vertical components of a BVD, and/or a sign of each of the separate horizontal and vertical components of the BVD. The decoder may decode/determine the BV by adding the corresponding horizontal and vertical components of the BVD to the corresponding components horizontal and vertical components of the BVP. The decoder may determine a reference block (e.g., which forms/corresponds to the prediction of the current block) using the decoded BV. The decoder may decode/determine the current block, for example, based on combining the prediction of the current block with the prediction error received via the bitstream.

Prediction information (e.g., IBC prediction information) may be adjusted. Prediction information (e.g., IBC prediction information) may be adjusted, for example, based on a BV comprising a null component and a non-null component. Components of a BVD may be indicated by determining and signaling a BVD component corresponding to the non-null component of the BV. A sign of the components of the BVD may be inferred, for example, based on one or more modified BVPs.

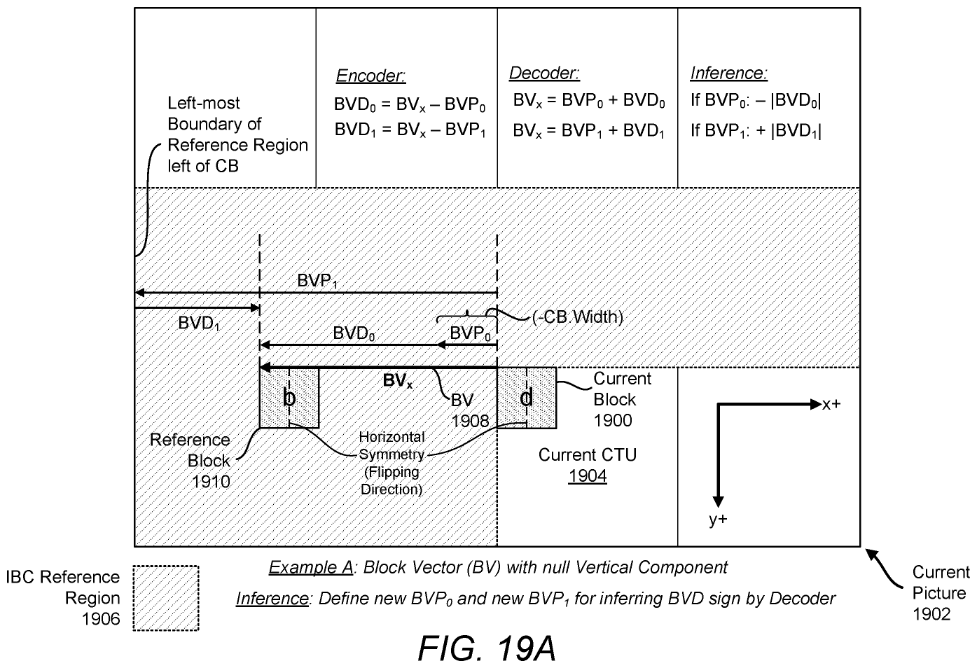

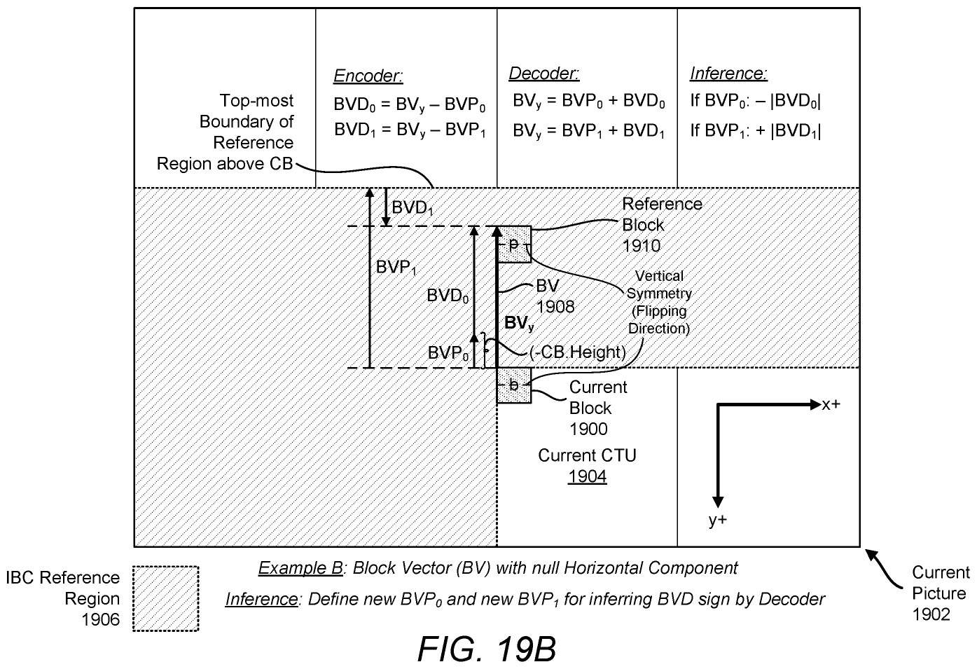

FIG. 19A shows an example of a BV comprising a null vertical component. The BV comprising the null vertical component may be determined based on BVPs and BVDs as described herein.

FIG. 19A shows an example of IBC predictive coding. An encoder (e.g., the encoder 200 as shown in FIG. 2, or any other encoder), may use an IBC prediction mode to code a current block 1900 in a current picture (or portion of a current picture) 1902. The current block 1900 may be a PB or a CB within a CTU 1904. A PB may also be referred to as a reference block. Blocks may be scanned (e.g., from left-to-right, top-to-bottom) using a z-scan to form a sequence order for encoding/decoding (e.g., in HEVC, VVC, and/or any other video compression standards). The CTUs to the left and in the row immediately above current CTU 1904 may be encoded/decoded, based on the z-scan, prior to the current CTU 1904 and the current block 1900 (e.g., prior to encoding the current CTU 1904 and the current block 1900). The samples of the CTUs (to the left and in the row immediately above current CTU 1904, shown with hatching in FIG. 19) may form an exemplary IBC reference region 1906 for determining a reference block to predict the current block 1900.

The encoder may use/apply a block matching technique to determine a BV 1908. The BV may indicate a relative displacement from the current block 1900 to a reference block 1910 (e.g., if using intra block compensated prediction) within the IBC reference region 1906. The reference block 1910 may match, or best match, the current block 1900. The IBC reference region 1906 may be a constraint placed on the BV 1908. The BV 1908 may be constrained, by the IBC reference region 1906, to indicate a displacement from the current block 1900 to a reference block that is within the IBC reference region 1906. The encoder may determine the best matching reference block 1910 from blocks, within the IBC reference region 1906, that are tested, for example, if a searching process occurs. The encoder may determine that a reference block is the best matching reference block, for example, based on one or more cost criterion, such as a rate-distortion criterion (e.g., Lagrangian rate-distortion cost). The one or more cost criterion may be based on a difference (e.g., an SSD, an SAD, an SATD, and/or a difference determined based on a hash function) between prediction samples of the reference block 1910 and the original samples of the current block 1900. The reference block 1910 may comprise decoded (or reconstructed) samples of the current picture 1902 prior to the samples being processed by in-loop filtering operations (e.g., deblocking and/or SAO filtering).

The encoder may determine and/or use a difference (e.g., a corresponding sample-by-sample difference) between the current block 1900 and the reference block 1910. The difference may be referred to as a prediction error or residual. The encoder may store and/or send/signal, in/via a bitstream, the prediction error and related prediction information for decoding.

The prediction information may include the BV 1908. The prediction information may include an indication of the BV 1908. The BV 1908 may be predictively coded, for example, before being stored and/or signaled via a bit stream (e.g., in HEVC, VVC, and/or other video compression schemes). The BV 1908 for the current block 1900 may be predictively coded (e.g., using a similar technique as AMVP for inter prediction). The BV 1908 may be predictively coded technique using BV prediction and difference coding. The encoder may code the BV 1908 as a difference between the BV 1908 and a BVP, for example, if using BV prediction and difference coding technique. The encoder may select a BVP from a list of candidate BVPs. The candidate BVPs may be determined based on/from previously decoded BVs of blocks neighboring the current block 1900 and/or from other sources. Both the encoder and decoder may generate and/or determine the list of candidate BVPs. The list of candidate BVPs may comprise as an AMVP list. BVP₀ and BVP₁ may comprise example BVPs (e.g., as further discussed herein).

The encoder may determine a BVD, for example, based on the encoder selecting a BVP from the list of candidate BVPs. BVD₀ and BVD₁ may denote example BVDs (e.g., as further discussed herein). A BVD may be calculated, for example, based on the difference between the BV 1908 and a BVP. The BVD may be represented by two directional components calculated according to equations (17) and (18), which are reproduced below:

BVDₓ=BVₓ−BVPₓ (17)

BVD_{y}=BV_{y}−BVP_{y} (18)

BVDₓ and BVD_{y} may respectively represent the horizontal and vertical components of the BVD. BVₓ and BV_{y} may respectively represent the horizontal and vertical components of the BV 1908. BVPₓ and BVP_{y} may respectively represent the horizontal and vertical components of the BVP. The horizontal x-axis and vertical y-axis, as well as indications of the direction of a positive sign of the x-axis and y-axis, are indicated in the lower right-hand corner of current picture 1902 for reference purposes.

FIG. 19A further shows an example wherein the BV 1908 comprises a non-null horizontal component BVₓ and a null vertical component BV_{y} (e.g., BV_{y}=0). The BV 1908 may indicate a displacement from the current block 1900 to the reference block 1910 in the IBC reference region 1906.

An encoder may determine a first BVP (e.g., BVP₀) for example, based on a dimension of the current block 1900. BVP₀ may indicate a displacement, from the current block 1900, in a same horizontal direction as the non-null horizontal component BVₓ. The encoder may determine BVP₀, for example, based on an inverse of the width of current block 1900 (e.g., a negative of the width of the current block, −CB.Width). An encoder may determine a second BVP, for example, (e.g., BVP₁) based on a displacement from the location of current block 1900. BVP₁ may indicate a displacement, from the current block 1900, in the same horizontal direction as a non-null horizontal component BVₓ. The displacement, of BVP₁ from the current block 1900, may extend to the left-most boundary of the IBC reference region 1906. The encoder may determine BVP₁ based on a position at/of the left-most boundary of the IBC reference region 1906 (e.g., to the left of current block 1900). BVP₀ and BVP₁ may comprise null vertical components. BVP₀ and BVP₁ may comprise null vertical components, for example, based on the BV 1908 comprising a null vertical component. The encoder may insert BVP₀ and BVP₁ into a list of candidate BVPs (e.g., an AMVP list). The encoder may determine a selected BVP among BVP₀ and BVP₁. The encoder may determine a selected BVP, among BVP₀ and BVP₁, for example, in a similar manner to selecting a BVP from a list of candidate BVPs (e.g., as described herein, for example, with respect to FIGS. 17A and 17B). The encoder may signal/send an indication of the selected BVP, to a decoder, via a bitstream. The indication of the selected BVP may comprise an index/indicator.

The encoder may determine a first BVD (e.g., BVD₀) and a second BVD (e.g., BVD₁). The encoder may determine BVD₀ and/or BVD₁, for example, based on a difference between the BV 1908 and BVP₀ and/or a difference between the BV 1908 and BVP₁, respectively. The encoder may determine BVD₀ and/or BVD₁ according to equations (19) and (20) below:

BVD₀=BVₓ−BVP₀ (19)

BVD₁=BVₓ−BVP₁ (20)

where BV 1908 may comprise a null vertical component BV_{y} (e.g., BV_{y}=0) and a non-null horizontal component BVₓ. The encoder may determine a BVD for indicating/signaling to the decoder, for example, based on a difference between the BV 1908 and the selected BVP. The encoder may signal/indicate the BVD via the bitstream. An indication of the BVD may comprise an absolute value of a non-null component of the BVD. The encoder may determine a residual of the current block 1900, for example, based on a difference between the current block 1900 and the reference block 1910. The encoder may signal, via a bitstream, the residual of the CB.

The decoder may determine a first BVP (e.g., BVP₀), for example, based on a dimension of the current block 1900. BVP₀ may indicate a displacement from the current block 1900 in the same horizontal direction as a non-null horizontal component BVₓ. The decoder may determine BVP₀, for example, based on an inverse of the width of the current block 1900 (e.g., a negative of the width of the current block, −CB.Width). The decoder may determine a second BVP (e.g., BVP₁), based on a displacement from a location of the current block 1900. BVP₁ may indicate a displacement from the current block 1900 in the same horizontal direction as a non-null horizontal component BVₓ. The displacement, of BVP₁ from the current block 1900, may extend to the left-most boundary of the IBC reference region 1906. A decoder may determine BVP₁, for example, based on a position at/of the left-most boundary of IBC the reference region 1906 (e.g., to the left of the current block 1900). The decoder may insert BVP₀ and BVP₁ into a BVP candidate list (e.g., an AMVP list). The decoder may receive an indication of a selected BVP, among BVP₀ and BVP₁, via a bitstream. The indication of a selected BVP may comprise an index/indicator.

The decoder may receive an indication of a BVD via a bitstream. The indication of the BVD may comprise an absolute value of a non-null component of the BVD. The decoder may determine a sign of the BVD, for example, based on the selected BVP. The determining the sign of the BVD, for example, based on the selected BVP may comprise determining/inferring the BVD sign to be negative, for example, if the selected BVP is BVP₀. The determining the sign of the BVD based on the selected BVP may comprise determining/inferring the BVD sign to be positive, for example, if the selected BVP is BVP₁. The decoder may determine the BVD, for example, based on the sign and the indication of the BVD (e.g., an absolute value of a non-null component of the BVD). The determining the BVD based on the sign and the indication of the BVD may further comprise assigning the sign to the non-null component of the BVD.

The decoder may determine the BV 1908, for example, based on the selected BVP and the determined BVD according to equations (21) and (22) below:

BVₓ=BVP₀+BVD₀ (21)

BVₓ=BVP₁+BVD₁ (22)

where BV 1908 may comprise a null vertical component BV_{y} (e.g., BV_{y}=0) and a non-null horizontal component BVₓ. The determining the BV 1908 based on the selected BVP and the determined BVD may comprise determining a non-null component of the BV 1908. The decoder may determine the non-null component of the BV 1908, for example, based on combining a non-null component of the selected BVP and a non-null component of the determined BVD. The decoder may decode the current block 1900 based on the reference block 1910, that is displaced from current block 1900 by the block vector 1908, in the IBC reference region 1906. The decoder may further receive, via a bitstream, a residual of the current block 1900. The decoder may decode the current block 1900 based on combining the reference block 1910 with the residual of the current block 1900.

FIG. 19B shows an example of a BV comprising a null horizontal component. The BV comprising the null vertical component may be determined, for example, based on BVPs and BVDs. BV 1908, as shown in FIG. 19B, may comprise a non-null vertical component BV_{y} and a null horizontal component BVₓ (e.g., BVₓ=0). The BV 1908 may indicate a displacement from the current block 1900 to the reference block 1910 in the IBC reference region 1906.

An encoder may determine a first BVP (e.g., BVP₀), for example, based on a dimension of the current block 1900. BVP₀ may indicate a displacement, from the current block 1900, in a same vertical direction as the non-null vertical component BV_{y}. The encoder may determine BVP₀, for example, based on an inverse of the height of current block 1900 (e.g., a negative of the height of the current block, −CB.Height). The encoder may determine a second BVP (e.g., BVP₁), for example, based on a displacement from the location of current block 1900. BVP₁ may indicate a displacement, from the current block 1900, in the same vertical direction as a non-null vertical component BVₓ. The displacement, of BVP₁ from the current block 1900, may extend to the top-most boundary of the IBC reference region 1906. The encoder may determine BVP₁, for example, based on a position at/of the top-most boundary of the IBC reference region 1906 (e.g., above the current block 1900). BVP₀ and BVP₁ may comprise null horizontal components. BVP₀ and BVP₁ may comprise null horizontal components, for example, based on the BV 1908 comprising a null horizontal component. The encoder may insert BVP₀ and BVP₁ into a list of candidate BVPs (e.g., an AMVP list). The encoder may determine a selected BVP among BVP₀ and BVP₁. The encoder may determine a selected BVP, among BVP₀ and BVP₁, in a similar manner to selecting a BVP from a list of candidate BVPs (e.g., as described herein, for example, with respect to FIGS. 17A and 17B). The encoder may signal/send an indication of the selected BVP, to a decoder, via a bitstream. The indication of the selected BVP may comprise an index/indicator.

The encoder may determine a first BVD (e.g., BVD₀) and a second BVD (e.g., BVD₁). The encoder may determine BVD₀ and/or BVD₁, for example, based on a difference between the BV 1908 and BVP₀ and/or a difference between the BV 1908 and BVP₁, respectively. The encoder may determine BVD₀ and/or BVD₁ according to equations (23) and (24) below:

BVD₀=BV_{y}−BVP₀ (23)

BVD₁=BV_{y}−BVP₁ (24)

where BV 1908 may comprise a null horizontal component BVₓ (e.g., BVₓ=0) and a non-null vertical component BV_{y}. The encoder may determine a BVD for indicating/signaling to the decoder, for example, based on a difference between the BV 1908 and the selected BVP. The encoder may signal/indicate/send an indication of the BVD via the bitstream. An indication of the BVD may comprise an absolute value of a non-null component of the BVD. The encoder may determine a residual of the current block 1900, for example, based on a difference between the current block 1900 and the reference block 1910. The encoder may signal, via a bitstream, the residual of the CB.

The decoder may determine a first BVP (e.g., BVP₀), for example, based on a dimension of the current block 1900. BVP₀ may indicate a displacement from the current block 1900 in the same vertical direction as a non-null vertical component BV_{y}. The decoder may determine BVP₀, for example, based on an inverse of the height of the current block 1900 (e.g., a negative of the height of the current block, −CB.Height). The decoder may determine a second BVP (e.g., BVP₁), for example, based on a displacement from a location of the current block 1900. BVP₁ may indicate a displacement from the current block 1900 in the same vertical direction as a non-null vertical component BV_{y}. The displacement, of BVP₁ from the current block 1900, may extend to the top-most boundary of the IBC reference region 1906. A decoder may determine BVP₁, for example, based on a position at/of the top-most boundary of IBC the reference region 1906 (e.g., above the current block 1900). The decoder may insert BVP₀ and BVP₁ into a BVP candidate list (e.g., an AMVP list). The decoder may receive an indication of a selected BVP, among BVP₀ and BVP₁, via a bitstream. The indication of a selected BVP may comprise an index/indicator.

The decoder may receive an indication of a BVD via a bitstream. The indication of the BVD may comprise an absolute value of a non-null component of the BVD. The decoder may determine a sign of the BVD, for example, based on the selected BVP. The determining the sign of the BVD based on the selected BVP may comprise determining/inferring the BVD sign to be negative, for example, if the selected BVP is BVP₀. The determining the sign of the BVD based on the selected BVP may comprise determining/inferring the BVD sign to be positive, for example, if the selected BVP is BVP₁. The decoder may determine the BVD, for example, based on the sign and the indication of the BVD (e.g., an absolute value of a non-null component of the BVD). The determining the BVD based on the sign and the indication of the BVD may further comprise assigning the sign to the non-null component of the BVD.

The decoder may determine the BV 1908 based on the selected BVP and the determined BVD according to equations (25) and (26) below:

BV_{y}=BVP₀+BVD₀ (25)

BV_{y}=BVP₁+BVD₁ (26)

where BV 1908 may comprise a null horizontal component BVₓ (e.g., BVₓ=0) and a non-null vertical component BV_{y}. The determining the BV 1908 based on the selected BVP and the determined BVD may comprise determining a non-null component of the BV 1908. The decoder may determine the non-null component of the BV 1908, for example, based on combining a non-null component of the selected BVP and a non-null component of the determined BVD. The decoder may decode the current block 1900, for example, based on the reference block 1910, that is displaced from current block 1900 by the block vector 1908, in the IBC reference region 1906. The decoder may further receive, via a bitstream, a residual of the current block 1900. The decoder may decode the current block 1900, for example, based on combining the reference block 1910 with the residual of the current block 1900.

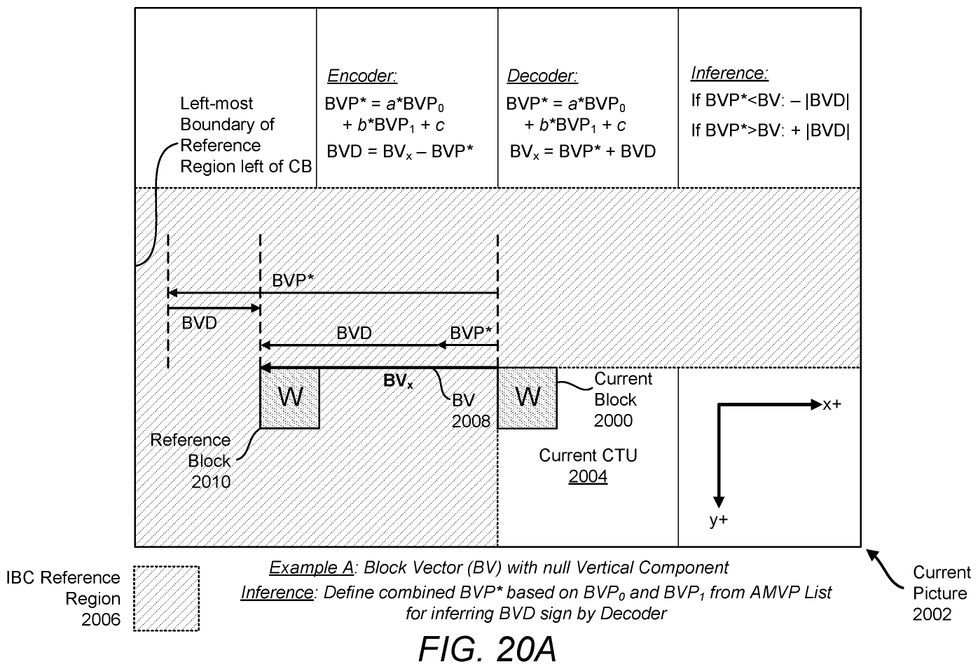

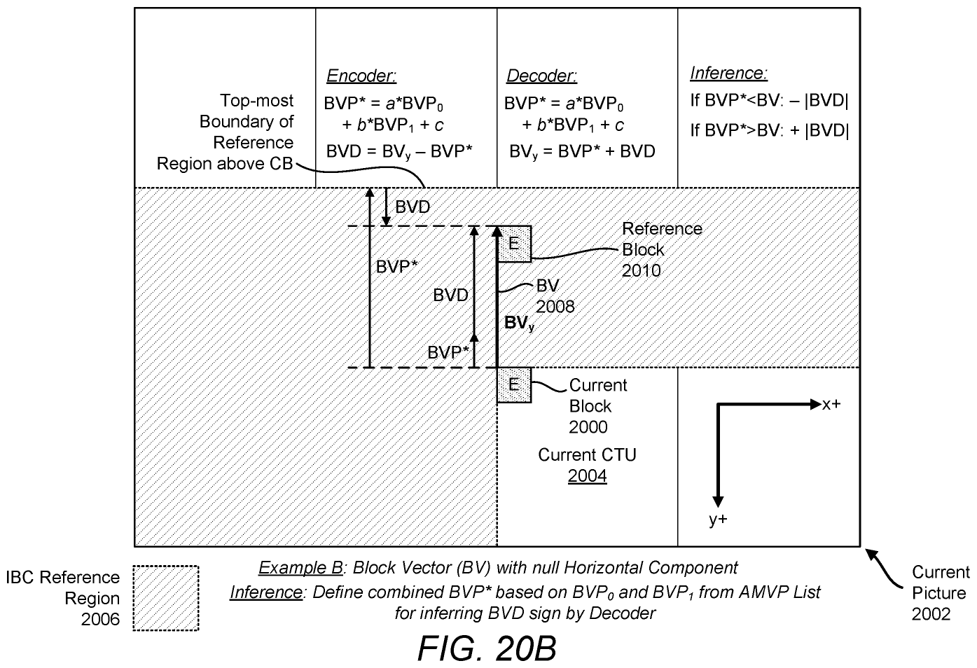

FIG. 20A shows an example of a BV comprising a null vertical component. The BV comprising the null vertical component may be represented based on a combined BVP and a BVD as described herein.

FIG. 20A shows an example of IBC predictive coding. An encoder (e.g., the encoder 200 as shown in FIG. 2, or any other encoder), may use an IBC prediction mode to code a current block 2000 in a current picture (or portion of a current picture) 2002. The current block 2000 may be a PB or a CB within a CTU 2004. A PB may also be referred to as a reference block. Blocks may be scanned (e.g., from left-to-right, top-to-bottom) using a z-scan to form a sequence order for encoding/decoding (e.g., in HEVC, VVC, and/or any other video compression standards). The CTUs to the left and in the row immediately above current CTU 2004 may be encoded/decoded, based on the z-scan, prior to the current CTU 2004 and the current block 2000 (e.g., prior to encoding the current CTU 2004 and the current block 2000). The samples of the CTUs (to the left and in the row immediately above current CTU 2004, as shown with hatching in FIG. 20) may form an exemplary IBC reference region 2006 for determining a reference block to predict the current block 2000.

The encoder may use/apply a block matching technique to determine a BV 2008. The BV may indicate a relative displacement from the current block 2000 to a reference block 2010 (e.g., if using intra block compensated prediction) within the IBC reference region 2006. The reference block 2010 may match, or best match, the current block 2000. The IBC reference region 2006 may be a constraint placed on the BV 2008. The BV 2008 may be constrained, by the IBC reference region 2006, to indicate a displacement from the current block 2000 to a reference block that is within the IBC reference region 2006. The encoder may determine the best matching reference block 2010 from blocks, within the IBC reference region 2006, that are tested, for example, if a searching process occurs. The encoder may determine that a reference block is the best matching reference block, for example, based on one or more cost criterion, such as a rate-distortion criterion (e.g., Lagrangian rate-distortion cost). The one or more cost criterion may be based on a difference (e.g., an SSD, an SAD, an SATD, and/or a difference determined based on a hash function) between prediction samples of the reference block 2010 and the original samples of the current block 2000. The reference block 2010 may comprise decoded (or reconstructed) samples of the current picture 2002 prior to the samples being processed by in-loop filtering operations (e.g., deblocking and/or SAO filtering).

The encoder may determine and/or use a difference (e.g., a corresponding sample-by-sample difference) between the current block 2000 and the reference block 2010. The difference may be referred to as a prediction error or residual. The encoder may store and/or send/signal, in/via a bitstream, the prediction error and related prediction information for decoding.

The prediction information may include the BV 2008. The prediction information may include an indication of the BV 2008. The BV 2008 may be predictively coded, for example, before being stored and/or signaled via a bit stream (e.g., in HEVC, VVC, and/or other video compression schemes). The BV 2008 for the current block 2000 may be predictively coded (e.g., using a similar technique as AMVP for inter prediction). The BV 2008 may be predictively coded technique using BV prediction and difference coding. The encoder may code the BV 2008 as a difference between the BV 2008 and a BVP, for example, if using BV prediction and difference coding technique. The encoder may select a BVP from a list of candidate BVPs. The candidate BVPs may be determined based on/from previously decoded BVs of blocks neighboring the current block 2000 and/or from other sources. Both the encoder and decoder may generate and/or determine the list of candidate BVPs. The list of candidate BVPs may comprise as an AMVP list.

The encoder may determine a BVD, for example, based on the encoder selecting a BVP from the list of candidate BVPs. A BVD may be calculated, for example, based on the difference between the BV 2008 and a BVP. For example, the BVD may be represented by two directional components calculated according to equations (17) and (18), which are reproduced below:

BVDₓ=BVₓ−BVPₓ (17)

BVD_{y}=BV_{y}−BVP_{y} (18)

BVDₓ and BVD_{y} may respectively represent the horizontal and vertical components of the BVD. BVₓ and BV_{y} may respectively represent the horizontal and vertical components of the BV 2008. BVPₓ and BVP_{y} may respectively represent the horizontal and vertical components of the BVP. The horizontal x-axis and vertical y-axis, as well as indications of the direction of a positive sign of the x-axis and y-axis, are indicated in the lower right-hand corner of current picture 2002 for reference purposes.

FIG. 20A shows a particular example wherein the BV 2008 comprises a non-null horizontal component BVₓ and a null vertical component BV_{y} (e.g., BV_{y}=0). The BV 2008 may indicate a displacement from the current block 2000 to the reference block 2010 in IBC reference region 2006.

The encoder may determine a combined BVP (BVP* as shown in FIG. 20A) based on a first BVP (e.g., BVP₀), and a second BVP (e.g., BVP₁). BVP₀ and BVP₁ may be in a BVP candidate list (e.g., an AMVP list). BVP₀ and BVP₁ may be first and second candidate BVPs in the BVP candidate list. The displacements of BVP₀ and BVP₁ are not shown in FIG. 20A since these BVPs may be any two candidates in the BVP candidate list. BVP₀ and BVP₁ may be candidate BVPs with null vertical components. BVP₀ and BVP₁ may comprise null vertical components, for example, based on the BV 2008 comprising a null vertical component. The encoder may determine a combined BVP* based on BVP₀ and BVP₁, and a BVD based on the BV 2008 and BVP* according to equations (27) and (28) below:

BVP*=a* BVP₀+b* BVP₁+c (27)

BVD=BVₓ−BVP* (28)

where BV 2008 may comprise a null vertical component BV_{y} (e.g., BV_{y}=0) and a non-null horizontal component BVₓ. As described herein regarding equation (27), a may be a first weighting factor, b may be a second weighting factor, and c may be an offset value. The encoder may determine a combined BVP*, for example, based on BVP₀ and BVP₁, in the BVP candidate list, by determining a linear combination of: a non-null component of the first BVP (e.g., BVP₀) multiplied by a first weighting factor (denoted as a); a non-null component of the second BVP (e.g., BVPᵢ) multiplied by a second weighting factor (denoted as ′); and an offset value (denoted as c). The weighting factors and offset value may be determined, for example, based on machine learning, statistical training, or any other technique.

The encoder may signal/indicate/send, via a bitstream to the decoder, an indication of a BVD. The BVD may be based on a difference between the BV 2008 and the combined BVP* (e.g., determined based on equation (28)). The signaling an indication of the BVD may further comprise determining an absolute value of the difference between BV and the combined BVP*. The signaling the indication of the BVD may further comprise signaling/sending, to the decoder via a bitstream, an indication of the absolute value of the difference between BV 2008 and the combined BVP*. The signaling an indication of the BVD may further comprise signaling an indication of whether the combined BVP* is less than or greater than the BV 2008. The signaling an indication of the BVD may further comprise signaling an indication when the combined BVP* is less than or greater than the BV 2008. The encoder may determine a non-null component of the BVD, for example, based on the difference between a non-null component of the BV 2008 and a non-null component of the combined BVP*. The encoder may determine an absolute value of the non-null component of the BVD. The encoder may signal/send/indicate the absolute value of the non-null component of the BVD via the bitstream (e.g., to the decoder). In an example, an encoder may determine a residual of current block 2000, for example, based on a difference between the current block 2000 and the reference block 2010. The encoder may further signal/send/indicate, via a bitstream, the residual of the current block 2000.

The decoder may determine a combined BVP (e.g., BVP* as shown in FIG. 20A) based on a first BVP (e.g., BVP₀) and a second BVP (e.g., BVP₁) in a BVP candidate list (e.g., an AMVP list). BVP₀ and BVP₁ may be a first and second candidate BVP in the BVP candidate list. BVP₀ and BVP₁ may be candidate BVPs with null vertical components. The decoder may determine a combined BVP*, for example, based on BVP₀ and BVP₁, and a BVD based on BV 2008 and BVP* according to equations (29) and (30) below:

BVP*=a* BVP₀+b* BVP₁+c (29)

BVₓ=BVP*+BVD (30)

where BV 2008 may comprise a null vertical component BV_{y} (e.g., BV_{y}=0) and a non-null horizontal component BVₓ. As described herein regarding equation (29), a may be a first weighting factor, b may be a second weighting factor, and c may be an offset value. The decoder may determine a combined BVP*, for example, based on BVP₀ and BVP₁ in the BVP candidate list by determining a linear combination of: a non-null component of the first BVP multiplied by a first weighting factor (denoted as a); a non-null component of the second BVP multiplied by a second weighting factor (denoted as b); and an offset value (denoted as c).

The decoder may receive an absolute value of a BVD via a bitstream. The absolute value of the BVD may comprise an absolute value of a non-null component of the BVD. The decoder may receive an indication via a bitstream. The indication may be a flag or an index. The decoder may determine the BVD, for example, based on the absolute value and the indication. The determining the BVD based on the absolute value and the indication may further comprise: determining/inferring the sign of the BVD to be negative if the indication indicates that combined BVP* is less than the BV 2008; and determining/inferring the sign of the of the BVD to be positive if the indication indicates that combined BVP* is greater than the BV 2008. The determining the BVD based on the absolute value and the indication may further comprise assigning the sign to the non-null component of the BVD.

The decoder may determine the BV 2008, for example, based on the combined BVP* and the determined BVD. The determining the BV 2008 based on the combined BVP* and the determined BVD may comprise determining a non-null component of the BV 2008 by combining a non-null component of the combined BVP* and a non-null component of the determined BVD (e.g., e.g., according to equation (30)). The decoder may decode the current block 2000, for example, based on the reference block 2010 in the IBC reference region 2006. The reference block 2010 may be displaced from the current block 2000 by the BV 2008. The decoder may receive, via a bitstream, a residual of the current block 2000. The decoder may decode the current block 2000 based on combining the reference block 2010 with the residual of the current block 2000.

FIG. 20B shows a BV comprising a null horizontal component. The BV comprising the null vertical component may be represented based on a combined BVP and a BVD.

FIG. 20B shows a particular example wherein the BV 2008 comprises a non-null vertical component BV_{y} and a null horizontal component BVₓ (e.g., BVₓ=0). The BV 2008 may indicate a displacement from the current block 2000 to the reference block 2010 in the IBC reference region 2006.

The encoder may determine a combined BVP (BVP* as shown in FIG. 20B), for example, based on a first BVP (e.g., BVP₀), and a second BVP (e.g., BVP₁) BVP₀ and BVP₁ may be in a BVP candidate list (e.g., an AMVP list). BVP₀ and BVP₁ may be a first and second candidate BVP in the BVP candidate list. The displacements of BVP₀ and BVP₁ are not shown in FIG. 20B since these BVPs may be any two candidates in the BVP candidate list. BVP₀ and BVP₁ may be candidate BVPs with null horizontal components. BVP₀ and BVP₁ may comprise null horizontal components, for example, based on the BV 2008 comprising a null horizontal component. The encoder may determine a combined BVP* based on BVP₀ and BVP₁, and a BVD based on the BV 2008 and BVP* according to equations (31) and (32) below:

BVP*=a*BVP₀+b*BVP₁+c (31)

BVD=BV_{y}−BVP* (32)

where BV 2008 may comprise a null horizontal component BVₓ (e.g., BVₓ=0) and a non-null vertical component BV_{y}. As described herein regarding equation (31), a may be a first weighting factor, b may be a second weighting factor, and c may be an offset value. The encoder may determine combined BVP* based on BVP₀ and BVP₁, in the BVP candidate list, for example, by determining a linear combination of: a non-null component of the first BVP (e.g., BVP₀) multiplied by a first weighting factor (denoted as a); a non-null component of the second BVP (e.g., BVP₁) multiplied by a second weighting factor (denoted as b); and an offset value (denoted as c). The weighting factors and offset value may be determined, for example, based on machine learning, statistical training, or any other technique.

The encoder may signal/indicate/send, via a bitstream to the decoder, an indication of a BVD. The BVD may be based on a difference between the BV 2008 and the combined BVP* (e.g., determined based on equation (32)). The signaling an indication of the BVD may further comprise determining an absolute value of the difference between BV and the combined BVP*. The signaling the indication of the BVD may further comprise signaling/sending, to the decoder via a bitstream, an indication of the absolute value of the difference between BV 2008 and the combined BVP*. The signaling an indication of the BVD may further comprise signaling an indication of the BVD if the combined BVP* is less than or greater than the BV 2008. The signaling an indication of the BVD may further comprise signaling an indication of whether the combined BVP* is less than or greater than the BV 2008. The encoder may determine a non-null component of the BVD based on the difference between a non-null component of the BV 2008 and a non-null component of the combined BVP*. The encoder may determine an absolute value of the non-null component of the BVD. The encoder may signal/send/indicate the absolute value of the non-null component of the BVD via the bitstream (e.g., to the decoder). In an example, an encoder may determine a residual of current block 2000, for example, based on a difference between the current block 2000 and the reference block 2010. The encoder may further signal/send/indicate, via a bitstream, the residual of the current block 2000.

The decoder may determine a combined BVP (e.g., BVP* as shown in FIG. 20B), for example, based on a first BVP (e.g., BVP₀) and a second BVP (e.g., BVP₁). in a BVP candidate list (e.g., an AMVP list). BVP₀ and BVP₁ may be a first and second candidate BVP in the BVP candidate list. BVP₀ and BVP₁ may be candidate BVPs with null horizontal components. The decoder may determine a combined BVP* based on BVP₀ and BVP₁, and a BVD based on BV 2008 and BVP* according to equations (29) and (30) below:

BVP*=a* BVP₀+b* BVP₁+c (33)

BV_{y}=BVP*+BVD (34)

where BV 2008 may comprise a null horizontal component BVₓ (e.g., BVₓ=0) and a non-null vertical component BV_{y}. As described herein regarding equation (33), a may be a first weighting factor, b may be a second weighting factor, and c may be an offset value. The decoder may determine a combined BVP* based on BVP₀ and BVP₁ in the BVP candidate list, for example, by determining a linear combination of: a non-null component of the first BVP multiplied by a first weighting factor (denoted as a′); a non-null component of the second BVP multiplied by a second weighting factor (denoted as ‘b’); and an offset value (denoted as ‘c’).

The decoder may receive an absolute value of a BVD via a bitstream. The absolute value of the BVD may comprise an absolute value of a non-null component of the BVD. The decoder may receive an indication via a bitstream. The indication may be a flag or an index. The decoder may determine the BVD, for example, based on the absolute value and the indication. The determining the BVD based on the absolute value and the indication may further comprise: determining/inferring the sign of the BVD to be negative if the indication indicates that combined BVP* is less than the BV 2008; and determining/inferring the sign of the of the BVD to be positive if the indication indicates that combined BVP* is greater than the BV 2008. The determining the BVD based on the absolute value and the indication may further comprise assigning the sign to the non-null component of the BVD.

The decoder may determine the BV 2008 based on the combined BVP* and the determined BVD. The determining the BV 2008 based on the combined BVP* and the determined BVD may comprise determining a non-null component of the BV 2008 by combining a non-null component of the combined BVP* and a non-null component of the determined BVD (e.g., e.g., according to equation (34)). The decoder may decode the current block 2000 based on the reference block 2010 in the IBC reference region 2006. The reference block 2010 may be displaced from the current block 2000 by the BV 2008. The decoder may receive, via a bitstream, a residual of the current block 2000. The decoder may decode the current block 2000, for example, based on combining the reference block 2010 with the residual of the current block 2000.

A reference block may be determined as a best matching reference block to a current block (e.g., in IBC mode as used for screen content). Arrows (e.g., as shown in FIG. 16) may correspond to BVs that indicate respective displacements from respective current blocks to respective reference blocks that best match the respective current blocks. The reference blocks may match the respective current blocks. The determined/calculated residuals (e.g., prediction errors) may be small, if not zero.

In some instances, video content may be more efficiently encoded by considering symmetry properties. Symmetry may often be present in video content (e.g., in text character regions and computer-generated graphics in screen content video).

A reconstruction-reordered intra block copy (RRIBC) mode (e.g., also referred to as IBC mirror mode) (e.g., for screen content video coding) may advantageously consider symmetry within video content to improve the coding efficiency of IBC. The RRIBC mode may be adopted into a software algorithm (e.g., enhanced compression model (ECM) software algorithm that is currently under coordinated exploration study by the joint video exploration team (JVET) of ITU-T Video coding experts group (VCEG), ISO/IEC MPEG, or any other video coding technologies) as a potential enhancement(e.g., beyond the capabilities of VVC). A residual for a current block may be determined/calculated (e.g., if RRIBC mode is indicated for encoding the current block), for example, based on samples of a reference block (e.g., corresponding to an original reference block being encoded and decoded to form a reconstructed block) that are flipped relative to the current block (e.g., according to a flip direction indicated for the current block). The reference block may be flipped, for example, before matching and residual calculation (e.g., at the encoder). The current block (e.g., to be predicted and/or encoded) may be derived without flipping. Additionally, or alternatively, the current block may be flipped (e.g., instead of the reference block). The reference block (e.g., the reference block that was encoded) may be flipped back (e.g., at the decoder) to restore the original reference block (e.g., the reference block before being flipped at the encoder side).

The direction of flipping (e.g., a flip direction) may be inherited from (e.g., may be the same as that of) neighboring blocks (e.g., for RRIBC mode, also referred to as IBC mirror mode). Flipping of a reference block in a horizontal direction and a vertical direction may be represented by equations (35) and (36), respectively:

Reference(x,y)=Sample(w−1−x,y) (35)

Reference(x,y)=Sample(x,h−1−y) (36)

where w and h are the width and height of a current block, respectively. Sample(x,y) may indicate a sample value located at position (x, y) in a reference region. Reference(x,y) may indicate a corresponding reference sample value, for example, after flipping at position (x, y). Equation (35) shows, for horizontal flipping, that the reference block is flipped in a horizontal direction by sampling from right to left. Equation (36) shows, for vertical flipping, that the reference block is flipped in the vertical direction by sampling the reference block from down to up. Horizontal flipping may include samples of the reference block being flipped along a vertical axis of the reference block. Vertical flipping may include samples of the reference block being flipped along a horizontal axis of the reference block. FIG. 19A shows an example of horizontal flipping and FIG. 19B shows an example of vertical flipping.

A BV may comprise a null component. A BV may comprise a null component, for example, if RRIBC mode is used to encode/decode the current block. A flag may indicate that RRIBC mode/flipping is used to encode/decode the current block. The flag may further indicate a direction of flipping. Different flags may be used to indicate use of the RRIBC mode/flipping and a direction of flipping. For example, a first flag may indicate that RRIBC mode is used to encode/decode the current block, and a second flag may indicate the direction of flipping.

The flip direction (e.g., for RRIBC mode) may include one of a horizontal direction or a vertical direction. For a current block coded in RRIBC mode (e.g., an IBC AMVP coded block), a first indication (e.g., a first syntax flag) may indicate/signal whether to use RRIBC mode/flipping (e.g., also referred to as mirror flipping) to encode/decode the current block. The first indication having a value of 0 (or any other first value) may indicate that RRIBC mode/flipping is not used for encoding a current block. The first indication having a value of 1 (or any other second value) may indicate that RRIBC mode/flipping is used for encoding a current block. The first indication may correspond to the parameter rribcFlag. For the current block, a second indication (e.g., a second syntax flag) may indicate/signal the direction of flipping (e.g., vertical direction or horizontal direction). The second indication having a value of 0 (or any other first value) may indicate that the direction of flipping is horizontal. The second indication having a value of 1 (or any other second value) may indicate that the direction of flipping is vertical. The second indication may be signaled if the first indication indicates to use flipping to encode/decode a current block. The second indication may correspond to the parameter rribcFlipType. Direction of flipping being horizontal (e.g., second indication having a value of ‘0’) may imply that a vertical component of the BV is null. Direction of flipping being vertical (e.g., second indication having a value of ‘1’) may imply that a horizontal component of the BV is null.

A BV for a current block (e.g., coded using IBC mode) may indicate a relative displacement from the current block to a reference block within an IBC reference region. A BVP may be used to predictively code a BV. The BVP may be based on a BV of a spatially neighboring block of the current block, or a prior coded BV. A BVD may be determined as a difference between the BV and the BVP. The BVD may be encoded and/or transmitted (e.g., along with an indication of the selected BVP) via a bitstream. The BVD and/or the BVP may be used for decoding the current block. In RRIBC mode operation, a reference block (e.g., which may be flipped in a direction relative to the current block) may be selected from an RRIBC reference region. The RRIBC reference region may correspond to a flipping direction of the reference block and may be located within the IBC reference region.

A BV of a reference block (e.g., in an RRIBC reference region) may comprise a null component and a non-null component. In some instances, flipping of the reference block may not be performed (e.g., for determination of a residual). Conventional coding/indication techniques (e.g., as applied/used for RRIBC mode operation) may not be efficient for a BV, that comprises both a null component and a non-null component, and for which flipping of the reference block may not be used (e.g., may be optional). For example, conventional techniques may not utilize a (separate) indication of flipping (e.g., in a flipping direction) to realize gains in encoding/decoding a BV comprising a null component (e.g., using components of a BVP and a BVD). Additionally, efficiencies related to signaling the horizontal and vertical components of the BVD, and efficiencies related to signaling signs of each of the components of the BVD, may not be realized by conventional techniques.

Various examples herein describe approaches for decreasing the signaling overhead of prediction information (e.g., IBC prediction information) based on the respective components of a BV. Various examples herein describe adjustment of IBC prediction information based on a BV comprising a null component and a non-null component, and based on usage (or non-usage) of flipping to encode/decode the current block. A signaling overhead of components of a BVD may be reduced, for example, by determining and signaling a BVD component corresponding to the non-null component of the BV. Signaling overhead of a sign of a component of the BVD may be reduced, for example, based on enabling inferring of the sign based on one or more modified/derived BVPs. Indications of a presence of a null component, a direction of the null component, use of flipping, and/or a flipping direction may be used to decrease signaling overhead for encoding/decoding a BV comprising a null component, and where flipping of a reference block may not be used (e.g., may be optional). The signaling overhead may be reduced, for example, based on enabling derivation of one or more modified BVPs, and inferring the sign and/or direction of a non-null component of the BVD (e.g., using one or more of the indications).

A current block and a reference block may be aligned horizontally or vertically. A current block and a reference block may be aligned horizontally or vertically, for example, in video content exhibiting horizontal symmetry or vertical symmetry, respectively. The reference block may be determined from a portion of a reference region (comprising candidate reference blocks) that is aligned in (e.g., corresponds to) a same flipping direction (e.g., horizontal direction or vertical direction). The reference block may be determined from a portion of a reference region that is aligned in the same flipping direction, for example, based on the RRIBC mode. The vertical component (BVy) of the BV (e.g., indicating a displacement from the current block to the reference block) may not need to be signaled, for example, if flipping in a horizontal direction is used/indicated. The vertical component (BVy) of the BV may not need to be signaled because it may be inferred to be null (or equal to 0). The horizontal component (BVx) of the BV may not need to be signaled, for example, if flipping in a horizontal direction is used/indicated. The horizontal component (BVx) of the BV may not need to be signaled because it may be inferred to be null (or equal to 0). A component being null may comprise the component having a value of zero. A component being null may comprise the component not having a value. Determining a null or zero component of the BV may provide a basis for inference of respective components and/or signs of one or more BVPs and BVDs as described herein.

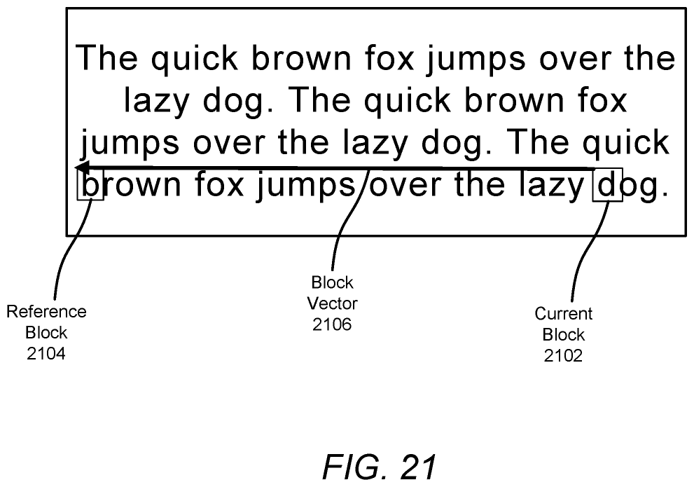

FIG. 21 shows an example use of RRIBC or IBC mirror mode applied for screen content. The RRIBC mode may be used to utilize symmetry within portions of content and increase efficiency for coding video content. An encoder or decoder may determine that a reference block 2104 is the best matching reference block for a current block 2102. The encoder or the decoder may determine that the reference block 2104 is the best matching reference block, for example, based on (or after) using horizontal flipping with respect to the reference block 2104. The encoder or the decoder may select the reference block 2104 as the best matching reference block, for example, based on one or more cost criterion (e.g., a rate-distortion criterion, as described herein). The one or more cost criterion may be used with respect to the reference block 2104 having been flipped (e.g., after the reference block is flipped) in the horizontal direction relative to the current block 2102. The reference block 2104 may be located in a reference region that is in horizontal alignment with current block 2102. The reference block 2104 may be located (e.g., constrained to be located) in a reference region that is in horizontal alignment with current block 2102, for example, if horizontal flipping is used. A block vector 2106, indicating a displacement between current block 2102 and the reference block 2104, may be represented as only a horizontal component (BVx) of the BV 2106.

The block vector 2106 may be represented as only a horizontal component (BVx) of the BV 2106 because of the constraints on possible locations of reference blocks. The vertical component of BV 2106 may be null (or equal to 0), for example, if horizontal flipping is indicated/used for encoding/decoding a current block.

A BV may comprise a null component. The BV may comprise a null component irrespective of whether or not RRIBC mode is used to encode/decode the current block. A non-null component of a BV may be determined. The BV may correspond to a reference block (e.g., that may or may not be flipped) or reconstructed block to encode/decode the current block. A non-null component of a BV may be determined with or without flipping of a reference block or reconstructed block to encode/decode the current block. The BV may be determined based on a BVP and a BVD. The BVD may be determined, for example, based on a sign and magnitude of a non-null component of the BVD. An indication of a BVP may be used to determine/infer the sign of the non-null component of the BVD (e.g., as discussed herein at least with respect to FIGS. 19A, 19B, 20A, and 20B). One or more indications may be used to indicate details regarding presence of a null component in the BV, a component of the BV that is null, and/or whether flipping/RRIBC mode is applied/used. A first indication (e.g., a BV one null component flag) may be used to indicate whether a BV comprises a null component. A second indication (e.g., BV null component direction flag) may indicate a direction of the null component of the BV. One or more indications having more than two possible values may be used to indicate/determine whether a BV comprises a null component, the direction of the null component of the BV, whether to use flipping to encode/decode the CB, and/or the direction of flipping.

The first and/or second indications may be referred to by other names and/or may have other values. The first indication may be an indication (e.g., an IBC mirror mode flag) of whether to use flipping to encode/decode a current block. The second indication may be an indication (e.g., an IBC mirror mode flip type flag) of a direction of flipping. The first indication may have a value of 0, for example, if RRIBC mode is used for encoding/decoding a current block, and may have a value of 1, for example, if RRIBC mode is not used for encoding/decoding a current block. The second indication may have a value of 0, for example, if the direction of flipping is vertical, and may have a value of 1, for example, if the direction is horizontal. The first indication may indicate whether a BV comprises a null component. The second indication may indicate a direction of the null component of the BV.

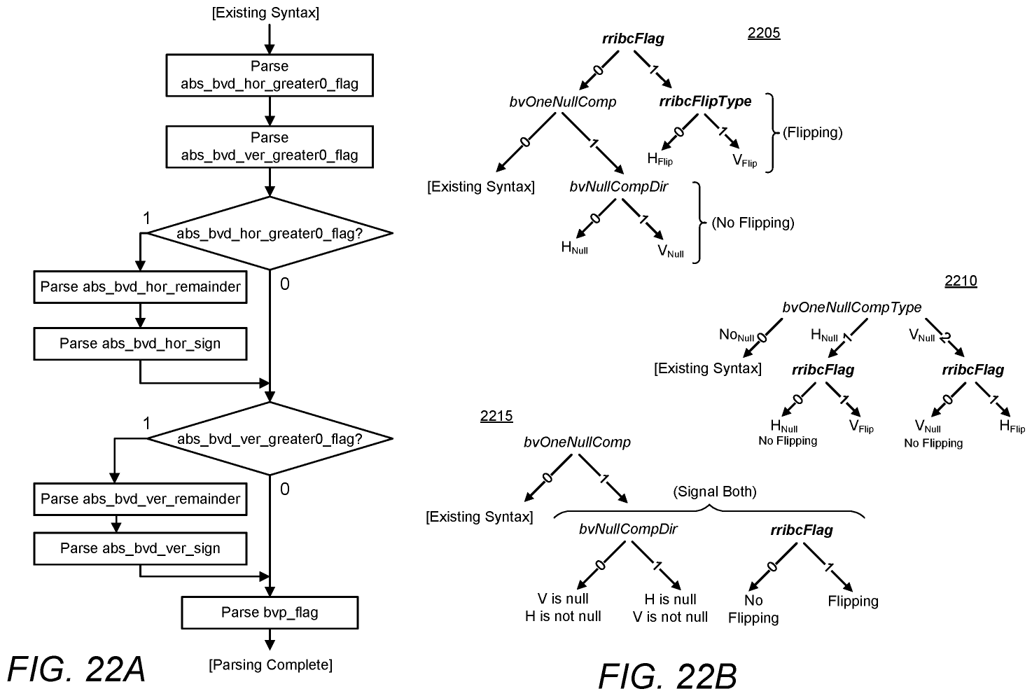

FIGS. 22A and 22B show examples of syntax parsing of conditionally indicated syntax elements in an IBC mirror mode or RRIBC mode. The syntax elements may be determined by an encoder (e.g., during encoding of a current block) and/or used by a decoder (e.g., during decoding of a current block). The encoder may determine and send the syntax elements, and/or the receiver may receive and process the syntax elements.

In a first example 2205 of syntax elements, a first flag (e.g., an RRIBC flag, denoted as rribcFlag in example 2205 of FIG. 22B) may be indicated/signaled first (e.g., by an encoder, to a decoder). The RRIBC flag is also referred to herein as an IBC mirror mode flag. The first flag may indicate whether flipping is used to encode/decode the current block. A second flag (e.g., BV one null component flag, denoted as bvOneNullComp in example 2205 of FIG. 22B) may be indicated/signaled (e.g., by an encoder, to a decoder) to indicate whether or not a BV (e.g., for a reference block corresponding to the current block) has one null component. The second flag may be indicated, for example, based on/if the first flag indicates/is signaled to indicate that flipping is not to be used. An existing syntax structure for IBC (e.g., [Existing Syntax] as shown in FIG. 22A) may be used (e.g., by an encoder, to a decoder), for example, based on the BV not having one null component. The existing syntax structure may indicate/provide, for example: indicators/flags indicating whether magnitudes of horizontal and/or vertical components of a BVD are greater than zero (e.g., abs_bvd_hor_greater0_flag and abs_bvd_ver_greater0_flag as shown in FIG. 22A); indicators of signs of horizontal and/or vertical components of the BVD (e.g., abs_bvd_hor_sign and abs_bvd_ver_sign as shown in FIG. 22A) and the magnitudes of the horizontal and/or vertical components of the BVD (e.g., abs_bvd_hor_remainder and abs_bvd_ver_remainder as shown in FIG. 22A); and, signaling of a BVP flag or indicator/index (e.g., bvp_flag as shown in FIG. 22A). A third flag (e.g., BV null component direction flag, denoted as bvNullCompDir in example 2205 of FIG. 22B) may be indicated/signaled (e.g., by an encoder, to a decoder), for example, if the second flag (e.g., BV one null component flag) indicates that the BV does have one null component. The third flag may indicate which component of the BV (e.g., horizontal component or vertical component) is null. The BV null component direction flag may indicate which component of the BV (e.g., horizontal component or vertical component), is not null. A fourth flag (e.g., an RRIBC flip type flag, denoted as rribcFlipType in example 2205 of FIG. 22A) may be signaled (e.g., by an encoder, to a decoder) to indicate which direction of flipping (e.g., horizontal direction or vertical direction), should be applied to encode/decode the current block. The fourth flag may be signaled, for example, if the first flag indicates that flipping is used. The RRIBC flip type flag is also referred herein as an IBC mirror mode flip type flag.

In a second example 2210 of syntax elements, a first syntax element/flag (e.g., BV one null component type, denoted as bvOneNullCompType as shown in example 2210 of FIG. 22B) may be signaled/indicated first (e.g., by an encoder, to a decoder). The first syntax element/flag may indicate which component(s) of the BV (e.g., horizontal component or vertical component) is null, if any. A first value of the first syntax element may indicate that no components of the BV are null, a second value of the first syntax element may indicate that the horizontal component of the BV is null, and a third value of the first syntax element may indicate that the vertical component of the BV is null. The first syntax element may indicate which component(s) of the BV (e.g., horizontal or vertical component, or both) is (or are) not null. An existing syntax structure may be used (e.g., [Existing Syntax] as described with respect to FIG. 22A), for example, if the first syntax element indicates that the BV does not have a null component. A second flag (e.g., RRIBC flag, denoted as rribcFlag as shown in example 2210 of FIG. 22B) may be signaled/indicated (e.g., by an encoder, to a decoder) to indicate whether flipping is used to encode/decode the current block. The second flag may be signaled/indicated, for example, if the first syntax element indicates that the BV does have a null horizontal component or null vertical component. The current block may be encoded/decoded without flipping, for example, if the first syntax element indicates that the horizontal component or the vertical component of the BV is null, and the second flag indicates that flipping is not used. The second flag may be signaled/indicated (e.g., by an encoder, to a decoder), for example, if the first syntax element indicates that the horizontal component or vertical component of the BV is null. The current block may be encoded/decoded with flipping, for example, if the second flag indicates that flipping is used. Flipping may be determined to be in in a direction that corresponds to a direction of a non-null component of the BV. Flipping in a vertical direction may be used to encode/decode the current block, for example, if the horizontal component of the BV is null and the second flag indicates the use of flipping. Flipping in a horizontal direction may be used to encode/decode the current block, for example, if the vertical component of the BV is null and the second flag indicates the use of flipping.

In a third example 2215 of syntax elements, a first flag (e.g., BV one null component′ flag, denoted as bvOneNullComp in example 2215 of FIG. 22B) may be signaled/indicated first. The first flag may indicate which component of the BV (e.g., horizontal component or vertical component) is null, if any. An existing syntax structure may be used (e.g., [Existing Syntax] as described with respect to FIG. 22A), for example, if the first flag indicates that the BV does not comprise a null component. A second flag (e.g., BV null component direction flag, denoted as bvNullCompDir′ in example 2215 of FIG. 22B) may be signaled/indicated to indicate which component of the BV (e.g., horizontal component or vertical component) is null. The second flag may be indicated, for example, if the first flag indicates that the BV has one null component. The second flag may indicate which component of the BV (e.g., horizontal component or vertical component) is not null. A third flag (e.g., RRIBC flag, denoted as rribcFlag in example 2215 of FIG. 22B) may be indicated/signaled (e.g., along with the second flag) to indicate whether flipping is used to encode/decode the current block. The current block may be encoded/decoded without flipping, for example, if the first flag indicates that a component of the BV is null, and the third flag indicates that flipping is not used. A direction of flipping may be determined to be used to encode/decode the current block, for example, based on a combination of the second flag and the third flag. Flipping in a horizontal direction may be used to encode/decode the current block, for example, if the vertical component of the BV is null and the third flag indicates that flipping is used. Flipping in a vertical direction may be used to encode/decode the current block, for example, if the horizontal component of the BV is null and the third flag indicates that flipping is used, then.

Syntax elements (or flags) and their associated values are described herein are exemplary. Other flags and/or values may be used to indicate various parameters for encoding/decoding (e.g., indication of a null component, direction of a null component, indication of flipping, indication of a direction of flipping, etc.). More or fewer syntax elements (or flags) may be signaled/indicated to accomplish the same or similar objectives. For example, two flags having two possible values each may be replaced by a single flag having more than two possible values (e.g., as shown in example 2210 of FIG. 22B). The value 0 may mean false, and the value 1 may mean true. In other examples, the values 0, 1, and/or ‘2’ may have other meanings. Various examples herein may comprise determination of a relative signaling cost (e.g., a rate-distortion optimization (RDO) cost) of various combinations of syntax elements (or flags) and their associated possible values, for encoding/decoding the current block, as described herein.

FIG. 19A shows an example representation of a BV comprising a null vertical component with derived BVPs and BVDs. FIG. 19A further shows an example of IBC predictive coding. An encoder (e.g., encoder 200 as shown in FIG. 2) may use an IBC prediction mode to code a current block 1900 in a current picture (or portion of a current picture) 1902. The encoder may use/apply a block matching technique to determine a BV 1908 that indicates the relative displacement from the current block 1900 to a reference block 1910 within the IBC reference region 1906. The reference block may match, or best match, the current block 1900. The BV 1908 may be constrained by the IBC reference region 1906 to indicate a displacement from the current block 1900 to a reference block that is within the IBC reference region 1906. The encoder may determine and/or use a difference (e.g., a corresponding sample-by-sample difference) between the current block 1900 and the reference block 1910. The difference may be referred to as a prediction error or residual. The encoder may store and/or signal, via a bitstream, the prediction error and/or related prediction information for decoding.

The prediction information may comprise the BV 1908. The BV 1908 may be predictively coded in a manner that is similar to techniques used for AMVP for inter prediction. For example, the BV 1908 may be coded using BV prediction and difference coding. The encoder may code the BV 1908 as a difference between the BV 1908 and a BVP. The encoder may select a BVP from a list of candidate BVPs. The candidate BVPs may correspond to previously decoded BVs of neighboring blocks of the current block 1900, or may be determined from other sources. Both the encoder and decoder may generate and/or determine the list of candidate BVPs. The list of candidate BVPs may comprise as an AMVP List. BVP₀ and BVP₁, as shown in FIG. 19A, may be example BVPs.

The encoder may determine a BVD based on a selected BVP from the list of candidate BVPs. BVD₀ and BVD₁ may be example BVDs, as shown in FIG. 19A. A BVD may be calculated based on the difference between the BV 1908 and the BVP. A BVD may be represented by two directional components calculated according to equations (17) and (18). BVDₓ and BVD, may respectively represent a horizontal component and a vertical component of the BVD. BVₓ and BV_{y} may respectively represent a horizontal component and a vertical component of the BV 1908. BVPₓ and BVP_{y} may respectively represent a horizontal component and a vertical component of the BVP.

FIG. 19A shows a particular example wherein the BV 1908 may comprise a non-null horizontal component BVₓ and a null vertical component BV_{y} (e.g., BV_{y}=0). The BV 1908 may indicate a displacement from the current block 1900 to the reference block 1910 in the IBC reference region 1906.

An encoder may determine a first BVP (e.g., BVP₀,) for example, based on a dimension of the current block 1900. BVP₀ may indicate a displacement, from the current block 1900, in a same horizontal direction as the non-null horizontal component BVₓ. The encoder may determine BVP₀, for example, based on an inverse of the width of current block 1900 (e.g., a negative of the width of the current block, −CB.Width). An encoder may determine a second BVP, for example, (e.g., BVP₁) based on a displacement from the location of current block 1900. BVP₁ may indicate a displacement, from the current block 1900, in the same horizontal direction as a non-null horizontal component BVₓ. The displacement, of BVP₁ from the current block 1900, may extend to the left-most boundary of the IBC reference region 1906. The encoder may determine BVP₁ based on a position at/of the left-most boundary of the IBC reference region 1906 (e.g., to the left of current block 1900). BVP₀ and BVP₁ may comprise null vertical components. BVP₀ and BVP₁ may comprise null vertical components, for example, based on the BV 1908 comprising a null vertical component. The encoder may insert BVP₀ and BVP₁ into a list of candidate BVPs (e.g., an AMVP list). The encoder may determine a selected BVP among BVP₀ and BVP₁. The encoder may determine a selected BVP, among BVP₀ and BVP₁, for example, in a similar manner to selecting a BVP from a list of candidate BVPs (e.g., as described herein, for example, with respect to FIGS. 17A and 17B). The encoder may signal/send an indication of the selected BVP, to a decoder, via a bitstream. The indication of the selected BVP may comprise an index/indicator.

The encoder may determine a first BVD (e.g., BVD₀) and a second BVD (e.g., BVD₁). The encoder may determine BVD₀ and/or BVD₁, for example, based on a difference between the BV 1908 and BVP₀ and/or a difference between the BV 1908 and BVP₁, respectively. The encoder may determine BVD₀ and/or BVD₁ according to equations (19) and (20). BVₓ may be the non-null horizontal component of the BV 1908. The encoder may determine a BVD for indicating/signaling to the decoder, for example, based on a difference between the BV 1908 and the selected BVP. The encoder may signal/indicate the BVD via the bitstream. An indication of the BVD may comprise an absolute value of a non-null component of the BVD. The encoder may determine a residual of the current block 1900, for example, based on a difference between the current block 1900 and the reference block 1910. The encoder may signal, via a bitstream, the residual of the CB.

The decoder may determine a first BVP (e.g., BVP₀), for example, based on a dimension of the current block 1900. BVP₀ may indicate a displacement from the current block 1900 in the same horizontal direction as a non-null horizontal component BVₓ. The decoder may determine BVP₀, for example, based on an inverse of the width of the current block 1900 (e.g., a negative of the width of the current block, −CB.Width). The decoder may determine a second BVP (e.g., BVP₁), based on a displacement from a location of the current block 1900. BVP₁ may indicate a displacement from the current block 1900 in the same horizontal direction as a non-null horizontal component BVₓ. The displacement, of BVP₁ from the current block 1900, may extend to the left-most boundary of the IBC reference region 1906. A decoder may determine BVP₁, for example, based on a position at/of the left-most boundary of IBC the reference region 1906 (e.g., to the left of the current block 1900). The decoder may insert BVP₀ and BVP₁ into a BVP candidate list (e.g., an AMVP list). The decoder may receive an indication of a selected BVP, among BVP₀ and BVP₁, via a bitstream. The indication of a selected BVP may comprise an index/indicator.

The decoder may receive an indication of a BVD via a bitstream. The indication of the BVD may comprise a magnitude (e.g., an absolute value) of a non-null component of the BVD. The decoder may determine a sign of the BVD, for example, based on the selected BVP. The determining the sign of the BVD, for example, based on the selected BVP may comprise determining/inferring the BVD sign to be negative. The BVD sign may be determined/inferred to be negative, for example, if the selected BVP is BVP₀. The determining the sign of the BVD based on the selected BVP may comprise determining/inferring the BVD sign to be positive. The BVD sign may be determined/inferred to be positive, for example, if the selected BVP is BVP₁. The decoder may determine the BVD, for example, based on the sign and the indication of the BVD (e.g., an absolute value of a non-null component of the BVD). The determining the BVD based on the sign and the indication of the BVD may further comprise assigning the sign to the non-null component of the BVD.

The decoder may determine the BV 1908, for example, based on the selected BVP and the determined BVD according to equations (21) and (22). BVₓ may represent the non-null horizontal component of the BV 1908. The determining the BV 1908 based on the selected BVP and the determined BVD may comprise determining a non-null component of the BV 1908. The decoder may determine the non-null component of the BV 1908, for example, based on combining a non-null component of the selected BVP and a non-null component of the determined BVD. The decoder may decode the current block 1900 based on the reference block 1910, that is displaced from current block 1900 by the block vector 1908, in the IBC reference region 1906. The decoder may further receive, via a bitstream, a residual of the current block 1900. The decoder may decode the current block 1900 based on combining the reference block 1910 with the residual of the current block 1900.

FIG. 19A further illustrates an example of RRIBC mode or IBC mirror mode applied/used for screen content. The RRIBC mode or IBC mirror mode may utilize symmetry within portions of content to increase efficiency for coding video content. Horizontal symmetry between the current block 1900 and the reference block 1910 may indicate that flipping in a horizontal direction may be used to encode/decode the current block 1900. As shown in FIG. 19A, an example content of the character ‘d’ within the current block 1900 may be predicted using an example content of the character ‘b’ within the reference block 1910. The example content of the character ‘d’ within the current block 1900 may be predicted using an example content of the character ‘b’ within the reference block 1910, for example, based on using flipping of the reference block 1910 (or a reconstructed block based on the reference block 1910 and a residual of the current block 1900) in a horizontal flipping direction to encode/decode the current block 1900. The encoder may signal/send an indication (e.g., to a decoder) that flipping (e.g., horizontal flipping) is used to encode/decode current block 1900, for example, based on determining that horizontal symmetry is present between the current block 1900 and a reference block 1910.

FIG. 19B shows an example of representing a BV comprising a null horizontal component using derived BVPs and BVDs. FIG. 19B shows a particular example wherein the BV 1908 comprises a non-null vertical component BV_{y} and a null horizontal component BVₓ (e.g., BVₓ=0). The BV 1908 may indicate a displacement from the current block 1900 to the reference block 1910 in the IBC reference region 1906.

An encoder may determine a first BVP (e.g., BVP₀), for example, based on a dimension of the current block 1900. BVP₀ may indicate a displacement, from the current block 1900, in a same vertical direction as the non-null vertical component BV_{y}. The encoder may determine BVP₀, for example, based on an inverse of the height of current block 1900 (e.g., a negative of the height of the current block, −CB.Height). The encoder may determine a second BVP (e.g., BVP₁), for example, based on a displacement from the location of current block 1900. BVP₁ may indicate a displacement, from the current block 1900, in the same vertical direction as a non-null vertical component BVₓ. The displacement, of BVP₁ from the current block 1900, may extend to the top-most boundary of the IBC reference region 1906. The encoder may determine BVP₁, for example, based on a position at/of the top-most boundary of the IBC reference region 1906 (e.g., above the current block 1900). BVP₀ and BVP₁ may comprise null horizontal components. BVP₀ and BVP₁ may comprise null horizontal components, for example, based on the BV 1908 comprising a null horizontal component. The encoder may insert BVP₀ and BVP₁ into a list of candidate BVPs (e.g., an AMVP list). The encoder may determine a selected BVP among BVP₀ and BVP₁. The encoder may determine a selected BVP, among BVP₀ and BVP₁, in a similar manner to selecting a BVP from a list of candidate BVPs (e.g., as described herein, for example, with respect to FIGS. 17A and 17B). The encoder may signal/send an indication of the selected BVP, to a decoder, via a bitstream. The indication of the selected BVP may comprise an index/indicator.

The encoder may determine a first BVD (e.g., BVD₀) and a second BVD (e.g., BVD₁). The encoder may determine BVD₀ and/or BVD₁, for example, based on a difference between the BV 1908 and BVP₀ and/or a difference between the BV 1908 and BVP₁, respectively. The encoder may determine BVD₀ and/or BVD₁ according to equations (23) and (24). BV_{y} may be the non-null vertical component of the BV 1908. The encoder may determine a BVD for indicating/signaling to the decoder, for example, based on a difference between the BV 1908 and the selected BVP. The encoder may signal/indicate/send an indication of the BVD via the bitstream. An indication of the BVD may comprise a magnitude (e.g., an absolute value) of a non-null component of the BVD. The encoder may determine a residual of the current block 1900, for example, based on a difference between the current block 1900 and the reference block 1910. The encoder may signal, via a bitstream, the residual of the CB.

The decoder may determine a first BVP (e.g., BVP₀), for example, based on a dimension of the current block 1900. BVP₀ may indicate a displacement from the current block 1900 in the same vertical direction as a non-null vertical component BV_{y}. The decoder may determine BVP₀, for example, based on an inverse of the height of the current block 1900 (e.g., a negative of the height of the current block, −CB.Height). The decoder may determine a second BVP (e.g., BVP₁), for example, based on a displacement from a location of the current block 1900. BVP₁ may indicate a displacement from the current block 1900 in the same vertical direction as a non-null vertical component BV_{y}. The displacement, of BVP₁ from the current block 1900, may extend to the top-most boundary of the IBC reference region 1906. A decoder may determine BVP₁, for example, based on a position at/of the top-most boundary of IBC the reference region 1906 (e.g., above the current block 1900). The decoder may insert BVP₀ and BVP₁ into a BVP candidate list (e.g., an AMVP list). The decoder may receive an indication of a selected BVP, among BVP₀ and BVP₁, via a bitstream. The indication of a selected BVP may comprise an index/indicator.

The decoder may receive an indication of a BVD via a bitstream. The indication of the BVD may comprise an absolute value of a non-null component of the BVD. The decoder may determine a sign of the BVD, for example, based on the selected BVP. The determining the sign of the BVD based on the selected BVP may comprise determining/inferring the BVD sign to be negative, for example, if the selected BVP is BVP₀. The determining the sign of the BVD based on the selected BVP may comprise determining/inferring the BVD sign to be positive, for example, if the selected BVP is BVP₁. The decoder may determine the BVD, for example, based on the sign and the indication of the BVD (e.g., an absolute value of a non-null component of the BVD). The determining the BVD based on the sign and the indication of the BVD may further comprise assigning the sign to the non-null component of the BVD.

The decoder may determine the BV 1908 based on the selected BVP and the determined BVD according to equations (25) and (26). BV_{y} may represent the non-null vertical component of the BV 1908. The determining the BV 1908 based on the selected BVP and the determined BVD may comprise determining a non-null component of the BV 1908. The decoder may determine the non-null component of the BV 1908, for example, based on combining a non-null component of the selected BVP and a non-null component of the determined BVD. The decoder may decode the current block 1900, for example, based on the reference block 1910, that is displaced from current block 1900 by the block vector 1908, in the IBC reference region 1906. The decoder may further receive, via a bitstream, a residual of the current block 1900. The decoder may decode the current block 1900, for example, based on combining the reference block 1910 with the residual of the current block 1900.

FIG. 19B further shows an example of RRIBC or IBC mirror mode applied/used for screen content. The RRIBC mode or IBC mirror mode may utilize symmetry within portions of content to increase efficiency for coding video content. Vertical symmetry between the current block 1900 and the reference block 1910 may indicate that flipping in a vertical direction may be used to encode/decode the current block. As illustrated in FIG. 19B, an example content of the character ‘b’ within the current block 1900 may be predicted based on an example content of the character ‘p’ within the reference block 1910. An example content of the character ‘b’ within the current block 1900 may be predicted based on an example content of the character ‘p’ within the reference block 1910, for example, by using flipping of the reference block 1910 (or a reconstructed block based on reference block 1910 and a residual of the current block 1900) in a vertical flipping direction to encode/decode current block 1900. The encoder may signal/send an indication (e.g., to a decoder) that flipping (e.g., vertical flipping) is used to encode/decode current block 1900, for example, based on determining that vertical symmetry is present between the current block 1900 and a reference block 1910.

FIG. 20A shows an example in which RRIBC or IBC mirror mode may or may not be applied/used for screen content. RRIBC or IBC mirror mode may or may not be applied/used for screen content, for example, to utilize symmetry within portions of content. Horizontal symmetry may be exhibited between a current block 2000 and a reference block 2010. An example content of the character ‘W’ within the current block 2000 may be predicted by/based on an example content of the character ‘W’ within the reference block 2010. Flipping of the reference block 2010 (or a reconstructed block based on the reference block 2010 and a residual of the current block 2000) in a horizontal flipping direction to encode/decode current block 2000 may have similar (or substantially similar) prediction result as not flipping the reference block 2010 in a horizontal flipping direction to encode/decode the current block 2000. The encoder may signal/send an indication (e.g., to a decoder) that flipping is not used to encode/decode current block 2000, for example, based on determining that a use of flipping of the reference block 2010 results in similar (or substantially similar) prediction results as not flipping the reference block 2000.

FIG. 20B shows an example in which RRIBC or IBC mirror mode may or may not be applied/used for screen content. RRIBC or IBC mirror mode may or may not be applied/used for screen content, for example, to utilize symmetry within portions of content. Vertical symmetry may be exhibited between a current block 2000 and a reference block 2010. An example content of the character ‘E’ within the current block 2000 may be predicted by/based on an example content of the character ‘E’ within the reference block 2010. Flipping of the reference block 2010 (or a reconstructed block based on the reference block 2010 and a residual of the current block 2000) in a vertical flipping direction to encode/decode the current block 2000 may have similar, or substantially similar, prediction result as not flipping the reference block 2010 in a vertical flipping direction to encode/decode the current block 2000. The encoder may signal/send an indication (e.g., to a decoder) that flipping is not used to encode/decode current block 2000, for example, based on determining that a use of flipping of the reference block 2010 results in similar (or substantially similar) prediction results as not flipping the reference block 2000.

The various examples described herein may comprise determining a BV based on a derived BVP, and a sign and direction of a component of a BVD for encoding/decoding a CB. A decoder may receive, via a bitstream, indications of: a component of a BV being null (e.g., a direction of a null component of the BV), a magnitude of a component of a BVD; and/or a BVP. The indication of a component of the BV being null may comprise a first flag indicating that a component of the BV is null. The indication of a component of the BV being null may further comprise a second flag indicating a direction of the null component of the BV. The first flag may be a BV one null component flag, and the second flag may be a BV null component direction flag. The null component of the BV may comprise a null vertical component. The null component of the BV may comprise a null horizontal component.

The decoder may determine a direction of the component of the BVD. The decoder may determine the direction of the component of the BVD, for example, based on the direction of the null component of the BV. The direction of the component of the BVD may be determined to be vertical, for example, based on the direction of the null component of the BV being horizontal (e.g., horizontal component of the BV being a null component). The direction of the component of the BVD may be determined to be horizontal, for example, based on the direction of the null component of the BV being vertical (e.g., vertical component of the BV being a null component). The first flag may be an IBC mirror mode flag indicating that IBC mirror mode is used to encode the current block, and the second flag may be an IBC mirror mode flip type flag indicating a direction of flipping. The reference block may mirror the current block in the direction of the flip.

The decoder may determine a direction of the component of the BVD. The decoder may determine a direction of the component of the BVD, for example, based on the direction of the flipping. The direction of the component of the BVD may be determined to be horizontal, for example, based on the direction of the flipping being horizontal. The direction of the component of the BVD may be determined to be vertical, for example, based on the direction of the flipping being vertical.

The decoder may determine a list of BVPs comprising a first BVP and a second BVP. The decoder may determine, based on the indication of a component of the BV being null (e.g., a direction of a null component of the BV), a list of BVPs comprising a first BVP and a second BVP. The first BVP may be determined based on a dimension of the current block, and the second BVP may be determined based on a displacement from a location of the current block to a boundary of the reference region. The first BVP may be determined based on an inverse of a height of the current block. The first BVP may be determined based on an inverse of a height of the current block, for example, based on the null component of the BV being in a horizontal direction. The first BVP may be determined based on an inverse of a width of the current block. The first BVP may be determined based on an inverse of a width of the current block, for example, based on the null component of the BV being in a vertical direction. The displacement from the location of the current block may indicate a position at a top-most boundary of the reference region above the current block. The second BVP may indicate a position at a top-most boundary of the reference region above the current block, for example, based on the null component of the BV being in a horizontal direction. The displacement from the location of the current block may indicate a position at a left-most boundary of the reference region left of the current block. The second BVP may indicate a position at a left-most boundary of the reference region left of the current block, for example, based on the null component of the BV being in a vertical direction. The indication of the BVP may indicate one of the first BVP or the second BVP.

The decoder may determine a sign of the component of the BVD. The decoder may determine a sign of the component of the BVD, for example, based on the BVP and the indication of a component of the BV being null. The determining the sign of the component of the BVD based on the BVP may comprise determining the sign of the component of the BVD to be negative, for example, based on the BVP being the first BVP. The determining the sign of the component of the BVD based on the BVP may comprise determining the sign of the component of the BVD to be positive, for example, based on the BVP being the second BVP. The indication of the magnitude of the component of the BVD may comprise an absolute value of a non-null component of the BVD. The determining the sign of the component of the BVD based on the BVP and the indication of a component of the BV being null may comprise assigning the sign to the non-null component of the BVD (e.g., magnitude of the non-null component of the BVD).

The decoder may determine the BV. The decoder may determine the BV based on the BVP, the sign of the component of the BVD, and/or the magnitude of the component of the BVD. The determining the BV based on the BVP, the sign of the component of the BVD, and/or the magnitude of the component of the BVD may comprise determining a non-null component of the BV by combining (e.g., adding) a non-null component of the BVP and the non-null component of the BVD.

The decoder may decode a current lock based on a reference block in a reference region. The reference block may be displaced from the current block by the BV. The decoder may receive, via a bitstream, a residual of the current block. The decoder may decode the current block based on combining the reference block with the residual of the current block. The decoding the current block based on the reference block, that is displaced from the current block by the BV, in the reference region may comprise one or more of: receiving, via the bitstream, a residual of the current block; determining a reconstructed block based on combining the reference block with the residual of the current block; determining, based on a first indication (e.g., the IBC mirror mode flag), to flip the reconstructed block; flipping the reconstructed block in the direction of the flip indicated by a second indication (e.g., the IBC mirror mode flip type flag); and decoding the current block based on the flipped reconstructed block.

Various examples as described herein may comprise determination of a relative signaling cost for signaling parameters/syntax elements associated with encoding/decoding a current block (e.g., one or more of an indication of a BVP, an indication of a magnitude of (component(s) of) a BVD, indication of sign(s) of (components of) the BVD, an indication that a BV comprises a null component, an indication of the null component of the BV, an indication of flipping, an indication of a direction of flipping, etc.). The relative signaling cost may be based on a quantity of bits used to signal a syntax element or several syntax elements in a bitstream for encoding/decoding the current block. An encoder may determine/select a technique, among a plurality of techniques, for signaling the parameters/syntax elements, for example, based on comparison of relative signaling costs associated with the plurality of techniques.

An encoder may select/determine a technique (e.g., among a plurality of different techniques) for predictively coding a BV based on a BVP and a BVD. The encoder may select the technique which results in a lower or lowest signaling cost (e.g., among the plurality of techniques). The signaling cost may represent an RDO cost, or a cost based on a quantity of bits used to signal a syntax element or several syntax elements (e.g., via the bitstream for encoding/decoding the current block). The signaling cost may be based on one or more of: a cost of signaling an indicator/index of a selected BVP or a selected replacement BVP, a cost of signaling a magnitude of a selected BVD or a selected replacement BVD, a cost of signaling a sign of the selected BVD or the selected replacement BVD, and/or a cost of signaling an indication of whether a component of the selected BVD or the selected replacement BVD is greater than zero.

In a first technique (e.g., BVP regular case), an encoder may determine a first BVP and a second BVP based on an AMVP list. The encoder may determine a first BVP and a second BVP based on an AMVP list, for example, instead of determining modified/derived BVP₀ and BVP₁ and associated BVDs (e.g., modified/derived BVP₀ and BVP₁ and associated BVDs as described herein with respect to FIGS. 19A, 19B, 20A, and 20B). In a second technique (e.g., BVP replacement case), the encoder may determine modified/derived BVP₀ and BVP₁ and associated BVDs (e.g., as described herein with respect to FIGS. 19A, 19B, 20A, and 20B). The encoder may determine the relative signaling cost of the first technique (e.g., BVP regular case) versus the relative signaling cost of the second technique (e.g., BVP replacement case). The encoder may select the technique with the lower relative signaling cost. The encoder may signal (e.g., send, indicate) the relevant syntax elements (e.g., to the decoder) according to the selected first technique or second technique. The encoder may compare the first technique and the second technique, for example, if a BV has one null component, but RRIBC-based flipping is not used to encode/decode the current block. The encoder may select the second technique, for example, if a BV has one null component and RRIBC-based flipping is used to encode/decode the current block. The encoder may determine the technique having the relatively lower signaling cost in a manner that is transparent to the decoder. The decoder may receive, via the bitstream, only the syntax elements that are relevant to the technique selected by the encoder.

The encoder may determine a location of a reference block in a reference region. The reference block may be displaced from a location of a current block by a BV. The BV may comprise one null component. The encoder may determine, using the first technique, a first BVP and a second BVP. The encoder may determine the first BVP and the second BVP, for example, based on determining/constructing an AMVP list. The encoder may determine a first signaling cost based on the first BVP. The encoder may determine a second signaling cost based on the second BVP. The encoder may determine a selected BVP among the first BVP and the second BVP, for example, based on the selected BVP having a lowest signaling cost among the first signaling cost and the second signaling cost.

The encoder may determine (e.g., using the second technique) a first replacement BVP based on a dimension of the current block. The first replacement BVP may be based on an inverse of a height of the current block, for example, if the BV comprises a null horizontal component. The first replacement BVP may be based on an inverse of a width of the current block, for example, if the BV comprises a null vertical component. The encoder may determine a second replacement BVP based on a displacement from a location of the current block to a boundary of the reference region. The boundary of the reference region may comprise a top-most boundary of the reference region above the current block, for example, if the BV comprises a null horizontal component. The boundary of the reference region may comprise a left-most boundary of the reference region left of the current block, for example, if the BV comprises a null vertical component. The encoder may determine a first replacement signaling cost based on the first replacement BVP. The encoder may determine a second replacement signaling cost based on the second replacement BVP. The encoder may determine a selected replacement BVP among the first replacement BVP and the second replacement BVP, for example, based on the selected replacement BVP having a lowest signaling cost between the first replacement signaling cost and the second replacement signaling cost. The encoder may determine the first replacement cost and the second replacement cost, for example, based on the various parameters that may indicated in accordance with one or more techniques described with respect to 19A, 19B, 20A, 20B, and 22B.

The encoder may compare a signaling cost of the selected BVP to a signaling cost of the selected replacement BVP, for example, to determine the technique having the relatively lower signaling cost. The first technique (e.g., BVP regular case) may be selected, for example, based on the signaling cost of the selected BVP being less than the signaling cost of the selected replacement BVP. The encoder may signal/indicate (e.g., based on the selection of the first technique), via a bitstream to the decoder, an indication of one or more of: the BV not having a null component; the selected BVP; and a sign and a magnitude of the selected BVD (e.g., based on a difference between the BV and the selected BVP). The indications may comprise syntax elements and/or flags as described herein with respect to FIGS. 22A and/or 22B. The indication that the BV does not comprise a null component (e.g., the bvOneNullComp flag may be set to indicate false, or zero) may be indicated/signaled to the decoder (e.g., irrespective of whether or not the BV having one null component). The bvOneNullComp flag may be effectively disabled by setting it to false (or zero), and the existing syntax may be used instead (e.g., as described with respect to FIG. 22A).

The second technique (e.g., the BVP replacement case) may be selected, for example, based on the signaling cost of the selected BVP being greater than or equal to the signaling cost of the selected replacement BVP. The encoder may signal (e.g., based on the selection of the second technique), via a bitstream to the decoder, one or more of: an indication that the BV comprises a null component; an indication of a direction of a non-null component of the BV; the selected replacement BVP; and/or a magnitude of a component of a selected replacement BVD (e.g., based on a difference between the BV and the selected replacement BVP). The indications may comprise syntax elements or flags as described herein with respect to FIG. 22B. The encoder may determine a residual of the current block, for example, based on a difference between the current block and the reference block. The encoder may signal, via the bitstream, the residual of the current block.

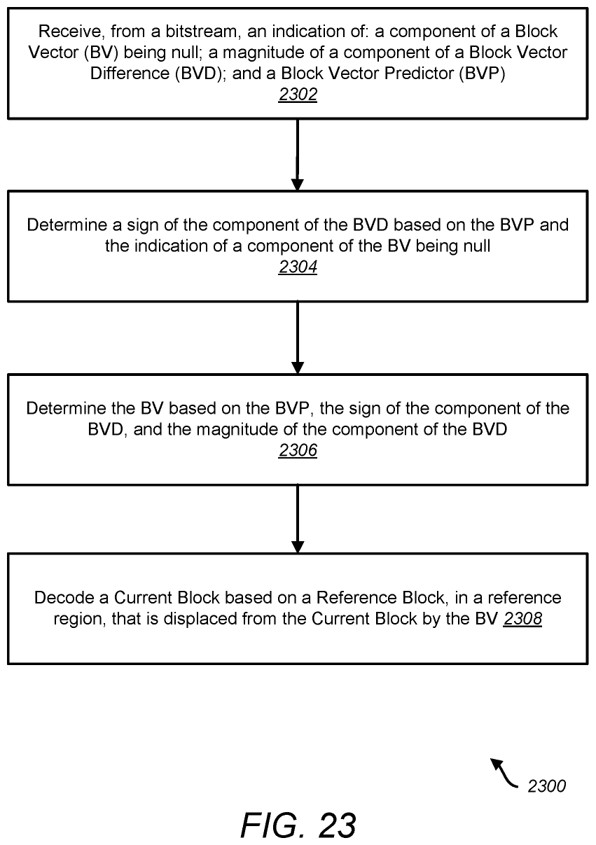

FIG. 23 shows an example method for determining a BV. The BV may be determined, for example, based on a derived BVP, and a sign and a direction of a component of a BVD for decoding a CB. FIG. 23 shows a flowchart 2300. One or more steps of the example flowchart 2300 shown in FIG. 23 may be performed by a decoder (e.g., the decoder 300 as shown in FIG. 3, or any other decoder). 2323

At step 2302, the decoder may receive, via a bitstream, indications of: a component of a BV being null; a magnitude of a component of a BVD; and/or a BVP. The indication of a component of the BV being null may comprise a first flag indicating that a component of the BV is null. The indication of a component of the BV being null may comprise a second flag indicating a direction of the null component of the BV. The first flag may be a BV one null component flag. The second flag may be a BV null component direction flag. The null component of the BV may comprise a null vertical component. The null component of the BV may comprise a null horizontal component.

The example method described herein with respect to FIG. 23 23may comprise determining a direction of the component of the BVD. The direction of the component of the BVD may be determined, for example, based on the direction of the null component of the BV. The direction of the component of the BVD may be determined to be vertical, for example, based on the direction of the null component of the BV being horizontal (e.g., the horizontal component of the BV being a null component). The direction of the component of the BVD may be determined to be horizontal, for example, based on the direction of the null component of the BV being vertical (e.g., the vertical component of the BV being a null component).

The first flag may be an IBC mirror mode flag indicating that IBC mirror mode is used to encode a current block. The second flag may be an IBC mirror mode flip type flag indicating a direction of flipping. The reference block may mirror the current block in the direction of the flipping.

The example method described herein with respect to FIG. 23 23may comprise determining a direction of the component of the BVD, for example, based on the direction of the flipping. The direction of the component of the BVD may be determined to be horizontal, for example, based on the direction of the flipping being horizontal. The direction of the component of the BVD may be determined to be vertical, for example, based on the direction of the flipping being vertical.

The example method described herein with respect to FIG. 23 may comprise determining, based on the indication of a component of the BV being null, a list of BVPs comprising a first BVP and a second BVP. The first BVP may be determined based on a dimension of the current block. The second BVP may be determined based on a displacement from a location of the current block to a boundary of the reference region. The dimension of the current block may be an inverse of a height of the current block. The dimension of the current block may be an inverse of a width of the current block. The displacement from the location of the current block may indicate a position at a top-most boundary of the reference region above the current block. The displacement from the location of the current block may indicate a position at a left-most boundary of the reference region left of the current block. The indication of the BVP may indicate one of the first BVP or the second BVP.

At step 2304, the decoder may determine a sign of the component of the BVD. The decoder may determine the sign of the component of the BVD, for example, based on the BVP and/or the indication of a component of the BV being null. The determining the sign of the component of the BVD based on the BVP may comprise determining the sign of the component of the BVD to be negative based on the BVP being the first BVP. The determining the sign of the component of the BVD based on the BVP may comprise determining the sign of the component of the BVD to be positive, for example, based on the BVP being the second BVP. The indication of the magnitude of the component of the BVD may an absolute value of a non-null component of the BVD. The determining the sign of the component of the BVD based on the BVP and/or the indication of the component of the BV being null may comprise assigning the sign to the non-null component of the BVD.

At step 2306, the decoder may determine the BV based on the BVP, the sign of the component of the BVD, and/or the magnitude of the component of the BVD. The determining the BV based on the BVP, the sign of the component of the BVD, and/or the magnitude of the component of the BVD may comprise determining a non-null component of the BV. The determining the non-null component of the BVP may comprise combining a non-null component of the BVP and the non-null component of the BVD.

At step 2308, the decoder may decode a current block based on a reference block in a reference region. The reference block may be displaced from the current block by the BV. The example method described herein with respect to FIG. 23 23may comprise receiving, via the bitstream, a residual of the current block. The example method described herein with respect to FIG. 2323 may comprise decoding the current block based on combining the reference block with the residual of the current block. The decoding the current block based on the reference block (e.g., in the reference region) that is displaced from the current block by the BV may comprise one or more of: receiving, via the bitstream, a residual of the current block; determining a reconstructed block based on combining the reference block with the residual of the current block; determining, based on a first flag (e.g., the IBC mirror mode flag), to flip the reconstructed block; flipping the reconstructed block in the direction of the flip indicated by a second flag (e.g., the IBC mirror mode flip type flag); and decoding the current block based on the flipped reconstructed block.

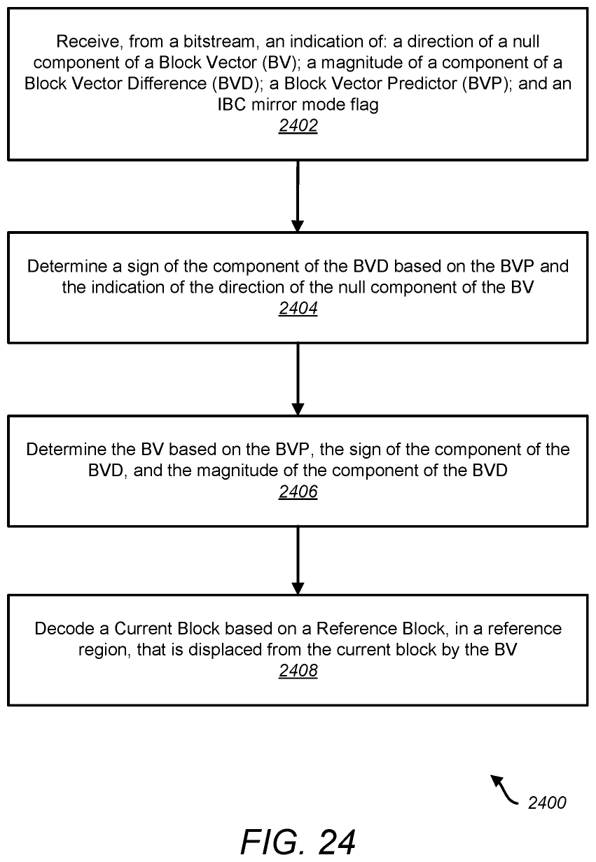

FIG. 24 shows 24an example method for determining a BV. The BV may be determined based on a derived BVP, and a sign and direction of a component of a BVD for decoding a current block. FIG. 24 shows an example flowchart 2400. One or more steps of the example flowchart 2400 24may be performed by a decoder (e.g., the decoder 300 as shown in FIG. 3, or any other decoder). 2424

At step 2402, the decoder may receive, via a bitstream, an indication of: a direction of a null component of a BV; a magnitude of a component of a BVD; a BVP; and/or an IBC mirror mode flag. The indication of the direction of the null component of the BV may comprise a first flag indicating that a component of the BV is null. The indication of the direction of the null component of the BV may further comprise a second flag indicating a direction of the null component of the BV. The first flag may be a BV one null component flag, and the second flag may be a BV null component direction flag. The null component of the BV may comprise a null vertical component. The null component of the BV may comprise a null horizontal component. The method 2400 may comprise determining a direction of the component of the BVD, for example, based on the direction of the null component of the BV. The direction of the component of the BVD may be determined to be vertical, for example, based on the null component of the BV being a horizontal component. In an embodiment, the direction of the component of the BVD may be determined to be horizontal, for example, based on the null component of the BV a being vertical component.

The method may comprise determining, based on the indication of the direction of a null component of the BV, a list of BVPs comprising a first BVP and a second BVP. The first BVP may be determined based on a dimension of the current block. The second BVP may be determined based on a displacement from a location of the current block to a boundary of the reference region. The first BVP may be based on an inverse of a height of the current block. The first BVP may be based on an inverse of a width of the current block. The displacement from the location of the current block may indicate a position at a top-most boundary of the reference region above the current block. The displacement from the location of the current block may indicate a position at a left-most boundary of the reference region left of the current block. The indication of the BVP may indicates one of the first BVP or the second BVP.

At step 2404, the decoder may determine a sign of the component of the BVD. The decoder may determine the sign of the component of the BVD, for example, based on the BVP and/or the indication of the direction of the null component of the BV. The determining the sign of the component of the BVD based on the BVP may comprise determining the sign of the component of the BVD to be negative, for example, based on the BVP being the first BVP. The determining the sign of the component of the BVD based on the BVP may comprise determining the sign of the component of the BVD to be positive, for example, based on the BVP being the second BVP. The indication of the magnitude of the component of the BVD may comprise an absolute value of a non-null component of the BVD. The determining the sign of the component of the BVD based on the BVP and/or the indication of the direction of the null component of the BV may comprise assigning the sign to the non-null component of the BVD.

At step 2406, the decoder may determine the BV based on the BVP, the sign of the component of the BVD, and/or the magnitude of the component of the BVD. The determining the BV based on the BVP, the sign of the component of the BVD, and/or the magnitude of the component of the BVD may comprise determining a non-null component of the BV. Determining the non-null component of the BV may comprise combining (e.g., adding) a non-null component of the BVP and the non-null component of the BVD.

At step 2408, the decoder may decode a current block based on a reference block in a reference region. The reference block may be displaced from the current block by the BV. The decoding the current block based on the reference block, that is displaced from the current block by the BV, may comprise one or more of: receiving, via the bitstream, a residual of the current block; and determining, based on an indication (e.g., the IBC mirror mode flag), to decode the current block without flipping. The decoding the current block may be based on combining the reference block with the residual of the current block. The IBC mirror mode flag may further comprise an IBC mirror mode direction flag. The decoding the current block based on the reference block, that is displaced from the current block by the BV, may comprise one or more of: receiving, via the bitstream, a residual of the current block; determining a reconstructed block based on combining the reference block with the residual of the current block; determining, based on the IBC mirror mode flag, to flip the reconstructed block; flipping the reconstructed block in a flipping direction indicated by the IBC mirror mode direction flag; and decoding the current block based on the flipped reconstructed block.

The example method discussed herein with respect to FIG. 24 may comprise determining, based on the direction of the null component of the BV, that the flipping direction is one of a horizontal direction or a vertical direction. The flipping direction may be a horizontal direction, for example, based on the direction of the null component of the BV being the vertical direction. The flipping direction may be vertical, for example, based on the direction of the null component of the BV being the horizontal direction.

The example method discussed herein with respect to FIG. 24 may comprise determining, based on the IBC mirror mode direction flag, that the flipping direction is one of a horizontal direction or a vertical direction. The flipping direction may be a horizontal direction, for example, based on the IBC mirror mode direction flag indicating a horizontal direction. The flipping direction may be a vertical direction, for example, based on the IBC mirror mode direction flag indicating a vertical direction.

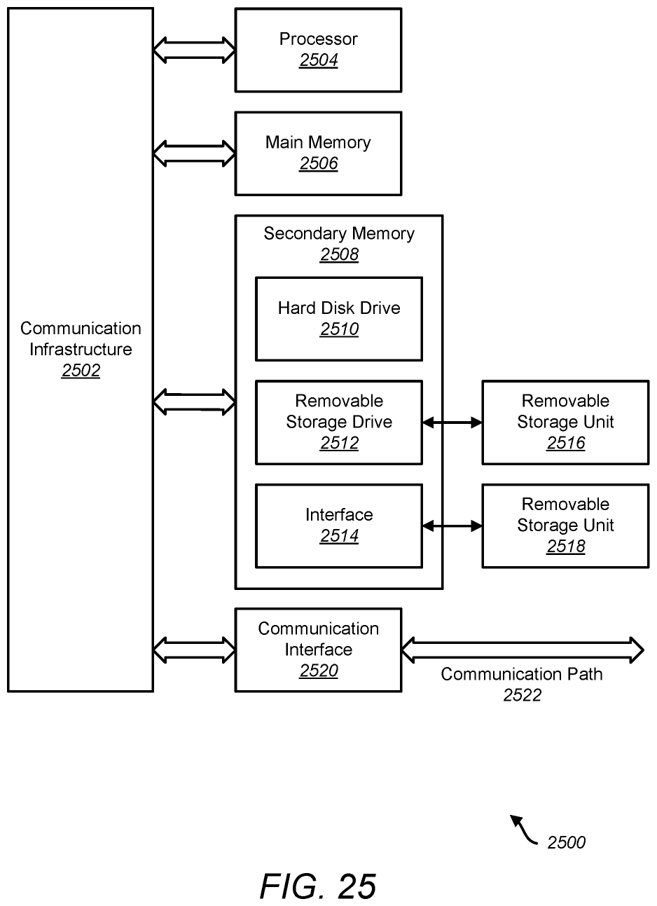

FIG. 25 shows an example computer system in which examples of the present disclosure may be implemented. For example, the example computer system 2500 shown in FIG. 25 may implement one or more of the methods described herein. For example, various devices and/or systems described herein (e.g., in FIGS. 1, 2, and 3) may be implemented in the form of one or more computer systems 2500. Furthermore, each of the steps of the flowcharts depicted in this disclosure may be implemented on one or more computer systems 2500.

The computer system 2500 may comprise one or more processors, such as a processor 2504. The processor 2504 may be a special purpose processor, a general purpose processor, a microprocessor, and/or a digital signal processor. The processor 2504 may be connected to a communication infrastructure 2502 (for example, a bus or network). The computer system 2500 may also comprise a main memory 2506 (e.g., a random access memory (RAM)), and/or a secondary memory 2508.

The secondary memory 2508 may comprise a hard disk drive 2510 and/or a removable storage drive 2512 (e.g., a magnetic tape drive, an optical disk drive, and/or the like). The removable storage drive 2512 may read from and/or write to a removable storage unit 2516. The removable storage unit 2516 may comprise a magnetic tape, optical disk, and/or the like. The removable storage unit 2516 may be read by and/or may be written to the removable storage drive 2512. The removable storage unit 2516 may comprise a computer usable storage medium having stored therein computer software and/or data.

The secondary memory 2508 may comprise other similar means for allowing computer programs or other instructions to be loaded into the computer system 2500. Such means may include a removable storage unit 2518 and/or an interface 2514. Examples of such means may comprise a program cartridge and/or cartridge interface (such as in video game devices), a removable memory chip (such as an erasable programmable read-only memory (EPROM) or a programmable read-only memory (PROM)) and associated socket, a thumb drive and USB port, and/or other removable storage units 2518 and interfaces 2514 which may allow software and/or data to be transferred from the removable storage unit 2518 to the computer system 2500.

The computer system 2500 may also comprise a communications interface 2520. The communications interface 2520 may allow software and data to be transferred between the computer system 2500 and external devices. Examples of the communications interface 2520 may include a modem, a network interface (e.g., an Ethernet card), a communications port, etc. Software and/or data transferred via the communications interface 2520 may be in the form of signals which may be electronic, electromagnetic, optical, and/or other signals capable of being received by the communications interface 2520. The signals may be provided to the communications interface 2520 via a communications path 2522. The communications path 2522 may carry signals and may be implemented using wire or cable, fiber optics, a phone line, a cellular phone link, an RF link, and/or any other communications channel(s).

A computer program medium and/or a computer readable medium may be used to refer to tangible storage media, such as removable storage units 2516 and 2518 or a hard disk installed in the hard disk drive 2510. The computer program products may be means for providing software to the computer system 2500. The computer programs (which may also be called computer control logic) may be stored in the main memory 2506 and/or the secondary memory 2508. The computer programs may be received via the communications interface 2520. Such computer programs, when executed, may enable the computer system 2500 to implement the present disclosure as discussed herein. In particular, the computer programs, when executed, may enable the processor 2504 to implement the processes of the present disclosure, such as any of the methods described herein. Accordingly, such computer programs may represent controllers of the computer system 2500.

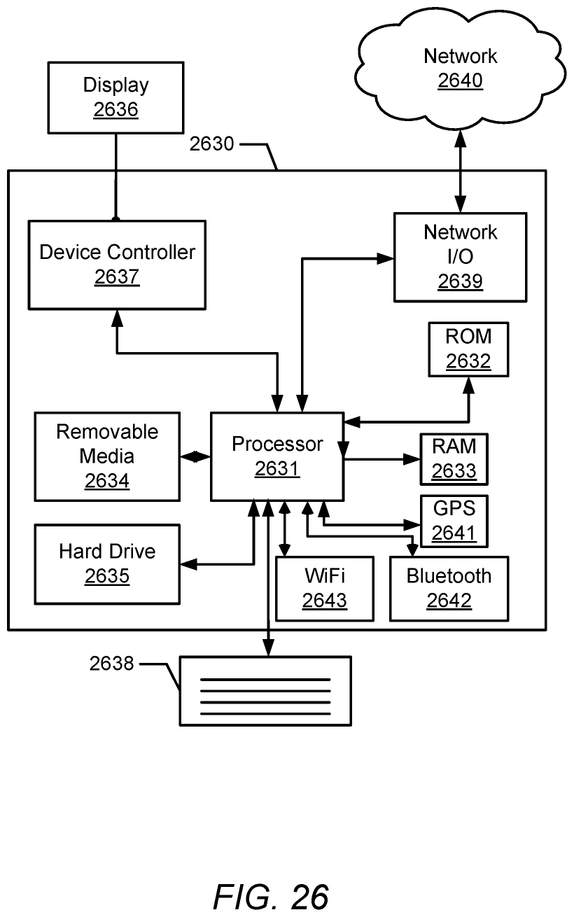

FIG. 26 shows example elements of a computing device that may be used to implement any of the various devices described herein, including, for example, a source device (e.g., 102), an encoder (e.g., 200), a destination device (e.g., 106), a decoder (e.g., 300), and/or any computing device described herein. The computing device 2630 may include one or more processors 2631, which may execute instructions stored in the random-access memory (RAM) 2633, the removable media 2634 (such as a Universal Serial Bus (USB) drive, compact disk (CD) or digital versatile disk (DVD), or floppy disk drive), or any other desired storage medium. Instructions may also be stored in an attached (or internal) hard drive 2635. The computing device 2630 may also include a security processor (not shown), which may execute instructions of one or more computer programs to monitor the processes executing on the processor 2631 and any process that requests access to any hardware and/or software components of the computing device 2630 (e.g., ROM 2632, RAM 2633, the removable media 2634, the hard drive 2635, the device controller 2637, a network interface 2639, a GPS 2641, a Bluetooth interface 2642, a WiFi interface 2643, etc.). The computing device 2630 may include one or more output devices, such as the display 2636 (e.g., a screen, a display device, a monitor, a television, etc.), and may include one or more output device controllers 2637, such as a video processor. There may also be one or more user input devices 2638, such as a remote control, keyboard, mouse, touch screen, microphone, etc. The computing device 2630 may also include one or more network interfaces, such as a network interface 2639, which may be a wired interface, a wireless interface, or a combination of the two. The network interface 2639 may provide an interface for the computing device 2630 to communicate with a network 2640 (e.g., a RAN, or any other network). The network interface 2639 may include a modem (e.g., a cable modem), and the external network 2640 may include communication links, an external network, an in-home network, a provider's wireless, coaxial, fiber, or hybrid fiber/coaxial distribution system (e.g., a DOCSIS network), or any other desired network. Additionally, the computing device 2630 may include a location-detecting device, such as a global positioning system (GPS) microprocessor 2641, which may be configured to receive and process global positioning signals and determine, with possible assistance from an external server and antenna, a geographic position of the computing device 2630.

The example in FIG. 26 may be a hardware configuration, although the components shown may be implemented as software as well. Modifications may be made to add, remove, combine, divide, etc. components of the computing device 2630 as desired. Additionally, the components may be implemented using basic computing devices and components, and the same components (e.g., processor 2631, ROM storage 2632, display 2636, etc.) may be used to implement any of the other computing devices and components described herein. For example, the various components described herein may be implemented using computing devices having components such as a processor executing computer-executable instructions stored on a computer-readable medium, as shown in FIG. 26. Some or all of the entities described herein may be software based, and may co-exist in a common physical platform (e.g., a requesting entity may be a separate software process and program from a dependent entity, both of which may be executed as software on a common computing device).

A computing device may perform a method comprising multiple operations. The computing device may receive an indication that a block vector (BV) comprises a null component; an indication of a magnitude of a component of a block vector difference (BVD) associated with a current block; and an indication of a block vector predictor (BVP). The computing device may determine a sign of the component of the BVD based on: the BVP; and the indication that the BV comprises the null component. The computing device may determine the BV based on: the BVP; the sign of the component of the BVD; and the magnitude of the component of the BVD. The computing device may decode the current block based on a reference block that is displaced from the current block by the BV. The computing device may perform one or more additional operations. The indication that the BV comprises the null component may comprise an indication of a direction of the null component of the BV. The BV may comprise a null vertical component or a null horizontal component. The indication that the BV comprises the null component may comprise an indication of a direction of the null component of the BV. The computing device may, based on the direction of the null component of the BV, determine a direction of the component of the BVD. The determining the direction of the component of the BVD may comprise determining that the direction of the component of the BVD is horizontal based on the direction of the null component of the BV being vertical. The determining the direction of the component of the BVD may comprise determining that the direction of the component of the BVD is vertical based on the direction of the null component of the BV being horizontal. The indication that the BV comprises the null component may comprise at least one of: a first indication that flipping of the reference block is used to encode the current block; or a second indication of a direction of flipping of the reference block. The computing device may determine, based on the indication that the BV comprises the null component, a list of BVPs. The list of BVs may comprise: a first BVP determined based on a dimension of the current block; and a second BVP determined based on a displacement from a location of the current block to a boundary of a reference region. The displacement from the location of the current block may indicate: a position at a top-most boundary of the reference region above the current block, or a position at a left-most boundary of the reference region left of the current block. The first BVP may be determined based on: a negative of a height of the current block, or a negative of a width of the current block. The indication of the BVP may indicate a BVP in the list of BVPs. The determining the sign of the component of the BVD based on the BVP may comprise: determining the sign of the component of the BVD to be negative based on the BVP being a first BVP in a list of BVPs; or determining the sign of the component of the BVD to be positive based on the BVP being a second BVP in the list of BVPs. The computing device may receive an indication of flipping of the reference block. The decoding the current block may be further based on the indication of flipping of the reference block. The indication that the BV comprises the null component may comprise an indication that flipping of the reference block is used to encode the current block. The reference block may mirror the current block in a direction of flipping. The computing device may determine the direction of the component of the BVD to be horizontal based on a direction of flipping being horizontal. The computing device may determine the direction of the component of the BVD to be vertical based on a direction of flipping being vertical. The computing device may determine a non-null component of the BVD based on the magnitude of the component of the BVD and the sign of the component of the BVD. Determining the BV may comprise determining a non-null component of the BV by combining a non-null component of the BVP and the non-null component of the BVD. The indication that the BV comprises the null component may comprise at least one of: a BV one component null flag; or a BV one component null direction flag. The decoding the current block may comprise: receiving a residual of the current block; determining a reconstructed block based on combining the reference block with the residual of the current block; determining, based on the indication that flipping of the reference block is used to encode the current block, to flip the reconstructed block; and flipping the reconstructed block in the direction of the flip indicated by the indication that flipping of the reference block is used to encode the current block. Decoding the current block may comprise decoding the current block based on the flipped reconstructed block. The computing device may receive a residual of the current block. The decoding the current block may comprise decoding the current block based on combining the reference block with the residual of the current block. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to send the indication that the BV comprises the null component. A computer-readable medium may store instructions that, when executed, cause performance of the described method, additional operations and/or include the additional elements.

A computing device may perform a method comprising multiple operations. The computing device may select, based on a block vector (BV) associated with a reference block comprising a null component, a block vector predictor (BVP). The BVP may be selected from among: a first BVP determined based on a dimension of a current block; and a second BVP determined based on a displacement from a location of the current block to a boundary of a reference region. The computing device may, based on a difference between the BV and the BVP, determine a magnitude of a block vector difference (BVD). The computing device may send an indication of the BVP, an indication that the BV comprises the null component, and an indication of the magnitude of the BVD. The computing device may perform one or more additional operations. The indication that the BV comprises the null component may comprise an indication of a direction of the null component of the BV. The BV may comprise a null vertical component or a null horizontal component. The displacement from the location of the current block may indicate: a position at a top-most boundary of the reference region above the current block, or a position at a left-most boundary of the reference region left of the current block. The indication that the BV comprises the null component may comprise at least one of: a first indication that flipping of the reference block is used to encode the current block; or a second indication of a direction of flipping of the reference block. The computing device may send a residual associated with the current block. The residual may be based on a difference between the current block and the reference block. The computing device may send an indication that flipping of the reference block is used to encode the current block. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to receive the indication that the BV comprises the null component. A computer-readable medium may store instructions that, when executed, cause performance of the described method, additional operations and/or include the additional elements.

A computing device may perform a method comprising multiple operations. The computing device may receive an indication that flipping of a reference block is used to encode a current block; an indication of a magnitude of a component of a block vector difference (BVD) associated with the current block; and an indication of a block vector predictor (BVP). The computing device may, based on the indication that flipping of the reference block is used to encode the current block, determine that a block vector (BV), associated with the reference block, comprises a null component. The computing device may determine a sign of the component of the BVD based on: the BVP; and the determination that the BV comprises the null component. The computing device determine the BV based on: the BVP; the sign of the component of the BVD; and the magnitude of the component of the BVD. The computing device may decode, based on the BV, the current block. The computing device may perform one or more additional operations. The indication that flipping of the reference block is used to encode the current block may comprise an indication of a direction of flipping. The BV may comprise a null vertical component or a null horizontal component. The computing device may determine a direction of the component of the BVD based on the direction of flipping. The computing device may, based on determining that the BV comprises the null component, determine a list of BVPs. The list of BVPs may comprise: a first BVP determined based on a dimension of the current block; and a second BVP determined based on a displacement from a location of the current block to a boundary of a reference region. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to send the indication that flipping of the reference block is used to encode the current block. A computer-readable medium may store instructions that, when executed, cause performance of the described method, additional operations and/or include the additional elements.

A computing device may perform a method comprising multiple operations. The computing device may receive, from a bitstream, an indication of: a direction of a null component of a block vector (BV); a magnitude of a component of a block vector difference (BVD); a block vector predictor (BVP); and an intra block copy (IBC) mirror mode flag. The computing device may determine a sign of the component of the BVD based on: the BVP; and the indication of the direction of the null component of the BV. The computing device may determine the BV based on the BVP, the sign of the component of the BVD, and the magnitude of the component of the BVD. The computing device may decode, based on a reference block that is displaced from the CB by the BV in a reference region, a current block. The computing device may perform one or more additional operations. The decoding the current block based on the reference block that is displaced from the current block by the BV in the reference region further may comprise: receiving, in the bitstream, a residual of the current block; and determining, based on the IBC mirror mode flag, to decode the current block without flipping based on combining the reference block with the residual of the current block. The IBC mirror mode flag may comprise an IBC mirror mode direction flag. The decoding the current block based on the reference block that is displaced from the current block by the BV in the reference region may comprise: receiving, from the bitstream, a residual of the current block; determining a reconstructed block based on combining the reference block with the residual of the current block; determining, based on the IBC mirror mode flag, to flip the reconstructed block; flipping the reconstructed block in a flipping direction indicated by the IBC mirror mode direction flag; and decoding the current block based on the flipped reconstructed block. The computing device may determine, based on the direction of the null component of the BV, that the flipping direction is one of horizontal or vertical. The flipping direction may be horizontal based on the direction of the null component of the BV being vertical. The flipping direction may be vertical based on the direction of the null component of the BV being horizontal. The computing device may determine, based on the IBC mirror mode direction flag, that the flipping direction is one of horizontal or vertical. The flipping direction may be horizontal based on the IBC mirror mode direction flag being horizontal. The flipping direction may be vertical based on the IBC mirror mode direction flag being vertical. The indication of the direction of the null component of the BV may comprise a first flag indicating that a component of the BV is null. The indication of the direction of the null component of the BV may comprise a second flag indicating a direction of the null component of the BV. The first flag may be a BV one component null flag. The second flag may be a BV one component null direction flag. The null component of the BV may comprise a null vertical component or a null horizontal component. The computing device may determine a direction of the component of the BVD based on the direction of the null component of the BV. The direction of the component of the BVD may be determined to be vertical based on the direction of the null component of the BV being horizontal. The direction of the component of the BVD may be determined to be horizontal based on the direction of the null component of the BV being vertical. The computing device may determine, based on the indication of the direction of the null component of the BV, a list of BVPs. The list of BVPs may comprise a first BVP determined based on a dimension of the current block; and a second BVP determined based on a displacement from a location of the current block to a boundary of the reference region. The first BVP may be determined based on: a negative of a height of the current block, or a negative of a width of the current block. The displacement from the location of the current block may indicate: a position at a top-most boundary of the reference region above the current block, or a position at a left-most boundary of the reference region left of the current block. The indication of the BVP may indicate a BVP in the list of BVPs. The determining the sign of the component of the BVD based on the BVP may comprise determining the sign of the component of the BVD to be: negative based on the BVP being the first BVP, or positive based on the BVP being the second BVP. The indication of the magnitude of the component of the BVD may comprise an absolute value of a non-null component of the BVD. The determining the sign of the component of the BVD may comprise assigning the sign to the non-null component of the BVD. The determining the BV may comprise determining a non-null component of the BV by combining a non-null component of the BVP and the non-null component of the BVD. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to send the indication of the direction of the null component of the BV. A computer-readable medium may store instructions that, when executed, cause performance of the described method, additional operations and/or include the additional elements.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

What is claimed is:

1. A method comprising:
receiving:
an indication that a block vector (BV) comprises a null component;
an indication of a magnitude of a component of a block vector difference (BVD) associated with a current block; and
an indication of a block vector predictor (BVP);
determining a sign of the component of the BVD based on:
the BVP; and
the indication that the BV comprises the null component;
determining the BV based on:
the BVP;
the sign of the component of the BVD; and
the magnitude of the component of the BVD; and
decoding the current block based on a reference block that is displaced from the current block by the BV.

2. The method of claim 1, wherein the indication that the BV comprises the null component comprises an indication of a direction of the null component of the BV.

3. The method of claim 1, wherein the BV comprises a null vertical component or a null horizontal component.

4. The method of claim 1, wherein the indication that the BV comprises the null component comprises an indication of a direction of the null component of the BV, wherein the method further comprises:
based on the direction of the null component of the BV, determining a direction of the component of the BVD.

5. The method of claim 1, wherein the indication that the BV comprises the null component comprises at least one of:
a first indication that flipping of the reference block is used to encode the current block; or
a second indication of a direction of flipping of the reference block.

6. The method of claim 1, further comprising determining, based on the indication that the BV comprises the null component, a list of BVPs comprising:
a first BVP determined based on a dimension of the current block; and
a second BVP determined based on a displacement from a location of the current block to a boundary of a reference region.

7. The method of claim 1, wherein the determining the sign of the component of the BVD based on the BVP comprises:
determining the sign of the component of the BVD to be negative based on the BVP being a first BVP in a list of BVPs; or
determining the sign of the component of the BVD to be positive based on the BVP being a second BVP in the list of BVPs.

8. The method of claim 1, further comprising:
receiving an indication of flipping of the reference block, wherein the decoding the current block is further based on the indication of flipping of the reference block.

9. A method comprising:
selecting, by a computing device and based on a block vector (BV) associated with a reference block comprising a null component, a block vector predictor (BVP) from among:
a first BVP determined based on a dimension of a current block; and
a second BVP determined based on a displacement from a location of the current block to a boundary of a reference region;
based on a difference between the BV and the BVP, determining a magnitude of a block vector difference (BVD); and
sending an indication of the BVP, an indication that the BV comprises the null component, and an indication of the magnitude of the BVD.

10. The method of claim 9, wherein the indication that the BV comprises the null component comprises an indication of a direction of the null component of the BV.

11. The method of claim 9, wherein the BV comprises a null vertical component or a null horizontal component.

12. The method of claim 9, wherein the displacement from the location of the current block indicates:
a position at a top-most boundary of the reference region above the current block, or
a position at a left-most boundary of the reference region left of the current block.

13. The method of claim 9, wherein the indication that the BV comprises the null component comprises at least one of:
a first indication that flipping of the reference block is used to encode the current block; or
a second indication of a direction of flipping of the reference block.

14. The method of claim 9, further comprising:
sending a residual associated with the current block, wherein the residual is based on a difference between the current block and the reference block.

15. The method of claim 9, further comprising sending an indication that flipping of the reference block is used to encode the current block.

16. A method comprising:
receiving:
an indication that flipping of a reference block is used to encode a current block;
an indication of a magnitude of a component of a block vector difference (BVD) associated with the current block; and
an indication of a block vector predictor (BVP);
based on the indication that flipping of the reference block is used to encode the current block, determining that a block vector (BV), associated with the reference block, comprises a null component;
determining a sign of the component of the BVD based on:
the BVP; and
the determination that the BV comprises the null component;
determining the BV based on:
the BVP;
the sign of the component of the BVD; and
the magnitude of the component of the BVD; and
decoding, based on the BV, the current block.

17. The method of claim 16, wherein the indication that flipping of the reference block is used to encode the current block comprises an indication of a direction of flipping.

18. The method of claim 16, wherein the BV comprises a null vertical component or a null horizontal component.

19. The method of claim 16, wherein the indication that flipping of the reference block is used to encode the current block comprises an indication of a direction of flipping, wherein the method further comprises determining a direction of the component of the BVD based on the direction of flipping.

20. The method of claim 16, further comprising, based on determining that the BV comprises the null component, determining a list of BVPs comprising:
a first BVP determined based on a dimension of the current block; and
a second BVP determined based on a displacement from a location of the current block to a boundary of a reference region.
